(19) United States
(12) Patent Application Publication
(10) Pub. No.: US 2026/0078220 A1
(43) Pub. Date: Mar. 19, 2026

(54) CORE-SHEATH MICROSTRUCTURES, PROCESS OF PREPARING SAME AND USES THEREOF

(71) Applicant: Ramot at Tel-Aviv University Ltd., Tel-Aviv (IL)

(72) Inventors: Amit Yehezkel SITT, Tel-Aviv (IL); Maya MOLCO, Tel-Aviv (IL); Amir KEILIN, Tel-Aviv (IL)

(73) Assignee: Ramot at Tel-Aviv University Ltd., Tel-Aviv (IL)

(21) Appl. No.: 19/403,332

(22) Filed: Nov. 28, 2025

Related U.S. Application Data
(63) Continuation of application No. PCT/IL2024/050542, filed on May 31, 2024.
(60) Provisional application No. 63/469,929, filed on May 31, 2023.

(51) Int. Cl. C08G 73/02; D01D 5/00; D01D 5/34

(52) U.S. Cl. CPC C08G 73/024; D01D 5/0038; D01D 5/34

(57) ABSTRACT

Core-shell microstructures made of a polymeric outer shell and a porous inner core that comprises a chemically-crosslinked polyamine, methods of preparing same and uses thereof are provided. The microstructures can be obtained, for example, by wet spinning, for example, wet mechanical spinning or by wet electrospinning using a solution comprising a polymeric material that forms an outer shell and a solution comprising a polyamine, and a hydrogel matrix that comprises a crosslinker for forming the chemically-crosslinked polyamine in the inner core.

### RELATED APPLICATIONS

This application is a Continuation of PCT Patent Application No. PCT/IL2024/050542 having International filing date of May 31, 2024 which claims the benefit of priority under 35 USC § 119 (e) of U.S. Provisional Patent Application No. 63/469,929, filed on May 31, 2023. The contents of the above applications are all incorporated by reference as if fully set forth herein in their entirety.

### FIELD AND BACKGROUND OF THE INVENTION

The present invention, in some embodiments thereof, relates to material science, and more particularly, but not exclusively, to core-sheath microstructures featuring chemically-controlled core architectures, to processes of preparing same, and to uses thereof, for example, in applications in which chemisorption and/or physisorption of chemical and/or biological substances is beneficial, such as, but not limited to, filtration, separation and catalysis.

The ongoing advance in the ability to control the physical, chemical, and mechanical properties of polymeric fibers, and the possibility to incorporate them with new technologies, enables the creation of fabrics with new features and properties, including functional fibers which can adsorb moisture, conduct electricity, and capture or release materials. Performance fabrics can exhibit high mechanical durability, self-cleaning, anti-fouling properties, and even self-healing. There are smart fabrics that can sense their environment and change their features accordingly. While many of the abovementioned properties emanate from the chemical structure of the polymer, in recent years it appears that the geometrical architecture of the fiber, and in particular the combination of micro- and nanoscale hierarchical geometrical features, play a major role in determining the physical, mechanical, and sometimes even the chemical, properties of the fiber.

The hierarchical geometrical structure and morphology are significant also when considering the inner structure of polymeric fibers. The inner structure of the fiber can have a major effect on a range of factors including the mechanical performance, wettability, porosity, and chemical reactivity of the fiber [See, for example, A Review by Badmus et al. Nano Mater. Sci. 2021, 3 (3), 213-232]. The formation of a complex hierarchical inner structure within the fiber, which combines different dimensions and scales, offers a large specific area and heterogeneous interfaces [Wu et al. J. Mater. Chem. A 2013, 1 (25), 7290-7305; Wang et al. Morphologies. Molecules 2019, 24 (5), 834]. Such hierarchical fiber structure is a common feature in many natural systems [John, M. J. and Thomas S. Carbohydr. Polym. 2008, 71 (3), 343-364; A Review by Ramamoorthy et al. Polym. Rev. 2015, 55 (1), 107-162], and is also appealing for a range of applications including fluid transport, separation and filtering, drug delivery and encapsulation, tissue growth, energy storage, and catalysis [Peng et al. Prog. Polym. Sci. 2012, 37 (10), 1401-1424; Hu et al. J. Control. Release 2014, 185 (1), 12-21; A Review by Pant et al. Pharmaceutics 2019, 11 (7), 305; Liu et al. Adv. Fiber Mater. 2022, 4 (4), 604-630].

However, affecting the internal geometry is not trivial, as the internal part of the fiber is not exposed to the environment. Therefore, its structure should either be induced during the fabrication step, or it should rely on post-fabrication internal processes that can alter the morphology of the inner domain of the fiber, e.g., phase separation or self-assembly.

One of the most versatile methods for obtaining fibers in the nano-to-microscale is electrospinning. In this approach, a polymer solution (or a melted polymer) is dispensed through a capillary, while high voltage is applied between the capillary and a collecting conductive surface. This results in the ejection of a fluid jet that is stretched and thinned as it solidifies, forming fibers on the collecting surface [Ramakrishna et al. World Scientific, 2005; Roh et al. Nat. Mater. 2005, 4 (10), 759-763; Lahann, J. Small 2011, 7 (9), 1149-1156]. Electrospinning provides a range of methods for controlling the inner architecture of the system, including electrohydrodynamic coaxial and side-by-side spinning [Roh et al. 2005, supra; Sun et al. Adv. Mater. 2003, 15 (22), 1929-1932], coaxial spinning with sacrificial fillers [Gualandi et al. Nano Lett. 2013, 13 (11), 5385-5390], emulsion electrospinning [a mini-review by Yarin, A. L. Polym. Adv. Technol. 2011, 22 (3), 310-317], and post-fabrication in-situ chemical and physical modification [Molco et al. AC'S Appl. Mater. Interfaces 2021, 13 (10), 12491-12500; Sitt et al. Small 2016, 12 (11), 1432-1439].

Core-sheath electrospinning is a common approach for constructing complex fiber architectures. In a typical core-sheath electrospinning process, the formation of a solid sheath, mediated by rapid solvent evaporation from the surface of the fiber, occurs first and precedes the solidification of the core. This provides a period in which the core components are still in a dynamic liquid form that is confined within the walls of the solid sheath. Reaching the final configuration of the core is much slower and is strongly affected by the liquid attributes of the core at this stage and in particular the liquid-solid surface tension between the core and the solid sheath [Sun et al. 2003, supra; Sitt et al. 2016, supra; Dror et al. Small 2007, 3 (6), 1064-1073; Vats et al. Langmuir 2021, 37 (45), 13265-13277]. While in most cases, the slow solidification of the core leads to a standard core/sheath structure, a combination of strong adhesion between the core and the sheath, accompanied by a large volume reduction of the core, can lead to the formation of hollow fibers [Dror et al. 2007, supra].

Additional background art includes Ma et al. Sci. Rep. 2016, 6 (1), 19370; Lee et al. Chem. Commun. 2013, 49 (29), 3028; a review by Wamba et al. J. Environ. Chem. Eng. 2018, 6 (2), 3192-3203; Otsuki et al. In Ruthenium Chemistry; Mishra, A. K. and Mishra, L., Eds.; Jenny Stanford Publishing: New York, 2018; 161214; Edelstein-Pardo et al. Chem. Mater. 2022, 34 (14), 6367-6377; Migneault et al. Biotechniques 2004, 37 (5), 790-802, Molco, M. et al. Polymers 2023, 15, 2537.

### SUMMARY OF THE INVENTION

According to an aspect of some embodiments of the present invention there is provided a microstructure comprising an inner core enveloped by an outer shell, wherein the inner core comprises a porous structure made of a chemically-crosslinked polyamine and the outer shell is a polymeric outer shell made of a polymeric material.

According to some of any of the embodiments described herein, the porous structure comprises a plurality of spheres.

According to some of any of the embodiments described herein, the plurality of spheres comprises a plurality of microspheres and a plurality of nanospheres.

According to some of any of the embodiments described herein, a weight ratio of the microspheres and the nanospheres ranges from 1:100 to 10:1.

According to some of any of the embodiments described herein, at least 50%, or at least 60%, or at least 80%, or about 90% of the spheres are nanospheres.

According to some of any of the embodiments described herein, the nanospheres feature an average diameter in a range of from 1 to 850, or from 250 to 650, or from 400 to 500, nm.

According to some of any of the embodiments described herein, the microspheres feature an average diameter in a range of from 1 to 3 microns.

According to some of any of the embodiments described herein, an average diameter in a range of from 10 to 50 μm, or from 10 to 30 μm, or from 10 to 20 μm.

According to some of any of the embodiments described herein, an average diameter of the inner core is in a range of from 5 to 30 μm, or from 5 to 20 μm, or from 10 to 15 μm.

According to some of any of the embodiments described herein, the chemically-crosslinked polyamine is formed of a polyamine having an average Mn in a range of from 100 to 5000 grams/mol.

According to some of any of the embodiments described herein, the chemically-crosslinked polyamine is formed of a polyamine having from 2 to 10 amine groups.

According to some of any of the embodiments described herein, the chemically-crosslinked polyamine is formed of a polyamine selected from a branched polyamine, a linear polyamine, and a combination thereof.

According to some of any of the embodiments described herein, the chemically-crosslinked polyamine is formed of a polyamine selected from tetraethylenepentamine (TEPA), trimethylolpropane tris[poly(propylene glycol), amine terminated] ether (JEFFAMINE® T-403), poly(propylene glycol)bis(2-aminopropyl ether) (JEFFAMINE® D-2000) and 3,3,5-trimethylhexamethylene-diamine (JEFFAMINE® D-230).

According to some of any of the embodiments described herein, the chemically-crosslinked polyamine is formed in the presence of a crosslinker having a molecular weight lower than 1,000 grams/mol.

According to some of any of the embodiments described herein, the chemically-crosslinked polyamine is formed in the presence of a crosslinker which is water-miscible or water-soluble.

According to some of any of the embodiments described herein, the crosslinker is glutaraldehyde (GA).

According to some of any of the embodiments described herein, the polymeric material that forms the outer shell and the crosslinker are selected such that the crosslinker is capable of penetrating through the outer shell.

According to some of any of the embodiments described herein, the polymeric material that forms the outer shell and the polyamine that forms the crosslinked polyamine are not dissolvable in one another.

According to some of any of the embodiments described herein, the polymeric material that forms the outer shell is water-immiscible or water-insoluble.

According to some of any of the embodiments described herein, the polymeric material that forms the outer shell comprises PLGA.

According to some of any of the embodiments described herein, the inner core further comprises an additional polymeric material other than the chemically-crosslinked polyamine.

According to some of any of the embodiments described herein, the additional polymeric material is or comprises a poly(alkylene glycol).

According to some of any of the embodiments described herein, the additional polymeric material has an average Mn of from 100 to 10,000 kDa, or from 1,000 to 5,000 kDa.

According to some of any of the embodiments described herein, is a fibrous microstructure.

According to some of any of the embodiments described herein, microstructure is a cylindrical microstructure.

According to some of any of the embodiments described herein, the microstructure is a degradable microstructure.

According to an aspect of some embodiments of the present invention there is provided a method for preparing the microstructure as described herein in any of the respective embodiments, the method comprising subjecting a solution comprising the polymeric material that forms the outer shell and a solution comprising the polyamine to a wet electrospinning process within a hydrogel matrix that comprises a crosslinker, to thereby obtain a fibrous microstructure embedded in the hydrogel matrix; removing the hydrogel matrix, to thereby obtain the fibrous microstructure; and optionally, converting the fibrous microstructure into a non-fibrous microstructure, wherein: the crosslinker is water-miscible or water-soluble; and/or wherein the polymeric material that forms the outer shell and the crosslinker are selected such that the crosslinker is capable of penetrating through the outer shell; and/or wherein the polymeric material that forms the outer shell and the polyamine that forms the crosslinked polyamine are immiscible with one another.

According to some of any of the embodiments described herein, the hydrogel matrix comprises a sacrificial material that is dissolvable in a solvent that does not dissolve the inner core and the outer shell.

According to some of any of the embodiments described herein, the hydrogel matrix is characterized by a viscosity in the range of from 2000 to 100000 mPa second (centipoises), or from 2000 to 50000 mPa second, or from 1000 to 20000 mPa second, or from 1000 to 10000 mPa second, or from 2000 to 10000 mPa second, including any intermediate values and subranges therebetween.

According to some of any of the embodiments described herein, the hydrogel matrix is or comprises an optimal cutting temperature (OCT) gel.

According to some of any of the embodiments described herein, the method further comprises cryosectioning the hydrogel matrix having the fibrous microstructure embedded therein prior to removing the hydrogel matrix, to thereby obtain a non-fibrous microstructure in a form of microcylinders.

According to an aspect of some embodiments of the present invention there is provided a microstructure prepared by the method as described herein in any of the respective embodiments.

According to an aspect of some embodiments of the present invention there is provided a composition comprising a plurality of microstructures, wherein in at least a portion of the microstructures, each microstructure is a microstructure as described herein in any of the respective embodiments and any combination thereof.

According to an aspect of some embodiments of the present invention there is provided an article-of-manufacturing comprising the microstructure or the composition as described herein in any of the respective embodiments.

According to some of any of the embodiments described herein, the article-of-is selected from a filter, a filtration device, a purifying device, a water purifying device, a gas-capturing device, and a separating device.

According to some of any of the embodiments described herein, the separating device is a precious metal separating device.

According to some of any of the embodiments described herein, article-of-manufacturing is for use in separating a substance or species from a mixture comprising same, the substance or species being absorbable by the microstructure of the composition comprising same.

According to an aspect of some embodiments of the present invention there is provided a composition-of-matter comprising the microstructure as described herein in any of the respective embodiments and a substance absorbed to and/or associated with, the microstructure.

According to some of any of the embodiments described herein, the composition-of-matter comprises a plurality of the microstructures, wherein the substance is absorbed to at least a portion of the microstructures.

According to some of any of the embodiments described herein, the substance is absorbed to and/or is associated with the inner core (e.g., the spheres that form the inner core or a portion thereof).

According to some of any of the embodiments described herein, the substance is a biologically active substance.

According to some of any of the embodiments described herein, the biologically active substance is an enzyme.

According to some of any of the embodiments described herein, the substance is a chemically active substance.

According to some of any of the embodiments described herein, the chemically active substance is an organometallic catalyst.

According to some of any of the embodiments described herein, the substance is or comprises a metal species.

According to some of any of the embodiments described herein, the metal species is selected from elemental metal, a metal ion, a metal salt, and a metal particle.

According to an aspect of some embodiments of the present invention there is provided a composition-of-matter comprising a plurality of particles, wherein at least a portion of the particles comprises a chemically crosslinked polyamine.

According to some of any of the embodiments described herein, the plurality of particles comprises a plurality of spheres, which, according to some embodiments, can comprise a plurality of microspheres and a plurality of nanospheres, as described herein in any of the respective embodiments that relate to the inner core.

According to some of any of the embodiments described herein, the chemically-crosslinked polyamine is formed of a polyamine having an average Mn in a range of from 100 to 5000, or from 100 to 2000, or from 100 to 1000 or from 100 to 500, grams/mol.

According to some of any of the embodiments described herein, the chemically-crosslinked polyamine is formed of a polyamine having from 2 to 10 amine groups.

According to some of any of the embodiments described herein, the chemically-crosslinked polyamine is formed of a polyamine selected from a branched polyamine, a linear polyamine, and a combination thereof, and in some embodiments it is as described herein in any of the respective embodiments that relate to the inner core.

According to some of any of the embodiments described herein, the crosslinker is glutaraldehyde (GA).

According to some of any of the embodiments described herein, the composition-of-matter is obtainable by contacting a solution of the crosslinker with a solution of the polyamine from which the chemically-crosslinked polyamine is formed, such that a reaction therebetween occurs at the interface of the solutions. The solutions can be miscible with one another, or not, as long as the formed chemically-crosslinked polyamine is not (i.e., the chemically-crosslinked polyamine is immiscible or insoluble in the solutions).

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-B present representative Brightfield microscopy time-lapse images showing the spontaneous emulsification process of an exemplary polyamine according to some embodiments of the present invention, JEFFAMINE® T-403 (left phase), and an exemplary crosslinker according to some embodiments of the present invention, glutaraldehyde (GA; 50% in water) (right phase) at 0, 1 and 8 seconds, as indicated, following the contact between the two components (as described herein, see “Spontaneous phase separation”) (FIG. 1A), and scanning electron microscope (SEM) image of the resulting residue, showing the formation of nano- and micro-spheres (FIG. 1B). Scale bars are 50 μm (FIG. 1A) and 500 nm (FIG. 1B).

FIG. 2 is an emission spectrum of an exemplary chemically-crosslinked polyamine according to some embodiments of the present invention, JEFFAMINE® T-403 crosslinked with GA obtained as described in FIG. 1, as collected from confocal microscope under an excitation wavelength of 405 nm. The red dots indicate the measured intensities.

FIG. 3 is a schematic illustration of an exemplary fabrication process according to some embodiments of the present invention. The core solution (green) contains PEG and an exemplary polyamine according to some of the present embodiments, JEFFAMINE® T-403, and the shell solution (blue) contains an exemplary spinning solution comprising PLGA, which forms the outer shell. The two solutions are injected simultaneously to achieve a core-sheath structure and are collected on a rotating drum covered with OCT and GA (left). After fabrication (right), the fibers are cryo-sectioned into microcylinders with a defined length and expose a chemically-crosslinked polyamine core (red).

FIG. 4A presents a representative SEM micrograph of cryo-sectioned “pixie-stick” exemplary microcylinders as obtained following the exemplary fabrication process described herein, showing the outer and inner sheaths, and the nano- or micro-spheres at the core (scale bar is 5 μm), with a magnification of the nanospheres presented in the inset (scale bar is 500 nm).

FIGS. 4B-C present size distribution of the outer (FIG. 4B) and inner (FIG. 4C) perpendicular diameters of 60 JEFFAMINE® T-403-based microcylinders obtained following the exemplary fabrication process described herein.

FIG. 4D presents size distribution of the spheres' diameter, as measured in a representative population in the cross-section of the exemplary microcylinders obtained following the exemplary fabrication process described herein, showing the diameter of 100 nanospheres and microspheres located at the core of the exemplary crosslinked JEFFAMINE® T-403 microcylinders.

FIG. 5 presents an energy dispersive spectroscopy (EDS) elemental analysis of a representative cross-sectioned microcylinder, showing excess of nitrogen at the core (green) and of oxygen at the sheath (cyan) of the microcylinder, while carbon is homogeneously distributed throughout the microcylinder (red).

FIG. 6 presents representative confocal laser scanning microscopy (CLSM) cross-sections along a representative sectioned fiber immersed in water with green emitting fluorescein isothiocyanate (FITC), showing the outer PLGA sheath (blue), the crosslinked JEFFAMINE® T-403-GA spheres in the inner sheath (red), the water (green) and the overlay (multiple colors).

FIGS. 7A-D present representative SEM micrographs of cryo-sectioned exemplary JEFFAMINE® T-403-based microcylinders embedded into OCT gels having different concentrations of GA: 0% GA (FIG. 7A), 1% GA (FIG. 7B), 6% GA (FIG. 7C), and 12% GA (FIG. 7D).

FIGS. 8A-B present representative Brightfield micrographs of crosslinked JEFFAMINE® T-403-based microcylinders before (FIG. 8A) and after (FIG. 8B) immersion in a solution of RuCl₃ 0.1 M in water, showing that the color of the metal-modified microcylinder became much darker, which may indicate adsorption of Ru³⁺ ions by the microcylinders.

FIG. 8C presents a representative EDS mapping of a cross-section of a metal-modified microcylinder, showing a SEM micrograph (left), an EDS elemental analysis (center), and an overlay of the SEM and EDS analyses (right), indicating adsorption of Ru³⁺ ions occurs at the spheres of the microcylinder.

FIG. 9 presents a representative Brightfield micrograph of an exemplary catalase-modified microcylinder upon immersion in hydrogen peroxide solution (0.1% in water). As the microcylinders catalyze the disproportionation of the hydrogen peroxide to water and oxygen gas inside the microcylinder, oxygen bubbles are emitted from the rims of the microcylinder and cause it to propel.

FIG. 10 presents chemical structures of the exemplary polyamines, JEFFAMINE® T-403, tetraethylenepentamine (TEPA), JEFFAMINE® D-230, and JEFFAMINE® D-2000 (poly(propylene glycol) bis(2-aminopropyl ether).

FIGS. 11A-B present representative Brightfield microscopy time-lapse images showing the spontaneous emulsification of the exemplary polyamines, TEPA (FIG. 11A) or JEFFAMINE® D-2000 (FIG. 11B), and an exemplary crosslinker according to some embodiments of the present invention, glutaraldehyde (GA; 50% in water) at different time intervals (0, 55 and 90 seconds in FIG. 11A; 0, 3 and 25 seconds in FIG. 11B), as indicated.

FIGS. 12A-C present representative SEM micrographs of cryo-sectioned microcylinders containing TEPA (FIG. 12A), JEFFAMINE® D-230 (FIG. 12B), and JEFFAMINE® D-2000 (FIG. 12C). The lower panel in each of FIGS. 12A-C shows a representative CLSM cross-section of the different microcylinders (left; crosslinked amine emission is depicted in red), the respective Brightfield micrograph (center), and the overlap of the two (right).

FIG. 12D is a representative CLSM cross-section of an entire crosslinked JEFFAMINE® D-2000 fiber (left), its Brightfield micrograph (center), and an overlay of the two (right).

FIGS. 13A-B are bar graphs presenting the size distribution of JEFFAMINE® D-2000 segments (FIG. 13A) and the gaps between the JEFFAMINE® D-2000 segments of crosslinked JEFFAMINE® D-2000 (FIG. 13B), obtained as described herein (see, Size distribution of crosslinked JEFFAMINE® D-2000).

FIGS. 14A-H present data obtained in XPS measurements of exemplary microstructures, decorated with ruthenium-(FIGS. 14A-B), platinum-(14C-D), iridium-(14E-F), and palladium-(14G-H), before (FIGS. 14A, 14C, 14E, and 14G) and after (FIGS. 14B, 14D, 14F, and 14H) reduction. The peak assignment is reported above each peak, indicating a clear reduction and for most metals a transition from ionic to metallic form.

FIGS. 15A-H present SEM images (FIGS. 15A, 15C, 15E, and 15G; scale bars are 10 μm) and corresponding EDX spectra (FIGS. 15B, 15D, 15F, and 15H) of platinum-(15A-B), palladium-(15C-D), iridium-(15E-F), and ruthenium-(FIGS. 15G-H) distribution in the exemplary microstructures (e.g., microcylinders). The different measured peaks are indicated in each EDX spectrum, and the dotted colors indicate the position of each metal according to the EDS. In all images, red indicates the presence of oxygen.

FIGS. 16A-B present Brightfield microscopy images showing a mesh of platinum-decorated fibrous microstructures before (FIG. 16A) and after (FIG. 16B) the addition of H₂O₂ (aq) (0.1% w/v) to the fibers.

FIGS. 17A-C present SEM images showing a cross-section of a representative example of a metal (platinum)-decorated fibrous microstructure according to some embodiments of the present invention. Scale bars are 5 μm (FIG. 17A), 500 nm (FIG. 17B), and 300 nm (FIG. 17C).

### DESCRIPTION OF SPECIFIC EMBODIMENTS OF THE INVENTION

The present invention, in some embodiments thereof, relates to material science, and more particularly, but not exclusively, to core-sheath microstructures featuring chemically-controlled core architectures, to processes of preparing same, and to uses thereof, for example, in applications in which chemisorption and/or physisorption of chemical and/or biological substances is beneficial, such as, but not limited to, filtration, separation and catalysis.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Sub-microscale control over the architecture and morphology of polymeric structures may provide smart structures (e.g., fibrous structures) with innovative physical, chemical, and mechanical properties.

The present inventors have uncovered that spontaneous phase-separation of polyamines conjugated with chemical fixation can be used as a synthetic route for the formation of polymeric core-sheath microstructures (e.g., fibrous structures) with controlled hierarchical multilevel structures.

The present inventors have designed and successfully practiced a novel approach for the formation of polyamine-based core-sheath fibrous microstructures with hierarchical architecture. Controlling the phase separation process can be effected by selecting polyamines of different MW, and results in fibers or fibrous structures with diverse porous core architectures, ranging from densely packed nanospheres to segmented “bamboo-stem” morphology.

Exemplary fibers or fibrous structures, made of a polyamine core embedded in a poly-lactic-co-glycolic acid (PLGA) sheath, were collected over a gel matrix comprising glutaraldehyde (GA), as an exemplary crosslinker and a fixation agent for amine moieties.

The crosslinker, or crosslinking agent, is selected as capable of penetrating into the core, and the chemically-induced spontaneous phase separation and chemical fixation occur simultaneously. The nature of the phase separation, which depends on, e.g., the polyamine used and the spatial confinement, dictates the obtained core morphology, which can range from densely packed nano-spheres to periodically segmented longitudinal compartments.

The nitrogen-rich environment of the core allows spatial-selective binding of different species to the core compartment, including the chemisorption and/or physisorption of, e.g., metal ions and other metal species, biological moieties such as enzymes, gases, pigments, etc. The absorbed substances may have an affinity towards amine groups, thus chemically interacting with the nitrogen-rich environment, and/or they may be physically confined within the structure without substantial leaching therefrom.

This broad range of possible absorbed substances allow employing the microstructure and/or its inner core in a myriad of applications, including, but not limited to, absorbing, depleting, filtering, and/or separating species and/or substances from mixtures or environments containing such species and/or substances, and/or as a protecting and/or immobilizing matrix for entrapping therein active substances.

These uses, along with the highly porous morphology of the core and high specific surface area, allows for a variety of technological applications including, but not limited to, separation, filtering, and catalysis.

Embodiments of the present invention therefore relate to core-sheath microstructures comprising a polymeric sheath, preferably hydrophobic, as an outer shell, and a chemically-crosslinked polyamine core, as described herein, to processes of preparing such structures, such as described and exemplified herein, and to uses thereof.

### Process

According to an aspect of some embodiments of the present invention there is provided a method or process for preparing a microstructure made of an inner core that comprises a chemically-crosslinked polyamine, at least partially enveloped by an outer polymeric shell, as described herein in any of the respective embodiments and in any combinations thereof.

According to an aspect of some embodiments of the present invention there is provided a microstructure (e.g., as described herein in any of the respective embodiments and in any combinations thereof), obtainable by a process as described herein.

According to some of any of the embodiments of this aspect of the present invention, the process is effected by subjecting a solution comprising a polymeric material that forms the outer shell (e.g., a polymeric material as described herein in any of the respective embodiments and in any combinations thereof) and a solution comprising a polyamine (e.g., a polyamine as described herein in any of the respective embodiments and in any combinations thereof) to a spinning process (e.g., an electro-spinning process or to a mechanical spinning process), or to any other process that generates core-sheath fibrous structures.

As used herein, the term “spinning” refers to a technology which produces fibrous structures (e.g. the fibrous microstructures) from a polymer solution (or polymer solutions, e.g., the core solution and the sheath solution as described herein). During this process, polymers are liquefied (i.e. melted or dissolved), placed in a dispenser, extruded by means that form continuous fibers (filaments), collected and then harden to provide fibrous structures.

The extrusion can be performed using a dispenser, for example, mechanically, by means of a plurality of syringes or needles, or a spinneret, and the mechanically formed fibrous structures can be collected or pulled as dry solidified structures or placed in a wet environment that induces solidification or hardening of the structures. Alternatively, the process can be performed by application of electrostatic field between the dispenser and the collector, and is known as electrospinning.

As used herein, the term “electrospinning” refers to a technology which produces electrospun fibrous structures (e.g. the fibrous microstructures) from a polymer solution (or polymer solutions, e.g., the core solution and the sheath solution as described herein). During this process, one or more polymers of the polymeric material as described herein are liquefied (i.e. melted or dissolved) and placed in a dispenser (e.g., a syringe with a co-axial metallic needle). An electrostatic field is employed to generate a positively charged jet from the dispenser to the collector (e.g., a rotating drum). Thus, a dispenser is typically connected to a source of high voltage, preferably of positive polarity, while the collector is grounded, thus forming an electrostatic field between the dispenser and the collector. Alternatively, the dispenser can be grounded while the collector is connected to a source of high voltage, preferably with negative polarity. As will be appreciated by one ordinarily skilled in the art, any of the above configurations establishes motion of positively charged jet from the dispenser to the collector. Reverse polarity for establishing motions of a negatively charged jet from the dispenser to the collector is also contemplated. At the critical voltage, the charge repulsion begins to overcome the surface tension of the liquid drop. The charged jets depart from the dispenser and travel within the electrostatic field towards the collector. Moving with high velocity in the inter-electrode space, the jet stretches and the solvent therein evaporates, thus forming fibers which are collected on the collector forming the electrospun scaffold. In some of any of the embodiments described herein, the driving voltage is in a range of from 1 to 5 kV, or from 1.5 to 4.

According to some of any of the embodiments described herein, the spinning process (e.g., electrospinning) is a wet spinning (e.g., electrospinning) process.

As used herein, the phrase “wet spinning” refers to a spinning process in which the formed fibrous structures (e.g. the fibrous microstructures) are formed in or are transferred to a liquid or wet environment (e.g., into the hydrogel).

As used herein, the phrase “wet electrospinning” refers to an electrospinning process in which the formed fibrous structures (e.g. the fibrous microstructures) are electrospun directly into a liquid or wet environment (e.g., into the hydrogel).

According to some of any of the embodiments described herein, the fibrous structures are pulled into a hydrogel matrix, or when the process is electrospinning, the fibrous structures are electrospun into a hydrogel matrix. According to the present embodiments, the hydrogel matrix comprises a crosslinker, as described herein in any of the respective embodiments and in any combinations thereof, which promotes the formation of the chemically-crosslinked polyamine in the inner core.

According to some of any of the embodiments described herein, the (e.g., wet) spinning (e.g., electrospinning) process is performed at a temperature in a range of from 0 to 90, or from 10 to 90, or from 0 to 80, or from 10 to 80, or from 0 to 70, or from 10 to 70, or from 0 to 60, or from 10 to 60, or from 0 to 50, or from 10 to 50, or from 1 to 40, or from 1o to 40, or from 20 to 90, or from 20 to 80, or from 20 to 70, or from 20 to 60, or from 20 to 50, or from 20 to 40, or from 20 to 30, ° C., including any intermediate values and subranges therebetween. In some embodiments, it is performed at room temperature.

According to some of any of the embodiments described herein, the (e.g., wet) spinning (e.g., electrospinning) process is performed at a relative humidity in a range of from 10 to 100, or 10) from 20 to 90, or 30 to 100, or 30 to 90, or 40 to 100 or 40 to 90, or 50 to 100 or 50 to 90, or 60 to 100 or 60 to 90, or 70 to 100 or 70 to 90, or 10 to 80, or 20 to 80, or 30 to 80, or 40 to 80, or 50 to 80, or 60 to 80, or 10 to 70, or 20 to 70, or 30 to 70, or 40 to 70, or 50 to 70, or 10 to 60, or 20 to 60, or 30 to 60, or 40 to 60, %, including any intermediate values and subranges therebetween. In some embodiments, it is performed at ambient relative humidity.

Several parameters may affect the diameter of the fibrous (e.g., electrospun) structures (e.g. the fibrous microstructures). These include the size of the dispensing hole/s of the dispenser, the dispensing rate, the dispensing force in case of a mechanical process, the strength of the electrostatic field in case of electrospinning, the distance between the dispenser and between the collector and/or the concentration of the polymeric materials used for fabricating the fibrous structures.

The dispenser can be, for example, a syringe with a metal needle or a bath provided with one or more capillary apertures from which liquid solutions as described herein can be extruded, e.g., under the action of hydrostatic pressure, mechanical pressure, air pressure and/or high voltage.

According to some of any of the embodiments described herein, a solution comprising the polymeric material (i.e., the sheath solution, which forms the outer shell) and a solution comprising the polyamine (i.e., the core solution) are added (i.e., dispensed, e.g., simultaneously jetted) through a metallic co-axial needle to provide a core-sheath configuration.

As used herein and in the art, the phrase “co-axial needle” refers to a setup in which two needles are concentrically arranged, with one needle positioned inside the other. This configuration allows for the simultaneous extrusion of two different materials or solutions, a core material and a sheath material. During electrospinning, the core material is ejected through the inner needle, while the sheath material is ejected through the outer needle. This setup of the co-axial needle enables the production of core-shell fibrous structures, where the core material is encapsulated (entrapped) within the shell.

According to some of any of the embodiments described herein, the outer shell in the microstructure is in a form of a sheath.

As used herein, the phrase “core-sheath configuration”, also being referred to herein interchangeably as a “core-sheath”, “core-shell configuration” or simply “core-shell”) refers to an arrangement of materials in which one material (the core) at least partially enveloped (surrounded or encapsulated) by another material (i.e., “the sheath” or “the shell”, as used herein interchangeably). In some of any of the embodiments described herein, at least 50% of the outer surface of the inner core is enveloped by the outer shell or sheath, and in some embodiments, at least 60%, at least 70%, at least 80%, at least 90%, at least 95%, at least 98%, or substantially all of the outer surface of the inner core is enveloped by the outer shell or sheath.

According to some of any of the embodiments described herein, the core solution and the shell solution are each independently dispensed (e.g., simultaneously) at a (e.g., constant) flow rate of from about 0.01 to 1, or from about 0.01 to 0.5, or from about 0.05 to about 0.5, or from about 0.1 to about 0.5, or from about 0.05 to about 0.025, or from about 0.1 to about to 0.25, including any intermediate values and subranges therebetween. In an exemplary, non-limiting embodiment, the flow rate is about 0.150, mL/hour. In exemplary embodiments, both solutions are dispensed at the same flow rate.

According to some of any of the embodiments described herein, the collector is a rotating collector (e.g., a rotating drum) which serves for collecting the spun (e.g., electrospun) scaffold thereupon. Employing a rotating collector can result in an e.g., electrospun scaffold with a continuous gradient of porosity. Such a porosity gradient can be achieved by continuous variation in the velocity of the collector or by a longitudinal motion of the dispenser, which result in a substantial variation in the density and/or spatial distribution of the fibers on the collector and thus, result in a porosity gradient along the radial direction or along the longitudinal direction of the collector, respectively. Typically, but not obligatorily, the rotating collector has a cylindrical shape (e.g., a drum), however, it will be appreciated that the rotating collector can be also of a planar geometry.

According to some of any of the embodiments described herein, the rotating drum rotates at a speed of from 1 to 1000, or from 10 to 1000, or from 1 to 500, or from 10 to 500, or from 1 to 10, or from 10 to 100, or from 20 to 80, rpm, including any intermediate values and subranges therebetween. In an exemplary, non-limiting embodiment, the drum rotates at a speed of about 60 rpm.

According to the present embodiments, a hydrogel matrix (e.g., as described herein in any of the respective embodiments) is applied over the rotating drum, so as to effect wet spinning (e.g., wet electrospinning).

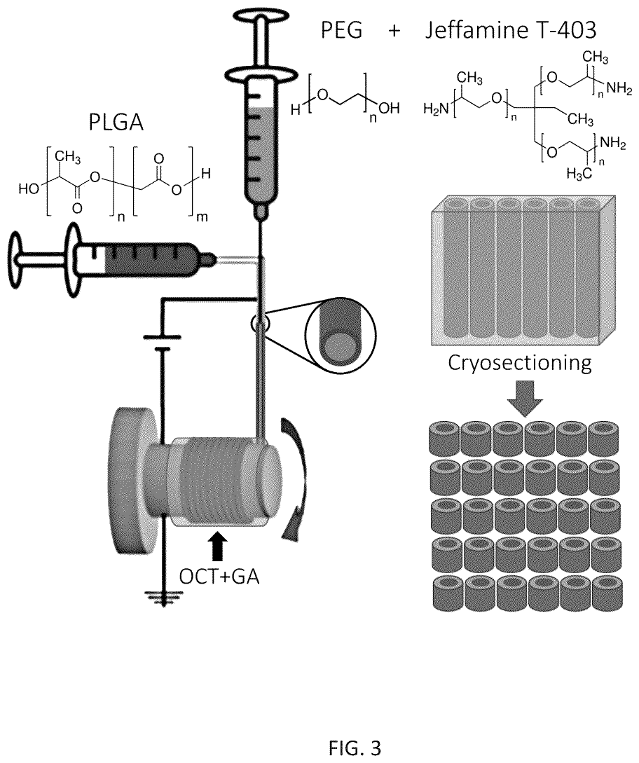

In an exemplary process, an electrospinning process is performed as schematically depicted in FIG. 3.

In some of any of the embodiments described herein, the process or method as described herein in any of the respective embodiments further comprises monitoring a change in the hydrogel as described herein in any of the respective embodiments, wherein the change is indicative of a reaction between a polyamine (e.g., a polyamine as described herein in any of the respective embodiments) and a crosslinker (e.g., a crosslinker as described herein in any of the respective embodiments). In some such embodiments, the change is a visual color change of the (e.g., fibrous) microstructure as described herein in any of the respective embodiments (e.g., from colorless to red).

### Hydrogel Matrix:

According to some of any of the embodiments described herein, the spinning process (e.g., electrospinning process, for example, a wet electrospinning process as described herein in any of the respective embodiments) is performed within a hydrogel matrix (also being referred to herein interchangeably as “hydrogel”).

Herein and in the art, the term “hydrogel” describes a three-dimensional fibrous network containing at least 20%, typically at least 50%, or at least 80%, and up to about 99.99% (by mass) water or aqueous solution, typically swollen within the network and imparting it a semi-solid, non-fluidic consistency. A hydrogel can be regarded as a material which is mostly water, yet behaves like a solid or semi-solid due to a three-dimensional crosslinked solid-like network, made of polymeric chains, within the liquid dispersing medium. The polymeric chains are interconnected (crosslinked) by chemical bonds (covalent, hydrogen and ionic/complex/metallic bonds, typically covalent bonds).

Herein throughout, whenever polymeric chains or a polymeric material is described, it encompasses polymeric synthetic materials, and polymeric biological materials (e.g., macromolecules) such as peptides, proteins, oligonucleotides and nucleic acids.

A hydrogel can be formed of one or more hydrogel-forming agents that polymerize or co-polymerize to form the fibrous network. Exemplary such agents include, but are not limited to, hydroxyethyl methacrylate (HEMA), hydroxyethyl acrylate (HEA), acrylamide (AAm), methacrylamide (MAAm), acrylic acid (AAc), methacrylic acid (MAAc), hydroxyethyl acrylate (HEA), hexyl methacrylate, N-isopropylacrylamide (NiPAAm)), N-isopropylmethacrylamide, polyamide, polyethylene-terephthalate (PET), polyvinyl alcohol, polyurethane, polycaprolactone, polyethylene-glycol (PEG), polyethylene-glycol methacrylate (PEGMA), polyethyleneoxide dimethacrylate (PEOdMA), N,N-dimethacrylamide (nnDMAA), poly(D,L-lactide), hyaluronic acid (HA), HA methacrylate, peptides, saccharides, gelatin, gelatin methacrylate, chitosan, chitosan methacrylate, glycol chitosan, glycol chitosan methacrylate, alginate, alginate methacrylate, cellulose, siloxanes, polysiloxanes, and any oligomer, polymer and/or copolymer thereof, in any combination thereof.

In some of any of the embodiments described herein, the hydrogel as described herein in any of the respective embodiments is selected such that the crosslinked polyamine and the polymeric material that forms the outer shell are not dissolvable or are immiscible herein. In exemplary embodiments, the hydrogel as described herein in any of the respective embodiments is an OCT gel (e.g., an OCT gel as described herein in any of the respective embodiments).

According to some of any of the embodiments described herein, the hydrogel matrix as described herein in any of the respective embodiments is or comprises a sacrificial material.

In some of any of the respective embodiments, the sacrificial material is removable under conditions that does not affect the inner core (e.g., the crosslinked polyamine) and the outer polymeric shell (e.g., the polymeric material), and the core-shell configuration thereof. In some of any of the respective embodiments, the sacrificial material is dissolvable under conditions that do not dissolve the inner core (e.g., the crosslinked polyamine) and the outer polymeric shell (e.g., the polymeric material), for example, is dissolvable in a solvent that does not dissolve the crosslinked polyamine and the outer shell.

According to some of any of the respective embodiments, the materials forming the hydrogel network are removable (i.e., are sacrificial) under the conditions that do not affect the inner core (e.g., the crosslinked polyamine) and the outer polymeric shell (e.g., the polymeric material), and the core-shell configuration thereof.

According to some of any of the embodiments described herein, the hydrogel comprises an optimal cutting temperature (OCT) gel. In some of any of the embodiments described herein, the hydrogel matrix comprises a crosslinker and an optimal cutting temperature (OCT) gel.

As used herein and in the art, the phrase “OCT gel” describes a typically water-soluble gel which, when frozen, provides a suitable consistency that enables or facilitates cryosectioning while maintaining the structure and composition of the substances embedded therein (herein, the microstructure). OCT gel typically allow performing the cryosectioning at temperatures of −5, or −50 to ˜10° C., or lower.

According to some of any of the embodiments described herein, the OCT gel as described herein in any of the respective embodiments is or comprises water-soluble glycols and resins (e.g., including PEO and poly vinyl alcohol).

According to some of any of the embodiments described herein, the hydrogel matrix further comprises a crosslinker (e.g., a crosslinker as described herein in any of the respective embodiments).

In some of any of the embodiments described herein, the crosslinker as described herein in any of the respective embodiments is not soluble in the network that forms the hydrogel as described herein in any of the respective embodiments. In some of any of the embodiments described herein, the crosslinker as described herein in any of the respective embodiments is water-soluble, and in some of these embodiments, the crosslinker is soluble in the aqueous solution composition the hydrogel.

In some of any of the embodiments described herein, the hydrogel and the crosslinker in the hydrogel matrix are included in a volume ratio of from 1000:1 to 1:1, or from 100:1 to 1:1, or from 20:1 to 1:1 or from 10:1 to 1:1, including any intermediate values and subranges therebetween. In exemplary non-limiting embodiments, the volume ratio is about 6:1.

According to some of any of the embodiments described herein, the hydrogel matrix as described herein in any of the respective embodiments is characterized by a viscosity in the range of from 1000 to 20000 centipoises (cps) (i.e., from 1000 to 20000 mPa second), or from 2000 to 10000 cps (i.e., from 2000 to 10000 mPa second), including any intermediate values and subranges therebetween.

### Crosslinker:

According to some of any of the embodiments described herein, the crosslinker as described herein in any of the respective embodiments is compatible with the electrospinning process as described herein in any of the respective embodiments.

In some of any of the embodiments described herein, the crosslinker as described herein in any of the respective embodiments is water-miscible or water-soluble.

According to some of any of the embodiments described herein, the crosslinker is selected such that it is capable of penetrating the outer shell, as is discussed in further detail hereinunder.

According to some of any of the embodiments described herein, the crosslinker has a low MW, e.g., lower than 1,000, preferably lower than 500, or lower than 200, or lower than 120, or lower than 100, or even lower than 50, grams/mol, including any intermediate values and subranges therebetween.

According to some of any of the embodiments described herein, the crosslinker has a MW of from 30 to 1,000, or from 30 to 500, or from 30 to 200, or from 30 to 100, or from 50 to 500, or from 50 to 300, or from 50 to 200, or from 50 to 150, or from 50 to 100, grams/mol, including any intermediate values and subranges therebetween.

According to some of any of the embodiments described herein, the crosslinker as described herein in any of the respective embodiments comprises as least two moieties or chemical groups that readily react with amine groups of a polyamine as described herein in any of the respective embodiments under mild conditions.

As used herein, the phrase “readily reacts with” is equivalent to “prone to react with” and “reactive towards”, and means that the moieties or chemical groups of the crosslinker are likely to participate in chemical reactions with amino or amine groups, either spontaneously or under specific and preferably mild conditions (conditions which would not be considered by a skilled person to be “harsh”, e.g., under mild temperature, pressure, acidity), due to its chemical nature and ability to interact with other molecules or functional groups.

Non-limiting examples for such moieties or chemical groups that are prone to react with and/or is reactive towards amine or amino groups include aldehydes, ketones, isocyanates, carboxylic acids, anhydrides, epoxides, acyl chlorides, sulfonyl chlorides, and alkyl halides.

In this context, it is noted that although the interactions of certain crosslinkers (e.g., GA) with amino groups are not fully understood in literature, the phrases “prone to react with” and “reactive towards” emphasize the propensity of the crosslinker or crosslinking agent to engage in chemical reactions with amino or amine groups, particularly under conditions characterized by mild temperature, pressure, and acidity, conducive to efficient and selective crosslinking processes.

In some of any of the embodiments described herein, the crosslinker is or comprises a molecule having at least two electrophilic groups in its backbone, the electrophilic groups are capable of forming a covalent bond with an amine group under the mild conditions described herein.

According to some embodiments of the present invention, the crosslinker is capable of interacting with a polyamine as described herein via a Click reaction.

Herein and in the art, a Click reaction describes a class of highly efficient, selective, and modular chemical reactions characterized by their orthogonality (compatibility with various functional groups) and high yields under mild reaction conditions.

An exemplary Click reaction according to the present embodiments is a Schiff-base reaction between an aldehyde and an amine.

According to some the present embodiments, the crosslinker features at least one, and preferably two or more, groups that are capable of participating in a Click reaction, e.g., Schiff-base reaction, with amine groups.

According to some the present embodiments, the crosslinker features at least two, or preferably more, aldehyde group(s), and is therefore capable of forming covalent bonds with free amine groups, via a Schiff-base Click reaction. According to some embodiments of the present invention, the crosslinker is a polyaldehyde.

As used herein, the term “polyaldehyde” describes a compound that has at least two free aldehyde groups, as this term is defined herein.

Polyaldehydes can readily interact with various groups via “Schiff-base” chemistry, to form imine bonds, under mild conditions.

According to some of any of the embodiments described herein, the crosslinker is a biocompatible small molecule compounds, as defined herein, which features one or more, preferably two or more aldehyde groups.

An exemplary, non-limiting, crosslinker is glutaraldehyde (GA).

According to some of any of the embodiments described herein, the crosslinker is a modified saccharide, that features one or more, preferably two or more, aldehyde groups, that is, it is a saccharide of which one or more hydroxy groups have been oxidized and thereby converted to aldehyde(s). Such a modified saccharide is also referred to herein and in the art as an oxidized saccharide.

The term “saccharide” as used herein encompasses monosaccharides, disaccharides and oligosaccharides. The term “monosaccharide”, as used herein and is well known in the art, describes a simple form of a sugar that consists of a single saccharide molecule, which can be open-chain or cyclic (e.g., pyranose- or furanose-based), and which cannot be further decomposed by hydrolysis. Most common examples of monosaccharides include glucose (dextrose), fructose, galactose, and ribose. Monosaccharides can be classified according to the number of carbon atoms of the carbohydrate, i.e., triose, having 3 carbon atoms such as glyceraldehyde and dihydroxyacetone; tetrose, having 4 carbon atoms such as erythrose, threose and erythrulose; pentose, having 5 carbon atoms such as arabinose, lyxose, ribose, xylose, ribulose and xylulose; hexose, having 6 carbon atoms such as allose, altrose, galactose, glucose, gulose, idose, mannose, talose, fructose, psicose, sorbose and tagatose; heptose, having 7 carbon atoms such as mannoheptulose, sedoheptulose; octose, having 8 carbon atoms such as 2-keto-3-deoxy-manno-octonate; nonose, having 9 carbon atoms such as sialose; and decose, having 10 carbon atoms. Monosaccharides are the building blocks of oligosaccharides and disaccharides like sucrose (common sugar).

The term “disaccharide” describes a compound two monosaccharide units, which can be the same or different, covalently bound to one another, typically via a glucosyl bond.

The term “oligosaccharide” as used herein describes a compound that comprises three or more monosaccharide units, as these are defined herein, which can be the same or different. Preferably, the oligosaccharide comprises 3-6 monosaccharides units.

According to some of any of the embodiments described herein, the crosslinker is an oxidized saccharide, as defined herein, which features at least two, at least three, at least four, or more aldehyde groups; and/or which has been oxidized so as to covert at least one, preferably at least two, at least three or at least four, of its hydroxy groups, into aldehyde groups.

Methods of generating oxidized saccharides are well-known in the art.

Similarly, other compounds which feature a plurality of aldehyde groups (polyaldehydes), can be used, and can be selected in accordance with the reinforced matrix, as above.

Alternatively, or in addition, the crosslinker is an epoxide.

Herein, the term “epoxides” refers to a class of organic compounds characterized by a three-membered ring structure consisting of an oxygen atom and two adjacent carbon atoms. Epoxides are highly reactive due to the strain in the ring structure and the electron deficiency of the oxygen atom. As crosslinkers, epoxides can undergo ring-opening reactions with functional groups on other molecules, leading to the formation of covalent bonds.

In some of any of the embodiments described herein, the crosslinker as described herein in any of the respective embodiments is or comprises glutaraldehyde (GA). In some embodiments, the crosslinker as described herein in any of the respective embodiments and in any combination thereof, is glutaraldehyde (GA).

According to some of any of the embodiments described herein, a concentration of a crosslinker (e.g., a crosslinker as described herein in any of the respective embodiments) in the hydrogel matrix as described herein in any of the respective embodiments is in a range of from 0.1 to 90, or from 0.1 to 50, or from 1 to 50, or from 1 to 40, or from 1 to 30, or from 1 to 20, or from 5 to 50, or from 5 to 40, or from 5 to 30, or from 5 to 20, or from 1 to 25, or from 1 to 20, or from 1 to 15, or from 5 to 15, or from 5 to 10, or from 1 to 10, %, by weight, of the total weight of the hydrogel matrix.

In some of any of the embodiments described herein, the crosslinker and the polyamine are selected such that upon contacting one another, a visual change is obtained.

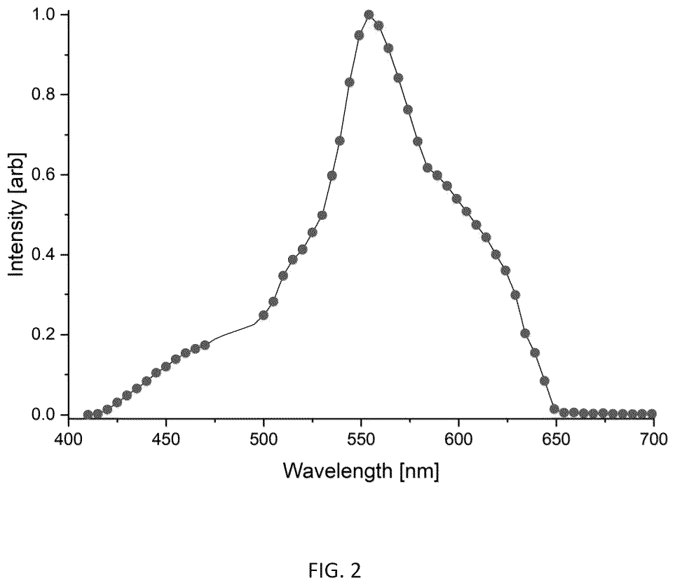

According to some of any of the embodiments described herein, when the crosslinker is a polyaldehyde as described herein, for example, GA, a plurality of imine bonds are formed with the polyamine. In such cases, the formation of chemically-crosslinked polyamine can be identified and/or monitored by, for example, spectroscopic measurements that can track the presence of imine bonds (for example, IR or NMR), as exemplified in FIG. 2.

### Sheath Solution:

According to some of any of the embodiments described herein, the solution that comprises the polymeric material (also being referred to herein interchangeably as a “sheath solution”) (e.g., a polymeric material that forms the outer shell as described herein in any of the respective embodiments) comprises a solvent in which the polymeric material is dissolvable. Preferably, the solvent is such that does not dissolve the fibrous microstructure.

According to some of any of the embodiments described herein, the solvent is a volatile solvent, that is, a solvent having a boiling temperature lower than 100, or lower than 80, or lower than 50, ° C., such that at least a portion of the solvent may evaporate during the process.

In some of any of the embodiments described herein, the solvent of the sheath solution (e.g., the volatile solvent) can be miscible or immiscible with water.

It is to be understood that the solvent of the sheath solution and the solvent of the core solution can be miscible in one another. In some of these embodiments, the solutions and the spinning process are such that enable laminar flow of the solutions (e.g., the core solution and the sheath solution are added by jetting as described herein, and/or the solutions are characterized by a viscosity as described herein), to thereby limit mixing of the solutions during the spinning process.

In some of any of the embodiments described herein, the sheath solution as described herein in any of the respective embodiments is characterized by a viscosity in the range of from 5 to 500000 centipoises (cps) (i.e., from 5 to 500000 mPa second), or from 5 to 350000 centipoises (cps) (i.e., from 5 to 350000 mPa second), or from 5 to 250000 cps (i.e., from 5 to 250000 mPa second), or from 5 to 100000 cps (i.e., from 5 to 100000 mPa second), or from 15 to 50000 centipoises (cps) (i.e., from 5 to 50000 mPa second), or from 5 to 10000 centipoises (cps) (i.e., from 5 to 10000 mPa second), or from 5 to 5000 cps (i.e., from 5 to 5000 mPa second), or from 5 to 1000 cps (i.e., from 5 to 1000 mPa second), or from 5 to 250000 cps (i.e., from 5 to 250000 mPa second), or from 5 to 10000 centipoises (cps) (i.e., from 5 to 10000 mPa second), or from 5 to 5000 cps (i.e., from 5 to 5000 mPa second), or from 5 to 1000 cps (i.e., from 5 to 1000 mPa second), or from 25 to 500000 cps (i.e., from 25 to 500000 mPa second), or from 25 to 250000 cps (i.e., from 25 to 250000 mPa second), or from 25 to 50000 centipoises (cps) (i.e., from 25 to 50000 mPa second), or from 25 to 10000 centipoises (cps) (i.e., from 25 to 10000 mPa second), or from 25 to 5000 cps (i.e., from 25 to 5000 mPa second), or from 100 to 500000 cps (i.e., from 100 to 500000 mPa second), or from 100 to 250000 cps (i.e., from 100 to 250000 mPa second), or from 100 to 100000 centipoises (cps) (i.e., from 100 to 100000 mPa second), or from 100 to 50000 centipoises (cps) (i.e., from 100 to 50000 mPa second), or from 100 to 5000 centipoises (cps) (i.e., from 100 to 5000 mPa second), or from 100 to 1000 cps (i.e., from 100 to 1000 mPa second), or from 100 to 500 cps (i.e., from 100 to 500 mPa second), or from 1000 to 500000 cps (i.e., from 1000 to 500000 mPa second), or from 1000 to 250000 cps (i.e., from 1000 to 250000 mPa second), or from 1000 to 100000 centipoises (cps) (i.e., from 1000 to 100000 mPa second), or from 1000 to 10) 50000 centipoises (cps) (i.e., from 1000 to 50000 mPa second), or from 1000 to 5000 centipoises (cps) (i.e., from 1000 to 5000 mPa second), or from 5000 to 500000 cps (i.e., from 5000 to 500000 mPa second), or from 5000 to 250000 cps (i.e., from 5000 to 250000 mPa second), or from 5000 to 100000 centipoises (cps) (i.e., from 5000 to 100000 mPa second), or from 5000 to 50000 centipoises (cps) (i.e., from 5000 to 50000 mPa second), including any intermediate value and subranges therebetween. The viscosity can be selected or manipulated so as to suit the process parameters and/or the parameters of the formed structures. A viscosity of the sheath solution may further facilitate a laminar flow of the core and sheath solutions in the spinning process. Herein throughout, a viscosity is as measured at room temperature. Viscosity is measured using a Brookfield® rheometer, but any other rheometer or viscometer can be used.

In some of any of the embodiments described herein, the volatile solvent is an organic solvent. Exemplary volatile solvents that are suitable for use in the context of these embodiments include, but are not limited to, tetrahydrofuran (THF), dimethylformamide (DMF), acetonitrile, methanol, ethanol, propanol, butanol, isopropanol, and a combination thereof. When two or more solvents are used, the solvents can be combined at any volume ratio, for example, from 1:1 to 1:10, including any intermediate values and subranges therebetween. In some embodiments, the volatile solvent is a mixture of tetrahydrofuran and dimethylformamide (e.g., in a ratio of from 1:1 v/v).

According to some of any of the embodiments described herein, a concentration of the polymeric material (i.e., that forms the outer shell) in the sheath solution is in a range of from 0.1 to 10, or is from 0.1 to 5, or is from 0.1 to 1, or is from 0.25 to 0.75, or is about 0.4 g/mL.

According to some of any of the embodiments described herein, a concentration of the polymeric material (i.e., that forms the outer shell) in the sheath solution is in a range of from 1 to 90, or from 1 to 80, or from 1 to 70, or from 1 to 80, or from 1 to 70, or from 1 to 60, or from 1 to 50, or from 10 to 90, or from 10 to 80, or from 10 to 70, or from 10 to 60, or from 10 to 50, or from 20 to 90, or from 20 to 80, or from 20 to 70, or from 20 to 60, or from 20 to 50, or from 30 to 90, or from 30 to 80, or from 30 to 70, or from 30 to 60, or from 30 to 50, or from 50 to 90, or from 50 to 890, or from 50 to 70, or from 10 to 50, or from 10 to 30, % by weight, including any intermediate values and subranges therebetween.

### Inner Core Solution

According to some of any of the embodiments described herein, a solution comprising the polyamine (e.g., as described in any of the respective embodiments and in any combination thereof), which is also referred to herein interchangeably as a “core solution” or “inner core solution”, further comprises a solvent in which the polyamine is dissolvable. Preferably, the solvent is selected such that the crosslinked polyamine is dissolvable in. In some of any of the embodiments described herein, the volatile solvent is selected such that the polyamine is dissolvable in or miscible with it.

According to some of any of the embodiments described herein, the solvent is a volatile solvent (e.g., a solvent having boiling temperature lower than 120, or lower than 100, or lower than 80, or lower than 50, ° C.), as described herein in any of the respective embodiments.

In some of any of the embodiments described herein, the volatile solvent is selected such that the crosslinked polyamine is not dissolvable or is immiscible in it.

In some of any of the embodiments described herein, the volatile solvent (i.e., of the core solution) is water immiscible. In some of any of the embodiments described herein, the volatile solvent is an organic solvent. Exemplary volatile solvents that are suitable for use in the context of these embodiments include, but are not limited to, chloroform, diethyl ether, pentane, hexane, dichloromethane, and a combination thereof. In some embodiments, the volatile solvent is chloroform.

According to some of any of the embodiments described herein, a concentration of the polyamine in the core solution is in a range of from 0.1 to 10, or is from 0.1 to 5, or is from 0.1 to 1, or is from 0.25 to 0.75, or is about 0.5 g/mL.

According to some of any of the embodiments described herein, a concentration of the polyamine in the core solution is in a range of from 1 to 100, or from 1 to 99.9, or from 1 to 99, or from 1 to 97, or from 1 to 95, or from 1 to 90, or from 1 to 80, or from 1 to 70, or from 1 to 80, or from 1 to 70, or from 1 to 60, or from 1 to 50, or from 10 to 100, or from 10 to 99.9, or from 10 to 99, or from 10 to 97, or from 10 to 95, or from 10 to 90, or from 10 to 80, or from 10 to 70, or from 10 to 60, or from 10 to 50, or from 20 to 100, or from 20 to 99.9, or from 20 to 99, or from 20 to 97, or from 20 to 95, or from 20 to 90, or from 20 to 80, or from 20 to 70, or from 20 to 60, or from 20 to 50, or from 30 to 100, or from 30 to 99.9, or from 30 to 99, or from 30 to 97, or from 30 to 95, or from 30 to 90, or from 30 to 80, or from 30 to 70, or from 30 to 60, or from 30 to 50, or from 50 to 100, or from 50 to 99.9, or from 50 to 99, or from 50 to 97, or from 50 to 95, or from 50 to 90, or from 50 to 80, or from 50 to 70, or from 70 to 100, or from 70 to 99.9, or from 70 to 99, or from 70 to 97, or from 70 to 95, or from 10 to 50, or from 80 to 100, or from 80 to 99.9, or from 80 to 99, or from 80 to 97, or from 80 to 95, or from 85 to 100, or from 85 to 99.9, or from 85 to 99, or from 85 to 97, or from 85 to 95, or from 10 to 30, % by weight, including any intermediate values and subranges therebetween.

According to some of any of the embodiments described herein, a solution comprising the polyamine (e.g., as described in any of the respective embodiments and in any combination thereof) further comprises one or more additional polymeric material(s) (e.g., additional polymeric materials as described in any of the respective embodiments).

In some of any of the embodiments described herein, the volatile solvent is selected such that the additional polymeric material is dissolvable in or miscible with it.

In some of any of the embodiments described herein, a weight ratio of a polyamine (e.g., a polyamine as described in any of the respective embodiments) and an additional polymeric material (e.g., an additional polymeric material as described in any of the respective embodiments) in the solution comprising the polyamine is in a range of from 10,000:1 to 1:1000, or from 1000:1 to 1:100, or from 100:1 to 1:10, or from 50:1 to 1:1, or from 20:1 to 1:1, or is about 10:1, respectively (polyamine-to-additional polymeric material), including any values and subranges therebetween.

According to some of any of the embodiments described herein, the additional polymeric material(s) as described herein in any of the respective embodiments increase(s) a viscosity of the solution comprising the polyamine, in comparison with a solution which does not comprise the additional polymeric material(s).

According to some of any of the embodiments described herein, the core solution as described herein in any of the respective embodiments is characterized by a viscosity in the range of from 5 to 500000 centipoises (cps) (i.e., from 5 to 500000 mPa second), or from 5 to 350000 centipoises (cps) (i.e., from 5 to 350000 mPa second), or from 5 to 250000 cps (i.e., from 5 to 250000 mPa second), or from 5 to 100000 cps (i.e., from 5 to 100000 mPa second), or from 15 to 50000 centipoises (cps) (i.e., from 5 to 50000 mPa second), or from 5 to 10000 centipoises (cps) (i.e., from 5 to 10000 mPa second), or from 5 to 5000 cps (i.e., from 5 to 5000 mPa second), or from 5 to 1000 cps (i.e., from 5 to 1000 mPa second), or from 5 to 250000 cps (i.e., from 5 to 250000 mPa second), or from 5 to 10000 centipoises (cps) (i.e., from 5 to 10000 mPa second), or from 5 to 5000 cps (i.e., from 5 to 5000 mPa second), or from 5 to 1000 cps (i.e., from 5 to 1000 mPa second), or from 25 to 500000 cps (i.e., from 25 to 500000 mPa second), or from 25 to 250000 cps (i.e., from 25 to 250000 mPa second), or from 25 to 50000 centipoises (cps) (i.e., from 25 to 50000 mPa second), or from 25 to 10000 centipoises (cps) (i.e., from 25 to 10000 mPa second), or from 25 to 5000 cps (i.e., from 25 to 5000 mPa second), or from 100 to 500000 cps (i.e., from 100 to 500000 mPa second), or from 100 to 250000 cps (i.e., from 100 to 250000 mPa second), or from 100 to 100000 centipoises (cps) (i.e., from 100 to 100000 mPa second), or from 100 to 50000 centipoises (cps) (i.e., from 100 to 50000 mPa second), or from 100 to 5000 centipoises (cps) (i.e., from 100 to 5000 mPa second), or from 100 to 1000 cps (i.e., from 100 to 1000 mPa second), or from 100 to 500 cps (i.e., from 100 to 500 mPa second), or from 1000 to 500000 cps (i.e., from 1000 to 500000 mPa second), or from 1000 to 250000 cps (i.e., from 1000 to 250000 mPa second), or from 1000 to 100000 centipoises (cps) (i.e., from 1000 to 100000 mPa second), or from 1000 to 10) 50000 centipoises (cps) (i.e., from 1000 to 50000 mPa second), or from 1000 to 5000 centipoises (cps) (i.e., from 1000 to 5000 mPa second), or from 5000 to 500000 cps (i.e., from 5000 to 500000 mPa second), or from 5000 to 250000 cps (i.e., from 5000 to 250000 mPa second), or from 5000 to 100000 centipoises (cps) (i.e., from 5000 to 100000 mPa second), or from 5000 to 50000 centipoises (cps) (i.e., from 5000 to 50000 mPa second), including any intermediate value and subranges therebetween. The viscosity can be selected or manipulated so as to suit the process 15 parameters and/or the parameters of the formed structures. A viscosity of the core solution may further facilitate a laminar flow of the core and sheath solutions in the spinning process.

According to some of any of the embodiments described herein, the core solution and the sheath solution are selected such that the solutions are immiscible in one another, for example, by selecting solvents or a mixture of solvents that are immiscible with one another.

As discussed in the Examples section that follows, the formation of a plurality of spheres in the inner core takes advantage of the emulsification phenomenon involved in the formation of a plurality of spheres (e.g., spheres as described herein in any of the respective embodiments) by the polyamine, within the outer polymeric shell.

According to some of any of the embodiments described herein, the polyamine, the crosslinker, the hydrogel, and the solutions of the core and the shell are selected such that a formation of a crosslinked polyamine droplet within an interface of the solutions and the hydrogel is enabled or promoted.

In some of any of the embodiments described herein, the reaction (i.e., crosslinking) between the polyamine and the crosslinker as described herein in any of the respective embodiments is devoid of an emulsifying agent. According to these embodiments, none of the solutions and hydrogel matrix that participate in the process comprises an emulsifying agent.

As used herein, the phrase “emulsifying agent” is also referred to as “emulsifier”, and describes a chemical substance that acts as a stabilizer for emulsions, preventing liquids that are immiscible with one another from separating, typically by increasing the kinetic stability of the emulsion by e.g., lowering the interfacial tension between the liquids. Emulsifying agents typically have a lipophilic group and a hydrophilic group, and can be categorized as ionic (e.g., cationic, anionic, or zwitterionic) or non-ionic agents.

As used herein and in the art, the term “emulsion” refers to a colloid of two or more immiscible liquids where one liquid contains a dispersion of the other liquids. In other words, an emulsion is a special type of mixture made by combining two liquids that normally don't mix (i.e., form a phase separation). Emulsification is the process of turning a liquid mixture into an emulsion. Emulsification may occur when the interfacial surface tension between two liquids is reduced.

In some of any of the embodiments described herein, the emulsion is obtained or obtainable at an interface of the core solution and the sheath solution. As used herein and in the art, the term “interface” of two solutions refers to the boundary or region where two distinct solutions come into contact with each other but do not mix or blend. Typically there is a clear separation between the two solutions at the interface, with each maintaining its own composition and properties. The interface may be visible as a distinct boundary or layer, and it is often characterized by surface 15 phenomena such as surface tension, interfacial tension, and surface adsorption.

As demonstrated in the Examples section that follows, a formation of the spheres is affected (i.e., controlled, governed) by a formation of the crosslinked polyamine. In some embodiments, the polyamine is selected such that it enables a formation of the crosslinked polyamine within up to 120 seconds, or up to 110 seconds, or up to 100 seconds, or up to 90 seconds, or up to 80 seconds, or up to 70 seconds, or up to 60 seconds, or up to 50 seconds, or up to 40 seconds, or up to 30 seconds, starting from a contact between a solution comprising the polyamine and a hydrogel matrix as described herein or any other solution or matrix that comprises the crosslinker.

According to an aspect of some embodiments of the present invention there is provided a (e.g., fibrous) microstructure (e.g., as described herein in any of the respective embodiments and in any combinations thereof) which is obtainable by a method as described herein in any of the respective embodiments and in any combination thereof.

### Tubular Structures:

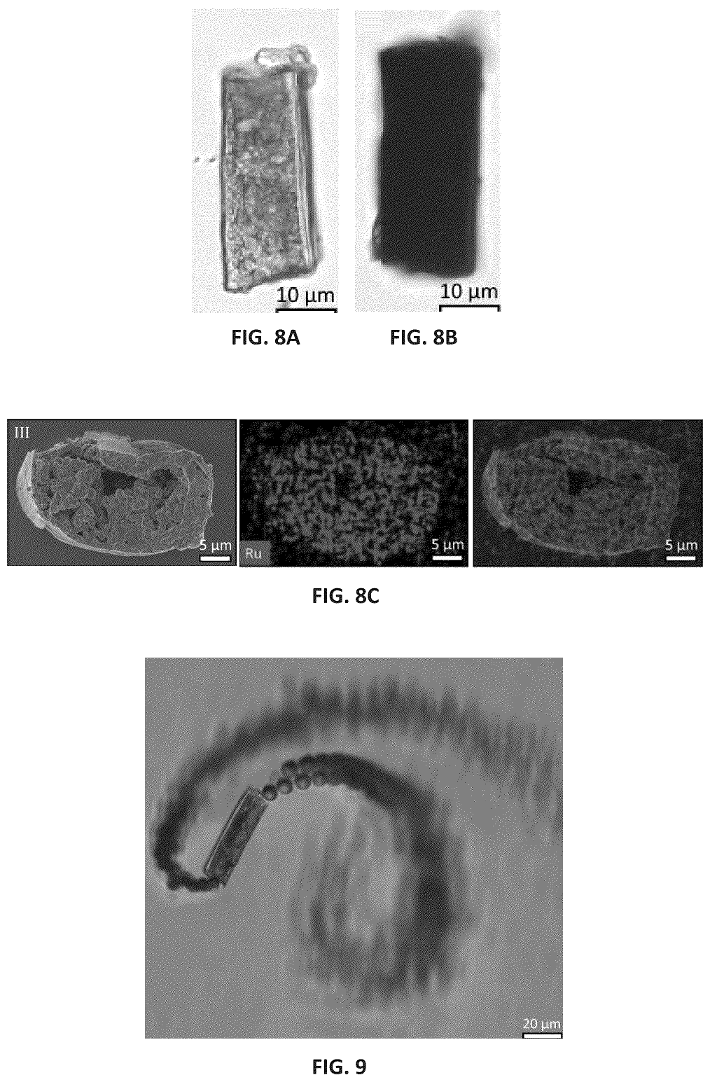

As demonstrated in the Examples section that follows, the architecture (i.e., inner structure, morphology) of a microstructure (e.g., its inner core) is affected by the concentration of the crosslinker as described herein in any of the respective embodiments. In the absence of a crosslinker, a hollow tubular structure is obtained, as shown, e.g., in FIG. 7A. In low concentrations of the crosslinker, microstructures which comprise little or no inner core are obtained. In lower concentrations of a crosslinker, the crosslinking process of the polyamine in the inner core is less effective and results in a solution or a semi-solid comprising the crosslinked polyamine which is consequently washed away during purification of the structure.

According to an aspect of some embodiments of the present invention there is provided a method or process for preparing a hollow tubular structure, which is effected by subjecting a solution comprising a polymeric material that forms the outer shell (e.g., a polymeric material as described herein in any of the respective embodiments and in any combinations thereof) and a solution comprising a polyamine as described herein in any of the respective embodiments and in any combinations thereof to an electrospinning process within a hydrogel matrix, as described herein in any of the respective embodiments and in any combinations thereof, wherein the hydrogel matrix optionally comprises a crosslinker in a low concentration (e.g., a concentration that does not provide the spheres as described herein in any of the respective embodiments). In exemplary embodiments, a concentration of the crosslinker is lower than 5%, or lower than 2%, and can range, for example, from 0.1 to 5, or from 0.1 to 4, or from 0.1 to 3, or from 0.1 to 2, or from 0.1 to 1, or from 0.1 to 0.5% by weight, of the total weight of the hydrogel. In exemplary embodiments, a concentration of the crosslinker is lower than 0.1% by weight or is null.

### Microstructures:

According to an aspect of some embodiments of the present invention there is provided a microstructure comprising an inner core enveloped by an outer shell (also being referred to herein interchangeably as “outer polymeric shell”, “polymeric shell”, “shell” or “sheath”). According to some of any of the embodiments described herein, the inner core comprises a (e.g., porous) structure comprising a chemically-crosslinked polyamine (also being referred to herein interchangeably as a “crosslinked polyamine”) (i.e., is made of a polyamine).

Herein, the term “microstructure” describes a structure, that is, a core-sheath structure as described herein, featuring at least one dimension within the micron scale of from 1 to 1000 microns. In some embodiments, a microstructure as described herein features at least an average diameter in the micron scale.

According to some of any of the embodiments described herein, the microstructure features an average diameter in a range of from 1 to 500, or from 1 to 400, or from 1 to 300, or from 1 to 200, or from 1 to 100, microns, including any intermediate values and subranges therebetween.

According to some of any of the embodiments described herein, the microstructure features an average diameter in a range of from 10 to 1000, or from 10 to 500, or from 10 to 400, or from 10 to 300, or from 10 to 200, or from 10 to 100, microns, including any intermediate values and subranges therebetween.

According to some of any of the embodiments described herein, the microstructure features an average diameter in a range of from 1 to 50, or from 1 to 30, or from 1 to 20 μm, or from 10 to 50, or from 10 to 40, or from 10 to 30, or from 20 to 40, or from 20 to 30, or from 10 to 20, micron, including any intermediate values and subranges therebetween.

Herein throughout, the terms “micron”, “micrometer”, and “μm” are used interchangeably.

Herein throughout, whenever an average diameter is described with respect to the microstructure, it refers to the outer diameter, of both the outer shell and the inner core enveloped thereby, unless otherwise indicated.

According to some of any of the embodiments described herein, the inner core is at least partially enveloped by the outer shell, as described herein in ant of the respective embodiments and any combination thereof, and in some embodiments, the inner core is enveloped by the outer shell such that it is completed enclosed within the outer shell, as schematically exemplified in FIG. 3.

The phrase “enveloped by” as used herein describes that the inner core is encased in/enclosed within/surrounded by/coated with/wrapped in/covered by/enfolded by/embedded in the polymeric shell, thus is located around the inner core.

According to some of any of the embodiments described herein, and as described in further detail hereinunder, a microstructure as described herein in any of the respective embodiments and any combination thereof can be prepared by electrospinning, and is typically obtained as a fibrous microstructure, for example, an electrospun microstructure.

The phrase “fibrous microstructure” as used herein throughout describes a microstructure as described herein, which has a fiber-like shape, that is, a shape of an elongated fibril or strand. In exemplary embodiments, a fibrous microstructure features an aspect ratio (length/average diameter) of at least 2, preferably of at least 10, or at least 50 or at least 100, for example, of from 10 to 10⁶, or from 10 to 10⁵, or from 10 to 10⁴, or from 10 to 10³, or from 10 to 1000, or from 10 to 100, or from 2 to 100, including any intermediate values and subranges therebetween.

According to some of any of the embodiments described herein, a length of a fibrous microstructure as described herein is in a range of from 10 microns to 100 meters, or from 100 microns to 100 meters, or from 1 mm to 100 meters, or from 10 microns to 50 meters, or from 100 microns to 50 meters, or from 1 mm to 50 meters, or from 10 microns to 25 meters, or from 100 microns to 25 meters, or from 1 mm to 25 meters, or from 10 microns to 10 meters, or from 100 microns to 10 meters, or from 1 mm to 10 meters, 10 microns to 1000 cm, or from 100 microns to 100 cm, or from 1 mm to 100 cm, or from 1 mm to 1 cm, including any intermediate values and subranges therebetween.

According to some of any of the embodiments described herein, a microstructure as described herein is in a form of a microcylinder, or a microtube, or a microsphere, or any other round-based form.

According to some of any of the embodiments described herein, the microstructure is in a form of a microcylinder structure, or cylindrical microstructure, featuring at least an average diameter in the micron scale as described herein. Herein throughout, the terms “microcylinder”, “microcylinder particles”, “MC”, “cylindrical particles”, “cylindrical microstructure” and others, are used interchangeably.

According to some of any of the embodiments described herein, the cylindrical microstructure features an (e.g., average) aspect ratio (length to diameter), of at least 0.5, or at least 1, or at least 1.5, for example, or from 0.5 to 5, or from 1 to 5, or from 0.5 to 2, or from 1 to 2, including any intermediate values and subranges therebetween.

According to some of any of the embodiments described herein, an average diameter of the inner core as described herein in any of the respective embodiments is in a range of from 0.1 to 500, or from 1 to 500, or from 0.1 to 400, or from 1 to 400, or from 0.1 to 300, or from 1 to 300, or from 0.1 to 200, or from 1 to 200, or from 0.1 to 100, or from 1 to 100, or from 0.1 to 50, or from 1 to 50, or from 0.1 to 30, or from 1 to 30, or from 0.1 to 20, or from 1 to 20, or from 0.1 to 10, or from 1 to 10, or from 5 to 50, or from 10 to 50, or from 5 to 40, or from 10 to 40, or from 5 to 30, or from 10 to 30, or from 5 to 20, or from 10 to 20, or from 5 to 15, or from 10 to 15, microns, including any intermediate values and subranges therebetween.

According to some of any of the embodiments described herein, an average thickness of the outer shell as described herein in any of the respective embodiments is in a range of from 0.1 to 100, or from 1 to 100, or from 0.1 to 50, or from 1 to 50, or from 0.1 to 30, or from 1 to 30, or from 0.1 to 20, or from 1 to 20, or from 0.1 to 10, or from 1 to 10, or from 5 to 10, or from 1 to 5, microns, including any intermediate values and subranges therebetween.

As used herein, the terms “diameter” and “diameters” refer to a cross-sectional dimension of a respective structure. Herein, the phrase “outer diameter” refers to the diameter of the entire microstructure, edge to edge. Herein, the phrase “inner diameter” encompasses the diameter including the inner shell and the spheres inside.

According to some of any of the embodiments described herein, the inner core comprises a plurality of spheres. In some of any of the embodiments described herein, the plurality of spheres are at least partially enveloped by an inner shell (also being referred to herein interchangeably as “inner sheath”).

In some of any of the embodiments described herein, an inner sheath (e.g., an inner sheath as described herein in any of the respective embodiments) is located between (i.e., co-axially to) the porous structure (e.g., the crosslinked polyamine) and the outer polymeric shell (e.g., the polymeric material).

According to some of any of the embodiments described herein, an average thickness of the inner sheath as described herein in any of the respective embodiments, if present, is in a range of from 0.01 to 3, or of from 0.01 to 2, or of from 0.1 to 3, or from 0.01 to 1, or from 0.1 to 1, or from 0.1 to 0.5, microns, including any intermediate values and subranges therebetween.

In some of the embodiments described herein, the plurality of spheres and/or the inner sheath are surrounded (e.g., layered) by a void (e.g., by a gas such as air or by a solution, a liquid, a solvent).

In some of the embodiments described herein, the inner core and the outer shell are separated by a gap (e.g., a void as described herein in any of the respective embodiments).

According to some of any of the embodiments described herein, the (e.g., fibrous) microstructure is characterized by a porosity in a range of from 10 to 99.9%, or from 10 to 99%, or from 10 to 97%, or from 10 to 95%, or from 10 to 90%, or from 20 to 99.9%, or from 20 to 99%, or from 20 to 97%, or from 20 to 95%, or from 20 to 90%, or from 25 to 99.9%, or from 25 to 99%, or from 25 to 97%, or from 25 to 95%, or from 25 to 90%, or from 30 to 99.9%, or from 30 to 99%, or from 30 to 97%, or from 30 to 95%, or from 30 to 90%, or from 40 to 99.9%, or from 40 to 99%, or from 40 to 97%, or from 40 to 95%, or from 40 to 90%, or from 45 to 99.9%, or from 45 to 99%, or from 45 to 97%, or from 45 to 95%, or from 45 to 90%, including any intermediate values and subranges therebetween. Porosity can be determined using methods and techniques as known in the art, for example, by measuring the surface area using Brunauer-Emmett-Teller (BET) method, or by measuring void volume (e.g., using pycnometry).

### Outer Shell:

According to some of any of the embodiments described herein, the outer shell in the microstructures as described herein in any of the respective embodiments is made of a polymeric material and is also referred to herein interchangeably as a polymeric shell or a polymeric outer shell.

According to some of any of the embodiments described herein, the outer shell features a continuous structure and is also referred to herein as a sheath, an outer sheath or a polymeric sheath.

In some of the embodiments described herein, the outer polymeric shell is devoid of a polyamine (e.g., a polyamine as described herein in any of the respective embodiments).

In some of the embodiments described herein, the outer polymeric shell is devoid of the plurality of spheres as described herein in any of the respective embodiments.

According to some of any of the embodiments described herein, the polymeric shell as described herein in any of the respective embodiments is water-immiscible or water-insoluble.

According to some of any of the embodiments described herein, the polymeric shell as described herein in any of the respective embodiments is made of a polymeric material that is water-immiscible or water-insoluble.

According to some of any of the embodiments described herein, the polymeric material that forms the outer shell as described herein in any of the respective embodiments is immiscible with and/or non-dissolvable in the OCT gel as described herein in any of the respective embodiments.

According to some of any of the embodiments described herein, the polymeric material that forms the outer shell is compatible with the electrospinning conditions as described herein in any of the respective embodiments.

According to some of any of the embodiments described herein, the polymeric material that forms the outer shell as described herein in any of the respective embodiments and the polyamine as described herein in any of the respective embodiments are not dissolvable in one another.

In some of any of the embodiments described herein, the outer shell is devoid of the chemically-crosslinked polyamine that forms the inner core.

Herein throughout, by “devoid of” it is meant an amount that does not exceed 0.1%, or 0.05%, or 0.01%, or 0.005%, by weight, of the total weight of the respective portion or material, or is nullified.

According to some of any of the embodiments described herein, the outer shell is hydrophobic. According to some of any of the embodiments described herein, the polymeric shell as described herein in any of the respective embodiments is made of a polymeric material that is hydrophobic.

As used herein throughout, the term “hydrophobic” describes a physical property of a material or a portion of a material (e.g., a chemical group or moiety in a compound) which accounts for lack of transient formation of bond(s) with water molecules, and thus for water-immiscibility, and is miscible or dissolvable in hydrocarbons.

A hydrophobic material or portion of a material (e.g., a chemical group or moiety in a compound) is one that is typically non-charged or non-charge-polarized and does not tend to form hydrogen bonds.

Hydrophobic materials dissolve more readily in oil than in water or other hydrophilic solvents. Hydrophobic materials can be determined by, for example, as having Log P higher than 1, when Log P is determined in octanol and water phases, at room temperature.

Hydrophobic materials can alternatively, or in addition, be determined as featuring a lipophilicity/hydrophilicity balance (HLB), according to the Davies method, lower than 9, preferably lower than 6.

A hydrophobic material can have one or more hydrophobic groups or moieties that render the material hydrophobic. Such groups are typically non-polar groups or moieties.

As used herein throughout, the term “hydrophilic” describes a physical property of a material or a portion of a material (e.g., a chemical group in a compound) which accounts for transient formation of bond(s) with water molecules, typically through hydrogen bonding.

Hydrophilic materials dissolve more readily in water than in oil or other hydrophobic solvents. Hydrophilic materials can be determined by, for example, as having Log P lower than 0.5, when Log P is determined in octanol and water phases, at room temperature.

Hydrophilic materials can alternatively, or in addition, be determined as featuring a lipophilicity/hydrophilicity balance (HLB), according to the Davies method, of at least 10, or of at least 12.

As used herein throughout, the term “amphiphilic” describes a property of a material that combines both hydrophilicity, as described herein for hydrophilic materials, and hydrophobicity or lipophilicity, as defined herein for hydrophobic materials.

Amphiphilic materials typically comprise both hydrophilic groups as defined herein and hydrophobic groups, as defined herein, and are substantially soluble in both water and a water-immiscible solvent (oil).

Amphiphilic materials can be determined by, for example, as having Log P of 0.8 to 1.2, or of about 1, when Log P is determined in octanol and water phases, at room temperature.

Amphiphilic materials can alternatively, or in addition, be determined as featuring a lipophilicity/hydrophilicity balance (HLB), according to the Davies method, of 3 to 12, or 3 to 9.

A hydrophilic material or portion of a material (e.g., a chemical group in a compound) is one that is typically charge-polarized and capable of hydrogen bonding.

Amphiphilic materials typically comprise one or more hydrophilic groups (e.g., a charge-polarized group), in addition to hydrophobic groups.

According to some of any of the embodiments described herein, the polymeric material that forms the outer shell is or comprises a biocompatible polymer and/or falls under the category of GRAS or of “Generally safe for use”.

According to some of any of the embodiments described herein, the polymeric material that forms the outer shell is or comprises a degradable polymer, or otherwise a polymer that can be decomposed (e.g., hydrolyzed) under relatively mild conditions.

According to some of any of the embodiments described herein, the outer shell is formed of a polymeric material that is a degradable, and is water-immiscible or water insoluble.

According to some of any of the embodiments described herein, the outer shell is formed of one or more polymeric materials.

According to some of any of the embodiments described herein, the one or more polymeric material(s) used to form the outer shell are selected such that it is non-dissolvable, insoluble, or immiscible in the polyamine that forms that inner core (both when chemically-crosslinked and when non-crosslinked). In other words, the polymeric material that forms the outer shell and the polyamine that formed the inner core are selected as non-dissolvable or immiscible in one another.

Herein throughout, the term “miscible” describes a material which is at least partially dissolvable or dispersible in another material as indicated, that is, at least 50% of the molecules move into the other material upon mixture, at room temperature. This term encompasses the terms “soluble” and “dispersible”.

Herein throughout, the term “soluble” describes a material that when mixed with water in equal volumes or weights, a homogeneous solution is formed.

Herein throughout, the phrase “water-miscible” describes a material which is at least partially dissolvable or dispersible in water, that is, at least 50% of the molecules move into the water upon mixture. This term encompasses the phrase “water-soluble” and “water dispersible”.

Herein throughout, the phrase “water-soluble” describes a material that when mixed with water in equal volumes or weights, a homogeneous solution is formed.

According to some of any of the embodiments described herein, the polymeric material that forms the outer shell as described herein in any of the respective embodiments is penetratable by the crosslinker as described herein in any of the respective embodiments.

According to some of any of the embodiments described herein, the outer shell is made of a polymeric material that is selected as penetratable to the crosslinker that is used to form the crosslinked polyamine in the inner core.

As used herein, a “polymeric material that is penetratable to a crosslinker” refers to a polymer which allows the crosslinker to permeate or pass through its structure. Such materials include, for example, materials featuring intermolecular spaces that are larger in size than the size of the crosslinker molecule and/or which do not interact with the crosslinker.

According to some of any of the embodiments described herein, the polymeric material that forms the outer shell as described herein in any of the respective embodiments and the crosslinker as described herein in any of the respective embodiments are selected such that the crosslinker can penetrate through the outer shell, so to effect crosslinker of the polyamine in the inner core.

According to some of any of the embodiments described herein, the polymeric shell as described herein in any of the respective embodiments is made of a polymeric material (e.g., a polymeric material that forms the outer shell as described herein in any of the respective embodiments) that is penetratable to a crosslinker, and which is immiscible with the polyamine or the crosslinked polyamine that forms the inner core.

Representative examples of polymeric materials that are suitable for use in forming the outer shell include, but are not limited to, polyesters, including poly-lactic-co-glycolic acid (PLGA), poly-(lactic acid (PLA), and polycaprolactones (PCL), polystyrene (PS), Polyvinylidene fluoride (PVDE), poly(ethylene oxide) (PEO), poly propylene oxide, poly amides, poly carbonate, polyurethane, polyvinyl chloride (PVC), polydimethylsiloxane (PDMS) and other silicone polyethers, polymethyl methacrylate (PMMA), poly vinyl cinnamate, co-polymers and of any of the foregoing and any combination thereof.

According to some of any of the embodiments described herein, the outer shell is made of a polymeric material that is or comprises poly-lactic-co-glycolic acid (PLGA).

### Inner Core:

According to the present embodiments, the inner core in the microstructure comprises a chemically-crosslinked polyamine.

The term “polyamine” as used herein throughout describes an organic compound that features one or more amine groups, as defined herein. The one or more amine groups can each independently be an amine linking group or an amine end group, as defined herein.

In some of any of the embodiments described herein, the polyamine is a hydrocarbon, as defined herein, featuring at least two amino groups, wherein the hydrocarbon is preferably, but not necessarily, a saturated hydrocarbon.

In some of any of the embodiments described herein, the one or more amino groups can each independently be a primary amino group, a secondary amino group, and a tertiary amino group, and preferably is/are independently a primary amino group or a secondary amino group, more preferably a primary amino group.

In some of any of the embodiments described herein, at least one of the amine groups in the polyamine is a primary amine group.

In some of any of the embodiments described herein, the hydrocarbon is interrupted by one or more amino group (e.g., secondary or tertiary amine groups). In some of any of the embodiments described herein, the hydrocarbon is interrupted by at least one —O—, and features amine end groups.

In some of any of the embodiments described herein, the amino groups as described herein are primary end and/or secondary linking groups (i.e., —NH₂ and/or —NH—, respectively), although substituted amines are also contemplated.

In some of any of the embodiments described herein, all of the amino groups of the polyamine as described herein in any of the present embodiments are primary amino groups (i.e., —NH₂).

According to some of any of the embodiments described herein, a polyamine comprises one or more hydrocarbon chains, and one or more of these chains is/are interrupted and/or terminated by an amine. The hydrocarbon chains can be all-carbon chains that are substituted and/or terminated by one or more amine groups and/or can be further interrupted by one or more of a secondary or tertiary amine and —O—. When one or more of the chains is interrupted by —O—, such a compound is also referred to herein and in the art as polyether amine.

In exemplary, non-limiting embodiments, the polyamine comprises 2, 3, or more alkylene glycol groups and/or oligo (alkylene glycol) groups and/or poly (alkylene glycol) groups, and at least two or each of these groups terminates by an amine group (e.g., a primary amine). Such polyamines are also referred to as polyether amines or poly (alkylene glycol) amines.

In some of any of the embodiments described herein, the polyamine as described herein in any of the respective embodiments has from 2 to 10, or from 2 to 5, amine groups, including any intermediate values and subranges therebetween.

In some of any of the embodiments described herein, the polyamine as described herein in any of the respective embodiments can be a branched polyamine, a linear polyamine, or a combination thereof.

In some of any of the embodiments described herein, the polyamine as described herein in any of the respective embodiments has from 2 to 10, or from 2 to 5 amine groups, and is a branched polyamine.

According to some of any of the embodiments described herein, a branched polyamine comprises a branching unit, as defined herein, from which two or more hydrocarbon chains extend, and in which one or more of these chains is/are interrupted and/or terminated by an amine. For example, a branching unit can be, for example, a branched alkyl, or a cycloalkyl, from which 2 or 3, or 4, such hydrocarbon chains extend. The hydrocarbon chains can be all-carbon chains that are substituted and/or terminated by one or more amine groups and/or can be further interrupted by one or more of a secondary or tertiary amine and —O—. When one or more of the chains is interrupted by —O—, such a compound is also referred to herein and in the art as a branched polyether amine.

In exemplary, non-limiting embodiments, the branched polyamine comprises 2, 3, or more alkylene glycol groups and/or oligo (alkylene glycol) groups and/or poly(alkylene glycol) groups that terminate by an amine group (e.g., a primary amine). Such polyamines are also referred to as branched polyether amines or branched poly(alkylene glycol) amines.

According to some of any of the embodiments described herein, the polyamine as described herein in any of the respective embodiments is a polyether amine, as described herein, for example, a poly(alkylene glycol) amine. According to some of any of the embodiments described herein, the polyamine as described herein in any of the respective embodiments is a branched polyether amine, such as defined herein.

In exemplary embodiments, the polyamine, as described herein in any of the respective embodiments and in any combination thereof, is trimethylolpropane tris[poly(propylene glycol), amine terminated] ether (i.e., JEFFAMINE® T-403).

In some of any of the embodiments described herein, the polyamine comprises one type of polyamine. In alternative embodiments, the polyamine comprises more than one type of polyamine (i.e., a mixture of polyamines).

In some of any of the embodiments described herein, the polyamine as described herein in any of the respective embodiments is characterized by a molecular weight (MW) in a range of from 50 to 10000, or from 50 to 5000, or from 100 to 5000, or from 100 to 4000, or from 100 to 3000, or from 200 to 3000, or from 200 to 2500, or from 200 to 2000, or from 200 to 2000, or from 200 to 1600, or from 200 to 1500, or from 200 to 1200, or from 200 to 1000, or from 200 to 900, or from 200 to 700, or from 200 to 500, or from 220 to 500, or from 220 to 450, grams/mol, including any intermediate values and subranges therebetween.

In some of any of the embodiments described herein, the polyamine as described herein in any of the respective embodiments is characterized by a molecular weight (MW) in a range of from 50 to 1000, or from 50 to 500, or from 100 to 1000, or from 100 to 500, or from 100 to 300, or from 200 to 300, or from 200 to 500, or from 200 to 400, or from 200 to 1000, or from 200 to 800, or from 300 to 1000, or from 300 to 800, or from 300 to 500, or from 200 to 700, or from 250 to 450, grams/mol, including any intermediate values and subranges therebetween. In some of any of these embodiments, the polyamine is a polyether amine, for example, a branched polyether amine as described herein.

According to some of any of the embodiments described herein, the polyamine is in liquid form at room temperature.

In some of any of the embodiments described herein, the polyamine as described herein in any of the respective embodiments is water-miscible or water-soluble.

Exemplary polyamines that are suitable for use in the context of the present embodiments include, but are not limited to, tetraethylenepentamine (TEPA), trimethylolpropane tris[poly(propylene glycol), polyoxyalkyleneamines (e.g., Jeffamine® products containing an average functionality of 1.5 or more amine groups per molecule), poly(ethylene glycol) diamines, 1,4-bis(2-aminoethyl) piperazine, butanediamine, hexanediamine, dimer diamine (e.g., Priamine™ 1074, supplied by Croda), diaminocyclohexane, norbornane diamine, 1,12-dodecanediamine, 1,10-decanediamine, isophorone diamine, and any combination thereof.

According to some of any of the embodiments described herein, the polyamine as described herein in any of the respective embodiments is or comprises one or more of tetraethylenepentamine (TEPA), trimethylolpropane tris[poly(propylene glycol), amine terminated] ether (JEFFAMINE® T-403), poly(propylene glycol)bis(2-aminopropyl ether) (JEFFAMINE® D-2000), and 3,3,5-trimethylhexamethylene-diamine (JEFFAMINE® D-230).

According to some of any of the embodiments described herein, the polyamine as described herein in any of the respective embodiments is or comprises one or more of tetraethylenepentamine (TEPA), trimethylolpropane tris[poly(propylene glycol), amine terminated] ether (JEFFAMINE® T-403), and 3,3,5-trimethylhexamethylene-diamine (JEFFAMINE® D-230).

In the context of some of the present embodiments, different processes and different fibrous structures having diverse porous architectures (e.g., densely packed nanospheres, coral-like, and segmented morphology) is obtainable when different polyamines are used. Fibrous microstructures having different fibrous structures possess different properties.

In some of any of the embodiments described herein, the inner core is devoid of the polymeric material that forms the outer shell as described herein in any of the respective embodiments.

The phrase “chemically-crosslinked” as used herein refers to a material that forms a three-dimensional network by forming covalent bonds, whereby the covalent bonds are formed between the material (e.g., a polymeric or a non-polymeric polyamine) and a crosslinker as defined herein in any of the respective embodiments.

In some of any of the embodiments described herein, at least 50%, or at least 60%, or at least 70%, or at least 80%, or at least 90%, or at least 95%, or at least 98%, or all, of the crosslinked polyamine as described herein in any of the respective embodiments is a chemically-crosslinked polyamine.

In some embodiments, polyamine in the inner core which is not chemically-crosslinked, is present, can be physically-crosslinked and/or ionically-crosslinked or non-crosslinked.

The phrase “physical crosslinking” as used herein refers to the formation of crosslinks between polymer chains or molecules through non-covalent interactions, such as hydrogen bonding, van der Waals forces, or entanglements. Unlike chemical crosslinking, which involves the formation of covalent bonds, physical crosslinking relies on reversible interactions that can be influenced by external factors (e.g., temperature, pressure, or solvent composition). Non-limiting physical crosslinking mechanisms include physical entanglements of polymer chains or molecules, crystallization, hydrogen bonding between polymer segments, and interactions with filler particles.

The phrase “ionic crosslinking” as used herein refers to the formation of crosslinks between polymer chains through ionic interactions. In an ionic crosslinking process, positively charged ions (cations) from one polymer chain interact with negatively charged ions (anions) from another polymer chain, leading to the formation of electrostatic bonds or complexes. Ionic crosslinking can occur between functional groups such as carboxylate (—COO—) and amine (—NH₃⁺) groups, or between metal ions and coordinating ligands. Ionic crosslinking can be reversible as the ionic bonds can break and reform under certain conditions (e.g., changes in pH or the presence of competing ions).

According to some of any of the embodiments described herein, the chemically-crosslinked polyamine as described herein in any of the respective embodiments is formed in the presence of a crosslinker, and hence features reaction products formed by coupling the crosslinker and the polyamine.

It is to be understood that the interactions of certain crosslinkers (e.g., polyaldehydes such as GA) with amino groups (e.g., of a polyamine) are not fully understood in literature, yet are known to form a broad range of nitrogen-containing species. Non-limiting examples of nitrogen-containing species include amine groups, imine groups, nitrogen-containing heterocyclic groups, and nitrogen-containing heteroalicyclic groups.

In some of any of the embodiments described herein, the crosslinked polyamine as described herein in any of the respective embodiments comprises nitrogen-containing species formed by formed by an interaction between the polyamine as described herein in any of the respective embodiments and the crosslinker as described herein in any of the respective embodiments. The chemical nature of these species depends in the type of the selected crosslinker.

In some of any of the embodiments described herein, the crosslinked polyamine as described herein in any of the respective embodiments comprises a plurality of imine groups.

In some of the embodiments described herein, the inner core is rich in nitrogen atoms, for example, it comprises a concentration of nitrogen atoms of at least 10% or at least 20%, or at least 30%, or at least 40%, or at least 50%, or at least 60%, or at least 70%, of the total atoms in the inner core.

According to some of any of the embodiments described herein, the inner core features a porous structure that comprises a plurality of spheres.

In some of any of the embodiments described herein, the plurality of spheres comprises a plurality of microspheres and/or a plurality of nanospheres.

It should be understood that the terms “spheres”, “microspheres” and “nanospheres” as used herein throughout do not refer exclusively to particles having a symmetric spherical shape. These terms also encompass particles featuring a regular spherical, elliptical, asymmetric, and/or any irregular shape.

According to some of any of the embodiments described herein, the nanospheres as described herein feature an average diameter in a range of from 1 to 900 nm, or from 1 to 800, or 1 to 700, or 1 to 600, or 1 to 500, or 1 to 400, or 1 to 300, or 1 to 200, or from 100 to 900, or from 100 to 800, or from 100 to 700, or from 100 to 600, or from 100 to 500, or from 100 to 400, or from 100 to 300, or from 200 to 900, or from 200 to 800, or from 200 to 700, or from 200 to 600, or from 200 to 500, or from 250 to 650, or from 400 to 500 nm, including any intermediate values and subranges therebetween.

According to some of any of the embodiments described herein, the microspheres as described herein feature an average diameter in a range of from 0.1 to 100 microns, or from 0.5 to 10 microns, or from 0.5 to 5 microns, or from 1 to 3 microns, or from 1 to 2 microns, including any intermediate values and subranges therebetween.

In some of any of the embodiments described herein, up to 50%, or up to 40%, or up to 20%, or about 10%, of the spheres (i.e., of the total amount of spheres) as described herein in any of the respective embodiments are microspheres.

In some of any of the embodiments described herein, the plurality of spheres in the inner core comprises a plurality of microspheres and a plurality of nanospheres. In some of these embodiments, a ratio between the nanospheres and microspheres in the inner core in is a range of from 1:10000 to 10000:1, or from 1:5000 to 5000:1, or from 1:2500 to 2500:1, or from 1:1000 to 1000:1, or from 1:500 to 500:1, or from 1:100 to 100:1, or from 1:100 to 10:1, respectively, including any intermediate values and subranges therebetween.

In some of any of the embodiments described herein, at least 50%, or at least 60%, or at least 80%, or about 90%, of the spheres (i.e., of the total amount of spheres) as described herein in any of the respective embodiments are nanospheres.

According to some of any of the embodiments described herein, the chemically-crosslinked polyamine as described herein in any of the respective embodiments is less water-miscible or less water-soluble than the polyamine as described herein in any of the respective embodiments.

### Additional Polymeric Material:

According to some of any of the embodiments described herein, the inner core as described herein in any of the respective embodiments further comprises additional one or more polymeric 10) materials (i.e., other than the crosslinked polyamine as described herein in any of the respective embodiments).

In some of any of the embodiments described herein, the additional polymeric material is selected such that it provides the core solution a viscosity as described herein in any of the respective embodiments.

In some embodiments, the additional polymeric material is selected as soluble or miscible in the same solvent or mixture of solvents in which the polyamine is dissolvable or miscible.

In some of any of the embodiments described herein, the additional polymeric material is selected such that it provides an additional functional group within the inner sheath and/or within the inner core. Non-limiting examples for additional polymeric materials that can provide additional functional groups include poly vinyl alcohol (PVA) which introduces hydroxy groups, and poly vinyl pyrrolidone which introduces pyrrolidone groups (including nitrogen atoms) to the inner sheath and/or to the inner core of the microstructure. Other polymeric materials, which feature amine groups, are also contemplated, for further enriching the nitrogen content.

In some of any of the embodiments described herein, the additional polymeric material as described herein in any of the respective embodiments is or comprises poly(alkylene glycol) (e.g., PEG). In some of any of the embodiments described herein, the PEG has an average MW of from 100 to 10,000 kDa, or from 1,000 to 5,000 kDa, or is 1,000 kDa, or is 5,000 kDa, including any intermediate values and subranges therebetween. According to some of any of the embodiments described herein, the additional polymeric material comprises at least one polymeric material (e.g., as described herein) which is a very high MW polymeric material, for example, having a MW at least 2,000 or at least 3,000, or at least 4,000 or at least 5,000 kDa, or in a range of from 2,000 to 10,000, or from 3,000 to 10,000, or from 4,000 to 10,000 or from 5,000 to 10,000 kDa; and at least one polymeric material (e.g., as described herein) which has lower MW, for example, of from 100 to 2,000, or from 100 to 1,000, or from 200 to 2,000, or from 200 to 1,500, or from 500 to 2,000, or from 500 to 1,500, or from 800 to 2,000 or from 800 to 1,500, kDa, including any intermediate values and subranges therebetween. In some embodiments, the two or more polymeric materials and the weight ratio therebetween are selected so as to provide a desired viscosity to the solution comprising same.

In some embodiments, a weight ratio of the High MW and the lower MW polymers ranges from 1:10 to 10:1, or from 5:1 to 1:5, or from 3:1 to 1:3, or from 1:2 to 2:1, or is about 1:1.

In some embodiments, the high MA and the lower MW polymeric materials are the same and in some embodiments different.

In exemplary embodiments, both the high MW and the lower MW polymeric materials are each a poly(alkylene glycol) (e.g., PEG).

In some of any of the embodiments described herein, the weight ratio of the one or more additional polymeric materials and the chemically-crosslinked polyamine in the inner core ranges from 1:1 to 1:50, or from 1:1 to 1:20, or from 1:1 to 1:10 or from 1:1 to 1:5, including any intermediate values and subranges therebetween.

According to some of any of the embodiments described herein, the additional polymeric material(s) as described herein, or a portion thereof, form an inner sheath, as described herein in any of the respective embodiments. In some embodiments, the inner sheath at least partially envelopes the plurality of spheres as described herein in any of the respective embodiments.

In some of any of the embodiments described herein, the inner sheath further comprises a polyamine (e.g., a polyamine as described herein in any of the respective embodiments). In some such embodiments, an amount of the crosslinked-polyamine in the inner sheath is up to 99.9, or up to 99, or up to 95, or up to 90, or up to 80, or up to 70, or up to 60, or up to 50, or up to 40, or up to 30, or up to 20, or up to 10, or up to 5, or up to 1, % by volume, including any intermediate values and subranges therebetween.

In some of any of the embodiments described herein, the inner sheath (e.g., an inner sheath as described herein in any of the respective embodiments) is obtained or obtainable consecutively, simultaneously, or in parallel to a formation of the outer polymeric shell.

In the context of the present invention, an analysis of the microstructure as described herein in any of the respective embodiments (i.e., its morphology and characteristics are studied) is affected using, e.g., EDS elemental analysis, CLSM imaging, SEM.

### Compositions:

According to an aspect of some embodiments of the present invention there is provided a composition comprising a plurality of microstructures, each microstructure is as described herein in any of the respective embodiments and any combination thereof.

By “plurality” it is meant at least 2 and up to 1010 or even more.

The microstructures in the composition can be the same or different from one another. When different, microstructures can be differ by one or more of the type of polymeric material forming the outer shell, the type of polyamine that forms the inner core, the type and/or concentration of the crosslinker used to form the crosslinked polyamine, and the shape and/or dimension (e.g., average diameter, length, aspect ratio) of the microstructure.

According to some of any of the embodiments described herein, at least a portion of the microstructures in the composition are physically associated with one another, for example, entangled or woven with one another, or otherwise form physical clusters.

### Compositions-of-Matter, Articles-of-Manufacturing and Applications:

According to an aspect of some embodiments of the present invention there is provided an article-of-manufacturing comprising a (e.g., fibrous) microstructure or a composition comprising a plurality of microstructures, as described herein in any of the respective embodiments and in any combinations thereof.

Such articles-of-manufacturing can be such that exploit the ability of the microstructures to absorb various substances, and hence can be used, for example, for separating such substances from mixtures containing same.

Alternatively or in addition, the articles-of-manufacturing can be used, for example, for absorbing and/or separating or filtering a solid and/or a fluid (e.g., gas) substance from an environment.

Exemplary solid substances include, without limitation, metals (e.g., precious metals, heavy metals, and otherwise hazardous metals) which typically have affinity to nitrogen atoms, organic pollutants (e.g., pigments, herbicides, pesticides, pharmaceuticals), synthetic chemicals (e.g., plasticizers, personal care products, flame retardants), biological substances (e.g., proteins), and pathogens (e.g., bacteria), and particularly such substances that feature chemical moieties or groups that may interact with nitrogen atoms via, e.g., electrostatic interactions or hydrogen bonding, for example, acidic groups.

Exemplary fluid substances include, without limitations, organic solvents and/or reagents, particularly such that feature chemical moieties or groups that may interact with nitrogen atoms via, e.g., electrostatic interactions or hydrogen bonding, and gases (e.g., carbon dioxide, nitrogen oxides), particularly such that are acidic in nature.

Environments or mixtures from which substances as described herein can be beneficially separated or filters include, as non-limiting examples, waste water, sewage, chemical waste, biological waste, industrial waste, pharmaceutical waste, agricultural waste, irrigation systems, water reservoirs (e.g., public swimming pools, lakes, irrigation sources), water conduits, air vents or air-supply systems, for example, in submarines, spacecraft, airtight chambers, emergency shelters, and any environment with poor or no ventilation, and any other environment that may be enriched with gases other than oxygen and nitrogen.

Exemplary articles-of-manufacturing include, but are not limited to, filters, filtration devices or systems, purifying devices or systems, such as water purification devices or systems, gas-capturing devices or systems, and separating devices or systems, and any higher system in which such articles, devices and systems can be integrated.

The term “filter” as used herein may refer to a sheet or membrane of any thickness produced from a microstructure as described herein in any of the respective embodiments and which optionally has pores of a predetermined size range to entrap particles of a desired size from a gaseous or liquid medium. It is contemplated that the filters according to the present invention may be flexible membranes, rigid or semi-rigid sheets or fashioned into a block or any other form that provides a desired filtration of a fluid applied to at least one surface of the membrane or sheet and which passes through the filter thereby leaving substance(s) to be separated on the surface contacted by the fluid and/or on or in the microstructures.

A filter as contemplated by the present invention may also be a fibrous net or mesh such as an air conditioner or automobile air filter or a filter bed such as used for the purification of water, wherein the filter bed may comprise a bed or layer of fibrous microstructures as described herein in any of the respective embodiments.

Any of the compositions-of-matter and articles-of-manufacturing described herein can be used in respective methods of, for example, in filtering, purification, separation, and/or absorption, of a fluid or solid substance as described herein.

The phrase “filtration device” as used herein refers to a device or unit which can filter and/or adsorb impurities or undesired substances, and which can be integrated within a system or a higher device so as to facilitate its operation.

The phrase “purifying device” as used herein refers to a device which is suitable for use in the purifying of a polluted substrate or environment.

The phrase “gas-capturing device” as used herein refers to a device designed for purifying environments polluted by gases or is for the removal of undesired gases. Non-limiting examples include air purification systems, air conditioning systems, ventilation systems, gas scrubbing systems, protective devices, and exhaust fume extractors.

In some of any of the embodiments described herein, the article-of-manufacturing is a carbon dioxide filter (e.g., carbon dioxide scrubber (i.e., a carbon dioxide absorber), a carbon dioxide-removal unit).

Non-limiting examples of settings where carbon dioxide filters are applicable include submarines, spacecraft, airtight chambers, emergency shelters, and any environment with poor or no ventilation; for maintaining minimal carbon dioxide concentration for health-related reasons such as capnography; for agricultural uses, such as capturing carbon dioxide (e.g., to improve crop yield) in greenhouses; and in controlling the concentration of carbon dioxide, e.g., in industrial fermentation facilities, in academic, research, and/or industrial chemical facilities (e.g., within a chemical hood or for the removal of carbon dioxide from inert gases or clean dry air).

The phrase “separating device” as used herein refers to a tool or apparatus designed to segregate components or substances from a mixture. It encompasses devices that employ various methods, such as filtration, sedimentation, centrifugation, or distillation, to achieve separation. Non-limiting examples of separating devices include filters, centrifuges, chromatography columns, and distillation setups. A separating device may facilitate the separation of components by exploiting differences in at least one property selected from size, density, and affinity towards amine groups of elements to-be-separated from the mixture. A separating device may combine one or more separating methods as described herein, such as a device which enables both filtration and distillation, in succession to one another.

In some of any of the embodiments described herein, the filter or separating device as described herein in any of the respective embodiments is a water filter and/or water purifying system.

Non-limiting examples of settings where water filters and/or purifying systems are applicable include cleaning and additional water treatment in (e.g., in a water conduit of) household appliances, irrigation systems, zoos and aquariums, agricultural operations (e.g., farms), cruise ships, boats, recreational vehicles (RVs), military bases, hospitality industrial facilities (e.g., hotels), educational institutions, disaster relief operations, medical facilities, and/or any facility which produces (e.g., medical, biological and/or chemical) waste in an industrial-scale.

In some of any of the embodiments described herein, the separating device as described herein in any of the respective embodiments is a metal separating device. Metals separating device are usable in separating metals from reaction mixtures containing same, for the purpose of recycling or purification, and/or for purifying the metals from mixtures, solutions and/or liquids, to thereby obtain purified (e.g., elemental) metals. In some of any of the embodiments described herein, the separating device is usable in separating a metal and impurities from a liquid comprising same, as in, e.g., waste treatment, for example, industrial waste.

In some of any of the embodiments described herein, the separating device as described herein in any of the respective embodiments is a precious metals separating device. In some of any of the embodiments described herein, the separating device is usable in separating a precious metal and impurities (e.g., non-precious metal) from a solution or mixture comprising same. Such a separating device may allow recycling of (e.g., precious) metals due to economic and/or environmental considerations, and/or purifying the solution or mixture comprising same.

The phrase “precious metals separating device” as used herein refers to a device designed for the isolation or separation of precious metals from a solution, a mixture or an ore comprising same. Such a separating device can also be usable for non-precious metals.

According to an aspect of some embodiments of the present invention, there is provided a composition-of-matter that comprises a microstructure as described herein or a composition comprising a plurality of microstructures as described herein, having absorbed thereto a substance.

In some embodiments, the substance is such that has an affinity towards amine groups (e.g., affinity to the crosslinked polyamine).

Herein, the phrase “has an affinity towards amine groups” refers to a substance that can physically or chemically interact with the spheres that form the inner core of the microstructures. The substance can have a chemical affinity to the polyamine and/or to the crosslinked polyamine, such that it can interact therewith via hydrogen bonding, electrostatic interactions, and/or coordination bonding. The substance can alternatively or in addition, be absorbed physically to the spheres in the inner core by, for example, being entrapped within the porous structure without substantial leaching therefrom and through the outer shell.

Without being bound by any particular theory, it is assumed that the nitrogen-rich environment of the inner core (e.g., of the crosslinked polyamine) facilitates (e.g., selective) physisorption and/or chemisorption of, e.g., enzymes, peptides, proteins, dyes and pigments, detergents, human and/or animal waste, pharmaceuticals, pollutants, gases, catalysts, and metals (e.g., heavy metals, precious metals, and transition metals), particularly those that feature functionalities that can interact via hydrogen bonding or electrostatic interactions or coordinative bonding with nitrogen or moieties comprising same (e.g., amines, imines, etc.).

According to some of any of the embodiments described herein, the substance that has an affinity towards amine groups is chemically inert to the nitrogen-containing groups (e.g., imines, amines), such that it does not chemically interact therewith by, for example, forming covalent bonds and/or decomposing the respective bond, and/or it maintains its activity in the presence of the crosslinked polyamine.

The interactions between the substance and the microstructure preferably occur mainly within the inner core and can involve various types of molecular interactions, such as hydrogen bonding, electrostatic interactions, and/or hydrophobic interactions with or within the plurality of spheres that forms the inner core. In some embodiments, an absorbed substance maintains its functions and/or properties (i.e., in comparison with functions and properties of a (non-absorbed) active substance).

According to an aspect of some embodiments of the present invention there is provided a method for preparing a microstructure having an active substance absorbed thereto or a composition-of-matter comprising same, which is effected by contacting a composition as described herein in any of the respective embodiments and in any combinations thereof with the active substance as described herein in any of the respective embodiments or a solution or mixture comprising same. In some embodiments, the method is effected under conditions that maintain the activity of the active substance.

According to some of any of the embodiments described herein, the composition-of-matter comprises a substance which is an active substance, comprised within the microstructure. The active substance can be, for example, a biologically active substance or a chemically active substance.

In some of any of the embodiments described herein, the active substance as described herein in any of the respective embodiments is a biologically active substance.

As used herein, “a biologically active substance” refers to a chemical compound or molecule that exerts a specific effect on biological systems, such as living organisms, cells, tissues, or biochemical processes. These substances interact with biological targets (e.g., receptors, enzymes, signaling molecules), leading to responses or changes in cellular function. Non-limiting examples of biologically active substances include hormones, neurotransmitters, enzymes, vitamins, receptors, antigens, antibodies, and the like.

The composition-of-matter comprising the biologically active substance can be used, for example, for separating biological moieties from a mixture, for example, by interacting selectively with such moieties. For example, the biologically active substance can be a part of an affinity pair, and is usable for separating the other part from a mixture containing same.

Examples of affinity pairs include, without limitation, an enzyme-substrate pair, a polypeptide-polypeptide pair (e.g., a hormone and receptor, a ligand and receptor, an antibody and an antigen, two chains of a multimeric protein), a polypeptide-small molecule pair (e.g., avidin or streptavidin with biotin, enzyme-substrate), a polynucleotide and its cognate polynucleotide such as two polynucleotides forming a double strand (e.g., DNA-DNA, DNA-RNA, RNA-DNA), a polypeptide-polynucleotide pair (e.g., a complex formed of a polypeptide and a DNA or RNA e.g., aptamer), a polypeptide-metal pair (e.g., a protein chelator and a metal ion), a polypeptide and a carbohydrate (leptin-carbohydrate), and the like.

In some of any of the embodiments described herein, the composition-of-matter comprising a biologically active substance which is a part of an affinity pair as described herein, is useful for separating biological entities (e.g., the part of the affinity pair which the composition-of-matter does not comprise) from a mixture comprising same, for example, a biological sample.

In some of any of the embodiments described herein, the composition-of-matter comprising a biologically active substance which is a part of an affinity pair as described herein, is useful for detecting a presence of a biological entity (e.g., the part of the affinity pair which the composition-of-matter does not comprise) in a sample (e.g., a biological sample).

In some of any of the embodiments described herein, the biologically active substance is such that promotes or facilitates biological reactions. Such active substances can be, for example, enzymes and co-factors.

In some embodiments, the biologically active substance is an enzyme. In some of these embodiments, the composition-of-matter can be used to perform non-homogeneous enzymatic catalyses, while protecting the enzyme from environmental conditions that may adversely affect its activity and/or while recycling the enzyme.

In some of any of the embodiments described herein, the composition-of-matter can be used to prevent the release and/or a production of an environmentally harmful (e.g., toxic) by-product.

Exemplary enzymes include, but are not limited to, catalase, oxidoreductases, transferases, hydrolases, lyases, isomerases, ligases, and translocases. In some of any of the embodiments described herein, the enzyme as described herein in any of the respective embodiments is a sensitive (e.g., oxygen-sensitive) enzyme (e.g., the three-dimensional conformation and/or catalytic activity and/or kinetics are impaired in non-physiological conditions).

Herein, the phrase “oxygen-sensitive” refers to a substance which interacts with oxygen (e.g., binds to oxygen) in a manner which alters the properties (e.g., activity) of the substance, and/or decomposes in the presence of oxygen) at room temperature (e.g., 25° C.).

Oxygen-sensitive enzymes may comprise a transition metal such as iron, for example, in the form of one or more iron-sulfur cluster and/or di-iron (e.g., di-iron azadithiolate) center. In some embodiments, oxygen sensitivity is associated with reaction of oxygen with such a metal, e.g., interfering with reduction and/or oxidation of the metal.

Examples of oxygen-sensitive enzymes include, without limitation, hydrogenases, nitroreductases, and nitrogenases and other enzymes that participate in redox reactions. In some of any of the embodiments described herein, the enzyme comprises an [FeFe]-hydrogenase, for example, a Chlamydomonas reinhardtii [FeFe]-hydrogenase.

Examples of commercially important reactions catalyzed by oxygen-sensitive enzymes-which may be protected using some embodiments of the invention-include, without limitation, the formation of H₂ (a potentially important fuel) by hydrogenases under reducing conditions, and nitrogen fixation by nitrogenases (e.g., formation of ammonia from N₂).

In some of any of the embodiments described herein, the composition-of-matter as described herein in any of the respective embodiments (e.g., the composition-of-matter comprising the biologically active substance) can be considered as an enzyme-immobilization matrix. Non-limiting examples for the use of an immobilized enzyme include continuous purifications of compounds in chemical synthesis (e.g., in chemical research, in pharmaceutical manufacturing), in the food and dairy industries (e.g., the production of lactose-free milk), in bioremediation (e.g., for the treatment of pollutants), and the like.

In some of any of the embodiments described herein, the enzyme as described herein in any of the respective embodiments is catalase. Catalase catalyzes the disproportionation reaction of hydrogen peroxide (H₂O₂) to water and oxygen. In some of any of the embodiments described herein, the active substance as described herein in any of the respective embodiments is a chemically active substance.

As used herein, the phrase “chemically active substance” refers to a compound or molecule that exhibits reactivity or the ability to undergo a chemical reaction (e.g., synthesis, decomposition, oxidation-reduction, acid-base reactions, and complexation) with other substances. A chemically active substance may contain functional groups or reactive sites that enable them to interact with other molecules and undergo chemical transformations. Non-limiting examples of chemically active substances include catalysts, reagents, and initiators. In some of any of the embodiments described herein, the chemically active substance as described herein in any of the respective embodiments is a catalyst. Compositions-of-matter comprising a catalyst can be beneficially used, for example, for performing catalysis while protecting the catalysts from environmental conditions such as air or oxygen and/or for recycling the catalyst and/or for performing heterogeneous catalyses.

In some of any of the embodiments described herein, the catalyst is a sensitive catalyst (e.g., the catalytic activity and/or kinetics are impaired in certain conditions (e.g., STP)). Non-limiting examples for sensitive catalysts include platinum-based automotive catalysts, Fischer-Tropsch catalysts, palladium catalysts. The microstructures as described herein in any of the respective embodiments and in any combination thereof are beneficial, inter alia, for the absorption of sensitive catalysts or sensitive enzymes, both because it stabilizes the sensitive catalyst and allows its activity in various environments, and due to the possibility to obtain a decreased metal contamination in the resulting, e.g., products or waste streams.

In some of any of the embodiments described herein, the catalyst is an oxygen-sensitive catalyst. Non-limiting examples for oxygen-sensitive catalysts include Grubbs catalysts, Lindlar's catalyst, and Pd/C.

In some of any of the embodiments described herein, the chemically active substance as described herein in any of the respective embodiments is a metallic or an organometallic catalyst.

Organometallic catalysts typically consist of organic ligands coordinated to a central metal atom or metal ion. Compositions-of-matter comprising an organometallic catalyst can be beneficially used, for example, for performing catalyses while protecting the catalysts from environmental conditions such as air or oxygen and/or for recycling the catalyst. Organometallic catalysts include, but are not limited to, [IrClCp*(2,2′-bi-2-imidazoline)]Cl, Ruthenium Diimine Organometallic Complexes, and mononuclear rhodium (I) amine complexes.

In some of any of the embodiments described herein, the chemically active substance as described herein in any of the respective embodiments (e.g., the catalyst) is a heterogeneous catalyst.

Herein and in the art, the phrase “heterogeneous catalysts” encompasses catalysts that exist in a different physical phase than the reactant in a chemical reaction, and are particularly useful in continuous industrial processes due to, e.g., their ease of separation from a reaction's crude mixture, as they allow a continuous operation without the need for extensive purification steps. Non-limiting examples for such heterogeneous catalysts and processes include the Haber-Bosch process using an iron catalyst, methanol synthesis using copper-zinc oxide catalyst.

According to some of any of the embodiments described herein, the composition-of-matter comprises a metal species adsorbed and/or absorbed thereto (e.g., is absorbed, adsorbed and/or adhered to the inner core of the microstructure). According to some of any of the embodiments described herein, the metal species is adsorbed in the inner core (i.e., within the inner core, e.g., on the spheres, as described herein in any of the respective embodiments).

Non-limiting examples of metal species include metal ions and metal salts, metal oxides, elemental metal particles (particles composed solely of one type of metal atom in its elemental form), and metal alloys (combinations of different metal species present together), and any combination thereof. Each metal species may exhibit distinct properties, reactivity, and behaviors, as known in the art.

Herein, when a microstructure as described herein in any of the respective embodiments is having a metal particle adsorbed or absorbed thereto (e.g., to its inner core), the microstructure as a whole is being referred to herein as “a metal-decorated microstructure”.

Exemplary metals include, but are not limited to, ruthenium, iridium, palladium, platinum, gold, silver, rhodium, osmium, rhenium, copper, nickel, cobalt, titanium, zinc, cadmium, mercury, iron, chromium, manganese, vanadium, scandium, yttrium, tungsten, molybdenum, aluminum, magnesium, lithium, sodium, potassium, cesium, and francium, although any other precious metals, rare earth metals, transition metals, alkali metals, alkaline earth metals, and like species are contemplated.

In some of any of the embodiments described herein, an amount of a metal species in the composition-of-matter is at least 0.1%, or at least 1%, or at least 5%, or about 10%, or more, and up to 50%, or up to 30%, or up to 20%, by weight of the total weight of the composition-of-matter, including any intermediate values and subranges therebetween.

In some of any of the embodiments described herein, a density of a metal species in the composition-of-matter (i.e., an amount of a metal species adsorbed per volume of the composition-of-matter) is in a range of from 1 to 100, or from 2 to 90, or from 5 to 80, or from 7 to 70, or from 8 to 60, or from 10 to 50, mg/mL, including any intermediate values and subranges therebetween.

In some of any of the embodiments described herein, the metal-decorated microstructure is for use as a catalyst. In some of these embodiments, the metal is a sensitive metal (e.g., an oxygen-sensitive metal, i.e., readily oxidizes upon a contact with oxygen). In some of these embodiments, the metal is an environmentally harmful (e.g., toxic) metal. In some of these embodiments, the metal is a precious metal or a rare earth metal.

In some of any of the embodiments described herein, a diameter of a metal particle in a composition-of-matter as described herein is in a range of from 5 to 100000, or from 5 to 10000, or from 5 to 5000, or from 5 to 1000, or from 5 to 500, or from 5 to 250, or from 5 to 100, or from 5 to 50, or from 5 to 30, or from 5 to 20, or from 10 to 100000, or from 10 to 10000, or from 10 to 5000, or from 10 to 1000, or from 10 to 500, or from 10 to 250, or from 10 to 100, or from 10 to 50, or from 10 to 30, or from 10 to 20, or from 20 to 100000, or from 20 to 10000, or from 20 to 5000, or from 20 to 1000, or from 20 to 500, or from 20 to 250, or from 20 to 100, or from 20 to 50, or from 30 to 100000, or from 30 to 10000, or from 30 to 5000, or from 30 to 1000, or from 30 to 500, or from 30 to 250, or from 30 to 100, or from 30 to 60, or from 50 to 100000, or from 50 to 10000, or from 50 to 5000, or from 50 to 1000, or from 50 to 500, or from 50 to 250, or from 50 to 100, nm.

In exemplary embodiments, a composition-of-matter that comprises a metal salt can be used for converting the metal salt to a metal particle or any other form or elemental metal within the microstructures, to thereby obtain a metal-decorated microstructure.

According to some of any of the embodiments described herein, metal-decorated microstructures can be prepared by contacting a microstructure as described herein with a metal salt or metal oxide (e.g., with a solution comprising same that can penetrate into and interact with the inner core), to thereby absorb the metal salt or oxide to the inner core, and then contacting the microstructure with a reducing solution, to thereby convert the metal salt or oxide to metallic particles, or islands, or clusters, for example, to thereby provide a (e.g., layered) deposition of a metal on a surface of the spheres as described herein in any of the respective embodiments. According to some of these embodiments, a method of preparing a microstructure having a substance absorbed thereto or a composition-of-matter comprising same, further comprises, subsequent to contacting the microstructure(s) with a solution that comprises the substance, herein a metal salt or oxide, contacting the obtained microstructure with a solution that comprises a reducing agent.

According to an aspect of some embodiments of the present invention there is provided a method for preparing a microstructure having a metal species adsorbed thereto, or a composition-of-matter comprising same, which is effected by contacting a microstructure as described herein in any of the respective embodiments and in any combinations thereof, or a composition comprising same, with a metal species as described herein in any of the respective embodiments or with a mixture comprising same.

In some of any of the embodiments described herein, the method is for obtaining a metal-decorated particle. In some of any of the embodiments described herein, the method comprises contacting (e.g., absorbing) the ionic metal, followed by a reduction of the ionic metal, to provide the metal-decorated particle. In some such embodiments, the metal is a sensitive metal (i.e., chemically and/or physically unstable at certain conditions, e.g., STP. A non-limiting example for a sensitive metal includes palladium and platinum.

Metal-decorated particles as described herein in any of the respective embodiments are usable, e.g., as catalysts as described herein in any of the respective embodiments.

In some of any of the embodiments described herein, a process or method as described herein in any of the respective embodiments further comprises contacting a composition, a composition-of-matter or an article-of-manufacturing as described herein with a degrading agent that is capable of degrading the microstructure or a portion thereof.

In some of any of the embodiments described herein, a process or method as described herein in any of the respective embodiments further comprises contacting a degrading agent with the microstructures to thereby provide a degraded outer shell. In some of any of the embodiments described herein, a process or method as described herein in any of the respective embodiments further comprises contacting an organic solvent (i.e., in which the polymeric material is dissolvable) with the microstructures to thereby provide a degraded outer shell. The outer shell can be fully-degraded, leaving only the inner core and optionally the inner sheath (if present), or partially degraded, such that only some portions of the inner core remain exposed and not-enveloped by the outer shell.

In some of any of the embodiments described herein, a process as described herein in any of the respective embodiments further comprises contacting a hydrolyzing agent with the microstructures to thereby provide a degraded inner core.

In some of any of the embodiments described herein, a process as described herein in any of the respective embodiments further comprises contacting a hydrolyzing agent with the microstructures to thereby provide degraded spheres.

Herein, a “hydrolyzing agent” refers to a substance or several substances that can degrade the crosslinked polyamine by hydrolyzing and/or reducing the (e.g., imine) crosslinking moieties. Non-limiting example for such agents includes a combination of an acidic buffer and imine reductase (e.g., as described in the Examples section that follows), however, any suitable hydrolyzing agents and conditions are considered. Hydrolyzing as described herein in any of the respective embodiments is beneficial, for example, for obtaining at least partially degraded microstructure (e.g., to obtain a sphere or a plurality of spheres as described herein in any of the respective embodiments) and/or fully degraded microstructure (e.g., to obtain a metal species or an active substance as described herein in any of the respective embodiments).

When a microstructure having a substance associated therewith is fully degraded, for example, be dissolving and/or decomposing the outer shell and the inner core, the substance is recovered. This can be used, for example, in cases where the microstructure, or the composition-of-matter or the article-of-manufacturing are used for separating substances as described herein, to thereby recover the separated substance (e.g., precious metals). This can further be used for recovering active substances subsequent to using same.

### Chemically-Crosslinked Polyamine Particles:

According to an aspect of some embodiments of the present invention there is provided a composition-of-matter comprising a plurality of particles, wherein at least a portion of said particles comprises a chemically crosslinked polyamine, as described herein in any of the respective embodiments and any combination thereof.

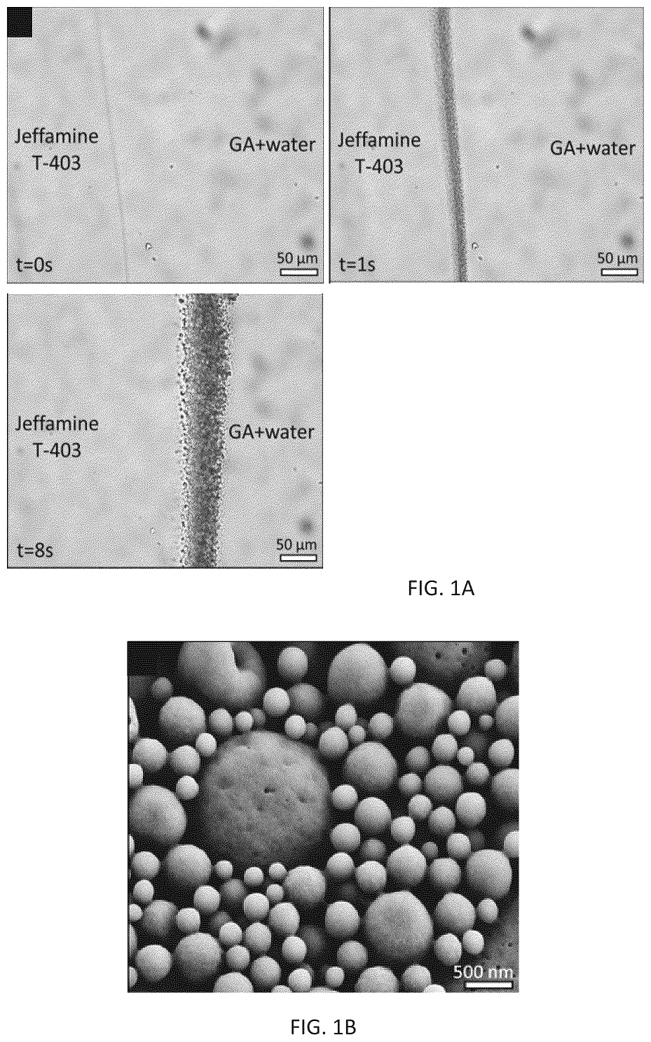

In some of any of the embodiments described herein, the plurality of particles consists of or comprise a plurality of spheres (e.g., the spheres as described herein in any of the respective embodiments and in any combination thereof). In some embodiments, the particles are as depicted in FIG. 1B.

In some of any of the embodiments described herein, the composition-of-matter as described herein is obtainable by contacting a solution of the crosslinker (e.g., the crosslinker as described herein in any of the respective embodiments and in any combination thereof) with a solution of the polyamine from which the chemically-crosslinked polyamine is formed (e.g., the polyamine and chemically-crosslinked polyamine as described herein in any of the respective embodiments and in any combination thereof), wherein the chemically-crosslinked polyamine being immiscible or insoluble in the solutions, such that particles (e.g., spheres) are formed at the interface (e.g., as described herein).

In some of any of the embodiments described herein, the solutions as described herein in any of the respective embodiments are miscible in one another (e.g., facilitate a formation of a direct contact between the polyamine and the crosslinker as described herein in any of the respective embodiments).

In some of any of the embodiments described herein, the solutions as described herein in any of the respective embodiments form an interface as described herein in any of the respective embodiments, wherein the interface promotes a formation of spheres as described herein in any of the respective embodiments.

In some of any of the embodiments described herein, the particles (e.g., spheres) have a substance associated therewith, as described herein in any of the respective embodiments for a substance associated with or absorbed to the inner core as described herein.

Such particles can be used in any of the relevant applications as described herein.

In some of any of the embodiments described herein, a plurality of particles (e.g., spheres) are in a form of a dispersion in solution. In some of any of the embodiments described herein, the particles are usable in water treatment or catalysis as described herein in any of the respective embodiments

In some of any of the embodiments described herein, a plurality of particles (e.g., spheres) are in a form of a powder. In some of any of the embodiments described herein, the particles are usable in gas-phase applications.

In some of any of the embodiments described herein, the particles are usable in surface coating. In some of any of the embodiments described herein, the particles are usable in electrochemical catalysis (in, e.g., energy conversion and storage, electrochemical sensors and biosensors, environmental remediation, chemical synthesis and manufacturing). in some of any of the embodiments described herein, the particles are usable in sensing applications (in, e.g., environmental monitoring, industrial monitoring and control, healthcare and medical diagnostics, automotive and transportation, agriculture and precision farming, energy management and conservation).

According to an aspect of some embodiments of the present invention there is provided an article-of-manufacturing comprising the composition-of-matter as described herein.

As used herein, the term “about” refers to +10% or +5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

Herein throughout, the phrase “linking moiety” or “linking group” describes a group that connects two or more moieties or groups in a compound. A linking moiety is typically derived from a bi- or tri-functional compound, and can be regarded as a bi- or tri-radical moiety, which is connected to two or three other moieties, via two or three atoms thereof, respectively.

Exemplary linking moieties include a hydrocarbon moiety or chain, optionally interrupted by one or more heteroatoms, as defined herein, and/or any of the chemical groups listed below, when defined as linking groups.

When a chemical group is referred to herein as “end group” it is to be interpreted as a substituent, which is connected to another group via one atom thereof.

Herein throughout, the term “hydrocarbon” collectively describes a chemical group composed mainly of carbon and hydrogen atoms. A hydrocarbon can be comprised of alkyl, alkene, alkyne, aryl, and/or cycloalkyl, each can be substituted or unsubstituted, and can be interrupted by one or more heteroatoms. The number of carbon atoms can range from 2 to 20, and is preferably lower, e.g., from 1 to 10, or from 1 to 6, or from 1 to 4. A hydrocarbon can be a linking group or an end group.

As used herein, the term “amine” describes both a —NR′R″ group and a —NR′— group, wherein R′ and R″ are each independently hydrogen, alkyl, cycloalkyl, aryl, as these terms are defined hereinbelow.

The amine group can therefore be a primary amine, where both R′ and R″ are hydrogen, a secondary amine, where R′ is hydrogen and R″ is alkyl, cycloalkyl or aryl, or a tertiary amine, where each of R′ and R″ is independently alkyl, cycloalkyl or aryl.

Alternatively, R′ and R″ can each independently be hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, carbonyl, C-carboxylate, O-carboxylate, N-thiocarbamate, O-thiocarbamate, urea, thiourea, N-carbamate, O-carbamate, C-amide, N-amide, guanyl, guanidine and hydrazine.

The term “amine” is used herein to describe a —NR′R″ group in cases where the amine is an end group, as defined hereinunder, and is used herein to describe a —NR′— group in cases where the amine is a linking group or is or part of a linking moiety.

The term “alkyl” describes a saturated aliphatic hydrocarbon including straight chain and branched chain groups. Preferably, the alkyl group has 1 to 30, or 1 to 20 carbon atoms. Whenever a numerical range; e.g., “1-20”, is stated herein, it implies that the group, in this case the alkyl group, may contain 1 carbon atom, 2 carbon atoms, 3 carbon atoms, etc., up to and including 20 carbon atoms. The alkyl group may be substituted or unsubstituted. Substituted alkyl may have one or more substituents, whereby each substituent group can independently be, for example, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, C-carboxylate, O-carboxylate, N-thiocarbamate, O-thiocarbamate, urea, thiourea, N-carbamate, O-carbamate, C-amide, N-amide, guanyl, guanidine and hydrazine.

The alkyl group can be an end group, as this phrase is defined hereinabove, wherein it is attached to a single adjacent atom, or a linking group, as this phrase is defined hereinabove, which connects two or more moieties via at least two carbons in its chain. When the alkyl is a linking group, it is also referred to herein as “alkylene” or “alkylene chain”.

Herein, a C(1-4) alkyl, substituted by a hydrophilic group, as defined herein, is included under the phrase “hydrophilic group” herein.

Alkene and alkyne, as used herein, are an alkyl, as defined herein, which contains one or more double bond or triple bond, respectively.

The term “cycloalkyl” describes an all-carbon monocyclic ring or fused rings (i.e., rings which share an adjacent pair of carbon atoms) group where one or more of the rings does not have a completely conjugated pi-electron system. Examples include, without limitation, cyclohexane, adamantine, norbornyl, isobornyl, and the like. The cycloalkyl group may be substituted or unsubstituted. Substituted cycloalkyl may have one or more substituents, whereby each substituent group can independently be, for example, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, C-carboxylate, O-carboxylate, N-thiocarbamate, O-thiocarbamate, urea, thiourea, N-carbamate, O-carbamate, C-amide, N-amide, guanyl, guanidine and hydrazine. The cycloalkyl group can be an end group, as this phrase is defined hereinabove, wherein it is attached to a single adjacent atom, or a linking group, as this phrase is defined hereinabove, connecting two or more moieties at two or more positions thereof.

Cycloalkyls of 1-6 carbon atoms, substituted by two or more hydrophilic groups, as defined herein, is included under the phrase “hydrophilic group” herein.

The term “heteroalicyclic” describes a monocyclic or fused ring group having in the ring(s) one or more atoms such as nitrogen, oxygen and sulfur. The rings may also have one or more double bonds. However, the rings do not have a completely conjugated pi-electron system. Representative examples are piperidine, piperazine, tetrahydrofuran, tetrahydropyran, morpholine, oxalidine, and the like.

The heteroalicyclic may be substituted or unsubstituted. Substituted heteroalicyclic may have one or more substituents, whereby each substituent group can independently be, for example, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, C-carboxylate, O-carboxylate, N-thiocarbamate, O-thiocarbamate, urea, thiourea, O-carbamate, N-carbamate, C-amide, N-amide, guanyl, guanidine and hydrazine. The heteroalicyclic group can be an end group, as this phrase is defined hereinabove, where it is attached to a single adjacent atom, or a linking group, as this phrase is defined hereinabove, connecting two or more moieties at two or more positions thereof.

A heteroalicyclic group which includes one or more of electron-donating atoms such as nitrogen and oxygen, and in which a numeral ratio of carbon atoms to heteroatoms is 5:1 or lower, is included under the phrase “hydrophilic group” herein.

The term “aryl” describes an all-carbon monocyclic or fused-ring polycyclic (i.e., rings which share adjacent pairs of carbon atoms) groups having a completely conjugated pi-electron system. The aryl group may be substituted or unsubstituted. Substituted aryl may have one or more substituents, whereby each substituent group can independently be, for example, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, C-carboxylate, O-carboxylate, N-thiocarbamate, O-thiocarbamate, urea, thiourea, N-carbamate, O-carbamate, C-amide, N-amide, guanyl, guanidine and hydrazine. The aryl group can be an end group, as this term is defined hereinabove, wherein it is attached to a single adjacent atom, or a linking group, as this term is defined hereinabove, connecting two or more moieties at two or more positions thereof.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furan, thiophene, imidazole, oxazole, thiazole, pyrazole, pyridine, pyrimidine, quinoline, isoquinoline and purine. The heteroaryl group may be substituted or unsubstituted. Substituted heteroaryl may have one or more substituents, whereby each substituent group can independently be, for example, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, C-carboxylate, O-carboxylate, N-thiocarbamate, O-thiocarbamate, urea, thiourea, O-carbamate, N-carbamate, C-amide, N-amide, guanyl, guanidine and hydrazine. The heteroaryl group can be an end group, as this phrase is defined hereinabove, where it is attached to a single adjacent atom, or a linking group, as this phrase is defined hereinabove, connecting two or more moieties at two or more positions thereof. Representative examples are pyridine, pyrrole, oxazole, indole, purine and the like.

The term “halide” and “halo” describes fluorine, chlorine, bromine or iodine.

The term “haloalkyl” describes an alkyl group as defined above, further substituted by one or more halide.

The term “sulfate” describes a —O—S(═O)₂—OR′ end group, as this term is defined hereinabove, or an —O—S(═O)₂—O— linking group, as these phrases are defined hereinabove, where R′ is as defined hereinabove.

The term “thiosulfate” describes a —O—S(═S) (═O)—OR′ end group or a —O—S(═S) (═O)—O— linking group, as these phrases are defined hereinabove, where R′ is as defined hereinabove.

The term “sulfite” describes an —O—S(═O)—O—R′ end group or a —O—S(═O)—O— group linking group, as these phrases are defined hereinabove, where R′ is as defined hereinabove.

The term “thiosulfite” describes a —O—S(═S)—O—R′ end group or an —O—S(═S)—O— group linking group, as these phrases are defined hereinabove, where R′ is as defined hereinabove.

The term “sulfinate” describes a —S(═O)—OR′ end group or an —S(═O)—O— group linking group, as these phrases are defined hereinabove, where R′ is as defined hereinabove.

The term “sulfoxide” or “sulfinyl” describes a —S(═O)R′ end group or an —S(═O)— linking group, as these phrases are defined hereinabove, where R′ is as defined hereinabove.

The term “sulfonate” describes a —S(═O)₂—R′ end group or an —S(═O)₂— linking group, as these phrases are defined hereinabove, where R′ is as defined herein.

The term “S-sulfonamide” describes a —S(═O)₂—NR′R″ end group or a —S(═O)₂—NR′— linking group, as these phrases are defined hereinabove, with R′ and R″ as defined herein.

The term “N-sulfonamide” describes an R'S(═O)₂—NR″— end group or a —S(═O)₂—NR′— linking group, as these phrases are defined hereinabove, where R′ and R″ are as defined herein.

The term “disulfide” refers to a —S—SR′ end group or a —S—S— linking group, as these phrases are defined hereinabove, where R′ is as defined herein.

The term “phosphonate” describes a —P(═O)(OR′)(OR″) end group or a —P(═O)(OR′) (O)— linking group, as these phrases are defined hereinabove, with R′ and R″ as defined herein.

The term “thiophosphonate” describes a —P(═S)(OR′)(OR″) end group or a —P(═S)(OR′) (O)— linking group, as these phrases are defined hereinabove, with R′ and R″ as defined herein.

The term “phosphinyl” describes a —PR′R″ end group or a —PR′— linking group, as these phrases are defined hereinabove, with R′ and R″ as defined hereinabove.

The term “phosphine oxide” describes a —P(═O)(R′)(R″) end group or a —P(═O)(R′)— linking group, as these phrases are defined hereinabove, with R′ and R″ as defined herein.

The term “phosphine sulfide” describes a —P(═S)(R′)(R″) end group or a —P(═S)(R′)— linking group, as these phrases are defined hereinabove, with R′ and R″ as defined herein.

The term “phosphite” describes an —O—PR′(═O)(OR″) end group or an —O—PH(═O) (O)— linking group, as these phrases are defined hereinabove, with R′ and R″ as defined herein.

The term “carbonyl” or “carbonate” as used herein, describes a —C(═O)—R′ end group or a —C(═O)— linking group, as these phrases are defined hereinabove, with R′ as defined herein.

The term “thiocarbonyl” as used herein, describes a —C(═S)—R′ end group or a —C(═S)— linking group, as these phrases are defined hereinabove, with R′ as defined herein.

The term “oxo” as used herein, describes a (═O) group, wherein an oxygen atom is linked by a double bond to the atom (e.g., carbon atom) at the indicated position.

The term “thiooxo” as used herein, describes a (═S) group, wherein a sulfur atom is linked by a double bond to the atom (e.g., carbon atom) at the indicated position.

The term “oxime” describes a ═N—OH end group or a ═N—O— linking group, as these phrases are defined hereinabove.

The term “hydroxyl” describes a —OH group.

The term “alkoxy” describes both an —O-alkyl and an —O-cycloalkyl group, as defined herein.

The term “aryloxy” describes both an —O-aryl and an —O-heteroaryl group, as defined herein.

The term “thiohydroxy” describes a —SH group.

The term “thioalkoxy” describes both a —S-alkyl group, and a —S-cycloalkyl group, as defined herein.

The term “thioaryloxy” describes both a —S-aryl and a —S-heteroaryl group, as defined herein.

The “hydroxyalkyl” is also referred to herein as “alcohol”, and describes an alkyl, as defined herein, substituted by a hydroxy group.

The term “cyano” describes a —C═N group.

The term “isocyanate” describes an —N═C═O group.

The term “isothiocyanate” describes an —N═C═S group.

The term “nitro” describes an —NO₂ group.

The term “acyl halide” describes a —(C═O) R″ group wherein R″″ is halide, as defined hereinabove.

The term “azo” or “diazo” describes an —N═NR′ end group or an —N═N— linking group, as these phrases are defined hereinabove, with R′ as defined hereinabove.

The term “peroxo” describes an —O—OR′ end group or an —O—O— linking group, as these phrases are defined hereinabove, with R′ as defined hereinabove.

The term “carboxylate” as used herein encompasses C-carboxylate and O-carboxylate.

The term “C-carboxylate” describes a —C(═O)—OR′ end group or a —C(═O)—O— linking group, as these phrases are defined hereinabove, where R′ is as defined herein.

The term “O-carboxylate” describes a —OC(═O) R′ end group or a —OC(═O)— linking group, as these phrases are defined hereinabove, where R′ is as defined herein.

A carboxylate can be linear or cyclic. When cyclic, R′ and the carbon atom are linked together to form a ring, in C-carboxylate, and this group is also referred to as lactone. Alternatively, R′ and O are linked together to form a ring in O-carboxylate. Cyclic carboxylates can function as a linking group, for example, when an atom in the formed ring is linked to another group.

The term “thiocarboxylate” as used herein encompasses C-thiocarboxylate and O-thiocarboxylate.

The term “C-thiocarboxylate” describes a —C(═S)—OR′ end group or a —C(═S)—O— linking group, as these phrases are defined hereinabove, where R′ is as defined herein.

The term “O-thiocarboxylate” describes a —OC(═S) R′ end group or a —OC(═S)— linking group, as these phrases are defined hereinabove, where R′ is as defined herein.

A thiocarboxylate can be linear or cyclic. When cyclic, R′ and the carbon atom are linked together to form a ring, in C-thiocarboxylate, and this group is also referred to as thiolactone. Alternatively, R′ and O are linked together to form a ring in O-thiocarboxylate. Cyclic thiocarboxylates can function as a linking group, for example, when an atom in the formed ring is linked to another group.

The term “carbamate” as used herein encompasses N-carbamate and O-carbamate.

The term “N-carbamate” describes an R″OC(═O)—NR′-end group or a —OC(═O)—NR′— linking group, as these phrases are defined hereinabove, with R′ and R″ as defined herein.

The term “O-carbamate” describes an —OC(═O)—NR′R″ end group or an —OC(═O)—NR′— linking group, as these phrases are defined hereinabove, with R′ and R″ as defined herein.

A carbamate can be linear or cyclic. When cyclic, R′ and the carbon atom are linked together to form a ring, in O-carbamate. Alternatively, R′ and O are linked together to form a ring in N-carbamate. Cyclic carbamates can function as a linking group, for example, when an atom in the formed ring is linked to another group.

The term “carbamate” as used herein encompasses N-carbamate and O-carbamate.

The term “thiocarbamate” as used herein encompasses N-thiocarbamate and O-thiocarbamate.

The term “O-thiocarbamate” describes a —OC(═S)—NR′R″ end group or a —OC(═S)—NR′— linking group, as these phrases are defined hereinabove, with R′ and R″ as defined herein.

The term “N-thiocarbamate” describes an R″OC(═S)NR′-end group or a —OC(═S)NR′— linking group, as these phrases are defined hereinabove, with R′ and R″ as defined herein.

Thiocarbamates can be linear or cyclic, as described herein for carbamates.

The term “dithiocarbamate” as used herein encompasses S-dithiocarbamate and N-dithiocarbamate.

The term “S-dithiocarbamate” describes a —SC(═S)—NR′R″ end group or a —SC(═S)NR′— linking group, as these phrases are defined hereinabove, with R′ and R″ as defined herein.

The term “N-dithiocarbamate” describes an R″SC(═S)NR′-end group or a —SC(═S)NR′— linking group, as these phrases are defined hereinabove, with R′ and R″ as defined herein.

The term “urea”, which is also referred to herein as “ureido”, describes a —NR′C(═O)—NR″R″″ end group or a —NR′C(═O)—NR″— linking group, as these phrases are defined hereinabove, where R′ and R″ are as defined herein and R″ is as defined herein for R′ and R″.

The term “thiourea”, which is also referred to herein as “thioureido”, describes a —NR′—C(═S)—NR″R′″ end group or a —NR′—C(═S)—NR″— linking group, with R′, R″ and R′″ as defined herein.

The term “amide” as used herein encompasses C-amide and N-amide.

The term “C-amide” describes a —C(═O)—NR′R″ end group or a —C(—O)—NR′— linking group, as these phrases are defined hereinabove, where R′ and R″ are as defined herein.

The term “N-amide” describes a R′C(═O)—NR″— end group or a R′C(═O)—N— linking group, as these phrases are defined hereinabove, where R′ and R″ are as defined herein.

An amide can be linear or cyclic. When cyclic, R′ and the carbon atom are linked together to form a ring, in C-amide, and this group is also referred to as lactam. Cyclic amides can function as a linking group, for example, when an atom in the formed ring is linked to another group.

The term “guanyl” describes a R′R″NC(═N)-end group or a —R′NC(═N)— linking group, as these phrases are defined hereinabove, where R′ and R″ are as defined herein.

The term “guanidine” describes a —R′NC(═N)—NR″R′″ end group or a —R′NC(═N)—NR″— linking group, as these phrases are defined hereinabove, where R′, R″ and R″ are as defined herein.

The term “hydrazine” describes a —NR′—NR″R′″ end group or a —NR′—NR″— linking group, as these phrases are defined hereinabove, with R′, R″, and R″ as defined herein.

As used herein, the term “hydrazide” describes a —C(═O)—NR′—NR″R′″ end group or a —C(═O)—NR′—NR″— linking group, as these phrases are defined hereinabove, where R′, R″ and R″ are as defined herein.

As used herein, the term “thiohydrazide” describes a —C(═S)—NR′—NR″R′″ end group or a —C(═S)—NR′—NR″— linking group, as these phrases are defined hereinabove, where R′, R″ and R′″ are as defined herein.

As used herein, the term “alkylene glycol” describes a —O—[(CR′R″)_{z}—O]_{y}—R′″ end group or a —O—[(CR′R″)_{z}—O]_{y}— linking group, with R′, R″ and R′″ being as defined herein, and with z being an integer of from 1 to 10, preferably, from 2 to 6, more preferably 2 or 3, and y being an integer of 1 or more. Preferably R′ and R″ are both hydrogen. When z is 2 and y is 1, this group is ethylene glycol. When z is 3 and y is 1, this group is propylene glycol. When y is 2-4, the alkylene glycol is referred to herein as oligo (alkylene glycol).

When y is greater than 4, the alkylene glycol is referred to herein as poly(alkylene glycol). In some embodiments of the present invention, a poly(alkylene glycol) group or moiety can have from 10 to 200 repeating alkylene glycol units, such that z is 10 to 200, preferably 10-100, more preferably 10-50.

The term “silanol” describes a —Si(OH) R′R″ group, or —Si(OH)₂R′ group or —Si(OH)₃ group, with R′ and R″ as described herein.

The term “silyl” describes a —SiR′R″R′″ group, with R′, R″ and R′″ as described herein. As used herein, the term “urethane” or “urethane moiety” or “urethane group” describes a Rx-O—C(═O)—NR′R″ end group or a —Rx-O—C(═O)—NR′— linking group, with R′ and R″ being as defined herein, and Rx being an alkyl, cycloalkyl, aryl, alkylene glycol or any combination thereof. Preferably R′ and R″ are both hydrogen.

The term “polyurethane” or “oligourethane” describes a moiety that comprises at least one urethane group as described herein in the repeating backbone units thereof, or at least one urethane bond, —O—C(═O)—NR′—, in the repeating backbone units thereof.

The term “branched” chain groups refers to a (e.g., carbon-containing) group containing a branching unit that is attached to at least three other atoms which are each independently other than hydrogen.

The phrase “branching unit” as used herein throughout describes a multi-radical linking moiety, which can be aliphatic, alicyclic, aromatic, heteroaromatic or heteroalicyclic. By “multi-radical” it is meant that the linking moiety has two or more attachment points such that it links between two or more atoms and/or groups or moieties.

That is, the branching unit is a chemical moiety that, when attached to a single position, group or atom of a substance, creates two or more functional groups that are linked to this single position, group or atom, and thus “branches” a single functionality into two or more functionalities.

In some embodiments, the branching unit is derived from a chemical moiety that has two, three or more functional groups.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

Poly lactic-co-glycolic acid (PLGA) (lactide to glycolide ratio=85:15; MW=50-75 kDa), polyethylene glycol having average Mn of about 1,000,000 Da (PEG-1 MDa); polyethylene glycol having average Mn of about 5,000,000 Da (PEG-5 MDa), Trimethylolpropane tris[poly(propylene glycol), amine terminated] ether (JEFFAMINE® T-403), 3,3,5-trimethylhexamethylene-diamine (JEFFAMINE® D-230), tetraethylenepentamine (TEPA), Poly(propylene glycol)-bis(2-aminopropyl ether) having average Mn of about 2,000 Da (JEFFAMINE® D-2000), chloroform, tetrahydrofuran (THF), dimethylformamide (DMF), visualizing markers for CLSM poly[(m-phenylenevinylene)-alt-(2,5-dihexyloxy-p-phenylenevinylene)] (blue), fluorescein isothiocyanate (FITC), Tween® 20, glutaraldehyde (GA) (50% in water solution), catalase from bovine liver (lyophilized powder, 2,000-5,000 units/mg protein), and ruthenium (III) chloride hydrate, were obtained from Sigma-Aldrich™.

Cryosectioning medium, optimal cutting temperature (OCT) (Tissue-plus OCT compound, Fisher Healthcare, USA) was obtained from Fisher scientific.

Nitric acid (70%), hydrochloric acid (36%), and hydrogen peroxide (30%) were obtained from BioLab.

Ruthenium (Ru³⁺) iridium (Ir⁴⁺, Ir³⁺), palladium (Pd²⁺), and platinum (Pt²⁺) ions (chloride or nitrate water-soluble salts thereof) were obtained from Sigma Aldrich®. Sodium phosphate dibasic heptahydrate and sodium phosphate monobasic monohydrate were obtained from J. T. Baker. All the materials were used as is, without further purification.

Phosphate buffer preparation: phosphate buffer (PB) (0.1 M, pH 6) was prepared by dissolving 3.67 gram of sodium phosphate dibasic heptahydrate and 11.91 gram of sodium phosphate monobasic monohydrate in 1 liter (L) of water.

Spontaneous phase separation in solutions: The phase separation and fixation that occur during the reaction between the polyamine and the GA were examined using a light microscope. A droplet of the exemplary polyamine (JEFFAMINE® T-403/JEFFAMINE® D-2000/TEPA) was placed on a glass slide. Next, a droplet of 50% GA in water solution was slowly injected onto the glass slide in proximity to the polyamine droplet, until the two droplets came into contact.

As a control, the process was repeated with the respective polyamine and deionized (DI) water droplets.

The interface between the two solutions was monitored and examined microscopically using an inverted bright-field microscope.

Jetting solutions: For all the solutions described below, the concentrations are given in polymer's mass to solvent's volume (in gram/mL). PLGA solution for the sheath was prepared by dissolving 0.400 gram PLGA in a mixture of 0.500 mL THF and 0.500 mL DMF (1:1 vol/vol (v/v)). A trace amount of the blue visualizing marker was added to the solution. A jetting solution of PEG/polyamine for the core was prepared by dissolving 0.025 gram PEG (average Mn of about 1 MDa), 0.025 gram PEG (average Mn of about 5 MDa), and 0.500 gram of the exemplary polyamine (either JEFFAMINE® T-403, JEFFAMINE® D-230, JEFFAMINE® D-2000, or TEPA) in 1.000 mL chloroform. OCT/GA gel was prepared by mixing OCT with a solution of GA in deionized water (50%) in a ratio of 3/1 v/v.

Fiber electrospinning: The exemplary fabrication process setup contained two syringe pumps (New Era), a power supply (DC voltage source, Gamma High Voltage Research, USA), and a rotating drum collector. The PLGA and PEG/polyamine solutions were dispensed via a metallic coaxial core (23-gauge)-sheath (14-gauge) needle (Rame-Hart). Both the core and the sheath solutions were dispensed at a constant flow rate of 0.150 mL/hour. A driving voltage of 1.5-4 kV resulted in a stable jet and the core/sheath fibers were collected over a collecting drum covered with a homogeneous layer of OCT/GA gel with a thickness of about 2 mm, at a tip-to-ground distance of 14 cm and a drum rotating speed of 60 rpm.

Cryo-sectioning: The OCT/GA layer containing the jetted fibers was dried while rotating overnight. Next, the dried OCT sample was embedded into OCT gel in a cryomold. The embedded sample was frozen and cryo-sectioned using a cryostat (Leica CM3050 S). The cryo-sectioned fibers in OCT were then suspended in Tween® 20 solution (0.01% v/v in water) and the OCT was dissolved by a gentle rocking of the sample overnight. The sectioned fibers were separated from residuals of OCT and GA by five successive steps of washing and centrifugation. The clean sectioned fibers were kept in a known volume of Tween® 20 solution (0.01% v/v in water) and their concentration per mL was calculated using a hemocytometer. The analysis of the sectioned fibers was performed using a scanning electron microscope (SEM) (Zeiss GeminiSEM 300) in a high vacuum (WD of about 5 mm; 2-3 kV), and by confocal microscopy (Olympus IX83).

Energy dispersive spectroscopy (EDS) elemental analysis was performed on X-Flash 6/60, Bruker. Samples were produced and handled in an atmospheric environment, which may have resulted in adsorption of nitrogen and oxygen from the air, and therefore the collected data is qualitative rather than quantitative.

Calculation of the mass of ruthenium adsorbed per length or volume units: The mass percentage of ruthenium adsorbed to the polyamine (e.g., JEFFAMINE® T-403) crosslinked fibers was measured by ICP-MS. Given the ruthenium mass percentage and the sectioned fiber's average diameter and length, the mass of ruthenium adsorbed per length or volume units of the fibers can be calculated.

The volume of a microcylinder (MC) was calculated according to a cylinder volume equation:

$${V}_{MC} = π {R}^{2} {h}_{MC} \qquad Equation 1$$

where R is the outer radius of the fiber and h is the length of the microcylinder.

The mass of the ruthenium per one MC, m_{Ru} was calculated by:

$${m}_{Ru} = \frac{{M}_{Ru}}{{n}_{MC}} \qquad Equation 2$$

where M_{Ru} is the total mass of ruthenium in the sample, and n_{MC} is the number of MCs in the sample. From this, the ruthenium mass per length (m̅ₗ_{_{Ru}}) or its concentration in the fiber (C_{Ru}) can be estimated:

$${\overline{m}}_{{l}_{Ru}} = \frac{{m}_{Ru}}{{h}_{MC}} , \qquad Equation 3$$

$${C}_{Ru} = \frac{{m}_{Ru}}{{V}_{MC}} \qquad Equation 4$$

The average concentration of ruthenium in a fiber obtained from the calculation are summarized in Table I.

TABLE I

| | |
|---|---|
| Number of sectioned MCs in the sample, n_{MC}* | 8,800,000 |
| Mass of the sample [mg]** | 30 |
| Mass of ruthenium in the sample, M_{Ru} [mg]** | 3 |
| Length of the MC, h_{MC} [μm] | 50 |
| Average outer diameter of the fibers (2R) [μm] | 16.3 |
| Volume of an MC, V_{MC} [mL] | 1.0 · 10⁻⁸ |
| Ruthenium mass in a MC, m_{Ru} [mg]*** | 3.4 · 10⁻⁷ |
| Ruthenium mass per length, m̅ₗ̅_{_{Ru}}, [μg/m] | 6.8 |
| Ruthenium concentration, C_{Ru}, [mg/mL] | 33 |

*The number of sectioned fibers per mL in the solution was calculated using a hemocytometer.
**As measured in the 7800 ICP-MS, Agilent ICP-MS.
***This is also the mass of ruthenium in 50 μm length and in 1 · 10⁻⁸ mL volume.

Metal ions adsorption: The chemisorption of metallic ions to the microcylinders was conducted and analyzed in the following exemplary procedure: 200 μL of microcylinders, with a concentration of 3.50·10⁵ microcylinders per mL, were gently mixed overnight with 1 mL of metal ions solution, 0.1 M. The microcylinders were then washed with Tween® 20 solution (0.01% v/v in water) several times to remove unbound ions.

After 24 hours, the microcylinders were added to a reducing solution of sodium borohydride (NaBH₄, 0.25 M) in basic conditions (pH=11). The solutions were mixed for a couple of hours, followed by repeated washing with Tween® 20 solution (0.01% v/v in water) to remove traces of NaBH₄.

The spatial distribution of the adsorbed metal ions and metals along the particle was examined using energy dispersive spectroscopy (EDS) (X-Flash 6/60, Bruker).

The average loading of metal per particle was obtained using inductively coupled plasma mass spectrometry (ICP-MS) (ICP-MS 7800, Agilent). For this measurement, a sample of microcylinders with adsorbed metal ions was dried under a vacuum overnight and then weighed. A mixture of water, nitric acid (70%), hydrochloric acid (36%), and hydrogen peroxide (30%) in a ratio of 2:1:3:1 was added to the sample. The sample was digested in a microwave oven which heated the sample from room temperature (RT) to 180° C. for 20 minutes and kept at 180° C. for 35 minutes, followed by a cooling process to room temperature. Then, the sample was diluted to 50 mL total volume with water and further diluted 1000 times with 2% nitric acid. The mass percentage of the metal in the sample was measured.

The oxidation state of the metallic species in the microcylinders before and after reduction were analyzed using X-ray Photoelectron Spectroscopy (XPS). The measurements were performed in UHV (2.5×10-10 Torr base pressure) using 5600 Multi-Technique System (PHI, USA). The sample was irradiated with an AlKa monochromated source (1486.6 eV) and the outcome electrons were analyzed by a Spherical Capacitor Analyzer using the slit aperture of 0.8 mm. The samples were charged during measurements and charge Neutralizer was used for charge compensation.

Enzyme immobilization and activity testing: Catalase was physisorbed to the microcylinders in the following procedure: 200 μL of microcylinders with a concentration of 3.00×10⁵ microcylinders per mL were gently mixed overnight with 300 μL of enzyme solution (˜1.5 mg/mL in phosphate buffer pH 6) and 500 μL of phosphate buffer pH 6. The microcylinders were then washed with Tween® 20 solution (0.01% vol/vol (v/v) in water) several times to remove the unbound enzyme. The activity of the immobilized catalase was examined using a light microscope. A droplet of the obtained catalase-modified microparticle was placed on a glass substrate. Next, a droplet of Tween® 20 (1% v/v in water) was placed on top of the microtubes and then, another droplet containing the enzyme's substrate, hydrogen peroxide (about 1.5% v/v in water), was added. The enzyme decomposes the hydrogen peroxide to water and oxygen gas and oxygen bubbles eject from the edges of the microcylinders.

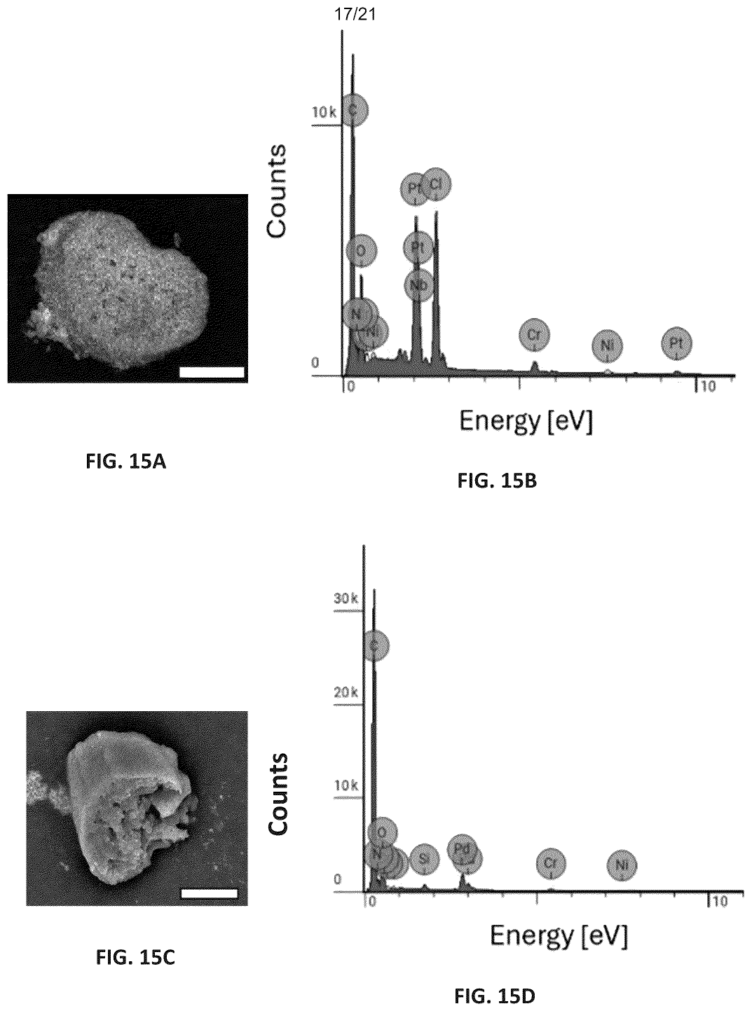

Size distribution of crosslinked JEFFAMINE® D-2000: The length of the JEFFAMINE® D-2000 segments and the gaps that are formed therebetween in the crosslinked JEFFAMINE® D-2000 fibers were measured from CSLM images. A total of 40 segments and 40 gaps originated from four uncut long fibers were measured and the average length and distribution of both the segments and the gaps were calculated. The length of the segments was measured from edge to edge of the red emitted areas and the gaps were measured from edge to edge of the dark areas. The average length of the segments is 16.6±3.8 μm (FIG. 13A), similar to the average length of the gaps which is 16.5=4.3 μm (FIG. 13B).

### Example 1

### Self-Emulsification and Crosslinking of Polyamines

While the external architecture of a fiber is exposed and can be therefore manipulated by a range of chemical, physical, and even mechanical means, a realization of a hierarchical inner structure within fibers is much more complex and calls for an approach that will induce (e.g., spontaneously) the desired morphology and architecture in a bottom-up manner.

Targeting the formation of a core-sheath system, an exemplary polyamine, polyamine trimethylolpropane tris[poly(propylene glycol), amine terminated] ether (JEFFAMINE® T-403), and an exemplary chemical crosslinker (crosslinking agent), glutaraldehyde (GA; 50% in water) were chosen, taking advantage of the high reactivity of GA with amine groups.

The present inventors have uncovered that upon mixing the two components, a spontaneous self-emulsification and a rapid chemical crosslinking that arrests the phase-separated morphology are observed. This phenomenon was therefore studied and utilized for constructing microscale fibers (microfibers or fibrous microstructures) with complex hierarchical inner structures.

FIG. 1A demonstrates a self-emulsification process, also known as the “Ouzo Effect” [Vitale S. A. and Katz J. L. Langmuir 2003, 19, 10, 4105-4110] at the interface of a droplet of JEFFAMINE® T-403 and a droplet of GA in water, taken using Brightfield microscopy. Upon the formation of an interface, the JEFFAMINE® phase penetrates the GA/water phase, and microdroplets are vigorously produced. The emulsification process was accompanied by the crosslinking of the JEFFAMINE® molecules by the reaction with GA.

The reaction mechanism of GA with amines (e.g., with protein amino groups) is not fully understood in literature, yet it is known to lead to a broad range of nitrogen-containing species (e.g., amines, imines, and even nitrogen-containing heterocyclic groups) [Migneault et al. 2004, supra].

The crosslinking of the amine moieties with GA leads to the formation of a wide and asymmetric emission peak with a maximum at a wavelength of about 560 nm (FIG. 2), which is indicative of the formation of a conjugated system [Ma et al. Sci. Rep. 2016, 6 (1), 19370; Lee et al. Chem. Commun. 2013, 49 (29), 3028]. Without being bound to any particular theory, the emission may be attributed to the formation of highly conjugated imine groups that are formed in the reaction between the amine groups in the polyamine and the GA.

As the exemplary polyamine JEFFAMINE® T-403 is miscible with water, crosslinking may also play a major role in the emulsification process through the formation of a crosslinked polyamine-GA polymer, which is less soluble in water and leads to the phase separation. As the reaction progresses, the formed polyamine-GA polymer droplets are fully crosslinked into solid nano-to-microspheres, as can be seen when the residue is examined in the scanning electron microscope (SEM) (FIG. 1B).

Unlike many cases in which the emulsification precedes the polymerization [Ganachaud, F. and Katz, J. L., Phys. Chem. 2005, 6, 209-216; Aschenbrenner et al. Langmuir 2013, 29 (28), 8845-8855; Lepeltier et al. Advanced drug delivery reviews 2014, 71, 86-97; Kempe, H. and Kempe, M. Journal of Colloid and Interface Science 2022, 616, 560-570], without being bound to any particular theory, it is believed that herein polymerization is a key step towards the spontaneous emulsification.

### Example 2

### Fabrication of Fibrous Microstructures Such as Microfibers and/or Microcylinders

Utilizing the observed phase separation and solidification scheme inside the polymeric fibers requires maintaining the phases in their liquid form without losing the structural attributes of the fiber.

To achieve this, a core-sheath architecture was used, wherein the sheath solution is composed of a preferably hydrophobic polymer, such as poly lactic-co-glycolic acid (PLGA) dissolved in a mixture of tetrahydrofuran (THF) and dimethylformamide (DMF) (1:1 volumetric ratio), or any other volatile solvent that does not dissolve the formed fibrous structure; and the core solution is composed of JEFFAMINE® T-403 as an exemplary polyamine, PEG-5 MDa, and PEG-1 MDa (20:1:1 by weight), as exemplary additional polymeric materials, dissolved in chloroform or any other suitable volatile solvent. The inclusion of polymeric materials such as PEGs is optional, yet significantly increases the viscosity of the solution, and the entanglement of its chains provides a polymeric scaffold that also drags the relatively small JEFFAMINE® T-403 molecules with it as it is pulled from the spinneret.

The polymeric shell is preferably selected as penetratable by the crosslinking agent, and is non-dissolvable in the OCT gel and the polyamine that form the inner core, in addition to being compatible with the electrospinning conditions. An exemplary fabrication process is schematically depicted in FIG. 3.

The two solutions are jetted simultaneously through a co-axial metallic needle in a core-sheath configuration. When voltage is applied between the needle and the collector, the system forms a stable jet, and fibers with a core-sheath (also referred to as core-shell herein throughout) configuration, dictated by the structure of the needle, were formed.

To introduce the chemical crosslinking agent, e.g., glutaraldehyde (GA), an optimal cutting temperature (OCT) gel is mixed with a solution of 50% GA in water in a volume ratio of 3:1 immediately before use. The relatively viscous gel is evenly smeared over the rotating drum, and the fibers are collected over the rotating drum in an aligned fashion along the direction of the rotation and embedded in the gel. The OCT gel is selected capable of dissolving the crosslinking agent and to being dissolved in solvents that do not dissolve the formed core-shell fibrous structures, and is preferably water-soluble or water-miscible. An exemplary OCT gel is composed of water-soluble glycols and resins including PEO and poly vinyl alcohol.

In an exemplary process, it was observed that a few minutes after the embedding of the fibers in an OCT/GA gel, their color changed from colorless to red, indicating the reaction between an exemplary polyamine, JEFFAMINE® T-403, and the GA.

The crosslinking agent is selected as a small molecule that can penetrate through the fibers' shell, as compatible with the electrospinning process, and preferably as highly reactive so as to induce self-emulsification as described herein.

The OCT gel was allowed to dry overnight on the rotator, forming a thin dry film embedded within the fibers. The dry OCT film comprising the aligned fibers was either dissolved in water to release the intact fibers or was further embedded in OCT, frozen, and cryo-sectioned.

The cryo-sectioned samples were immersed in a Tween® 20 solution (0.1% v/v in water) to remove the excess OCT through repeated washing and centrifugation cycles. The morphology and characteristics of the resulting cylinders were examined.

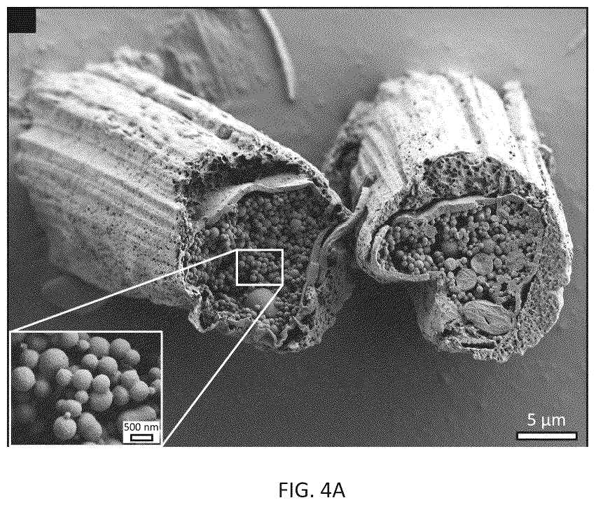

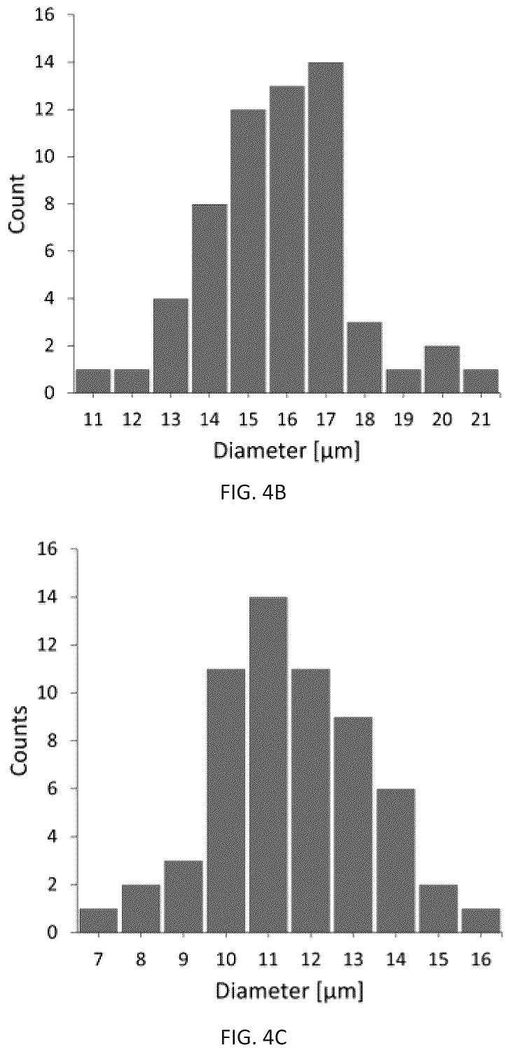

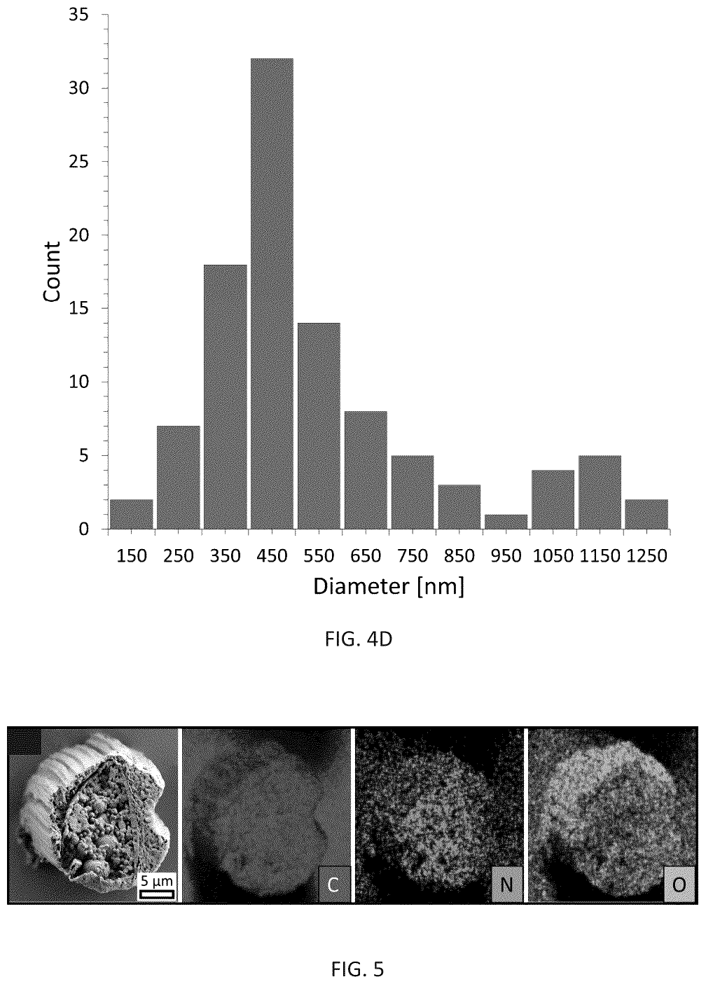

The outer and inner diameters of the resulting microcylinders were measured from SEM micrographs of the cross-section of cryo-sectioned fibers (FIG. 4A). Due to the fiber's elliptical-like shape, two inner and two outer perpendicular diameters of 60 fibers were measured and the average diameters of each fiber was calculated. The outer diameter is referred to the diameter of the entire fiber, edge to edge, and the inner diameter includes the PEG-rich outer core and the spheres inside. The mean outer diameter is 16.3±1.9 μm (FIG. 4B) and the mean inner diameter is 12.1±1.8 μm (FIG. 4C).

The diameters of the spheres formed inside the microcylinders were also measured from SEM micrographs of the cross-section of cryo-sectioned fibers. While the distribution is relatively wide, two populations can be observed: the majority (90%) of the spheres are in the nanoscale range and exhibit a Gaussian size distribution with a mean diameter of 475±157 nm; 10% of the spheres have a diameter in the range of 1-2.5 μm, with a mean diameter of 1660±398 nm (FIG. 4D).

Although the number of microspheres is smaller than the number of nanospheres, they occupy a significantly larger volume and hence have an effect on the porosity and on the total surface area of the sample.

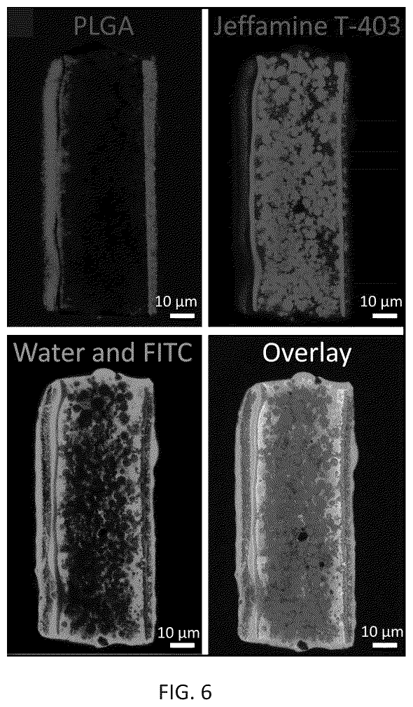

Energy Dispersive Spectroscopy (EDS) elemental analysis of the fiber's cross-section was performed. As can be seen in FIG. 5, there is a higher concentration of nitrogen in the center of the fiber and the inner sheath, while a higher concentration of oxygen is observed in the outer sheath. As expected, carbon is homogeneously distributed in the fiber.

These data support the presence of the exemplary polyamine, JEFFAMINE® T-403, in the spheres, as this is the only nitrogen-containing species in the system. It further shows that the outer sheath composed mainly of PLGA, as it contains a high concentration of oxygen.

To further characterize the composition and morphology of the fibers, a confocal laser scanning microscopy (CLSM) imaging was used. To identify the compartment containing PLGA, a blue-emitting polymeric fluorophore was added to the PLGA solutions before the electrospinning process. As mentioned above, the product of the polyamine-GA crosslinking exhibits a strong and wide emission, with a peak at a wavelength of 561 nm, and was traced in the red channel.

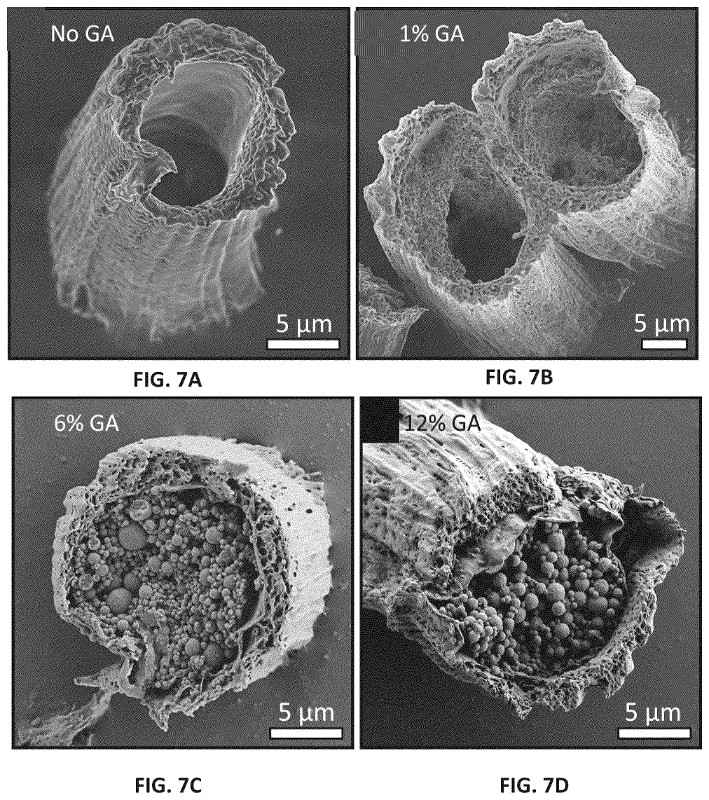

To examine the porosity of the core and the percolation, the system was immersed in water that contained green-emitting fluorescein isothiocyanate (FITC), which was traced in the green channel. The fibers were subsequently imaged, and the spatial distributions of the different fluorophores were obtained, and the results are presented in FIG. 6.

The CLSM images reveal the existence of an outer sheath composed of PLGA (blue) and an inner sheath that is made of the exemplary crosslinked polyamine, JEFFAMINE® T-403/PEG (red). The nano-to-microspheres can be seen within the inner sheath (red). Examining the percolation of water (green) indicates that most of the voids around the spheres are interconnected and can be accessed by the water. In some of the tested microcylinders, a gap exists between the inner and outer sheaths, which can be observed in the SEM and in the penetration of water into this gap as well.

### Example 3

### Effect of the Crosslinker's Concentration on the Microcylinders

To examine the effect of the concentration of GA in the OCT gel on the formation of the hierarchical structure at the core, the exemplary JEFFAMINE® T-403-based microcylinders were collected into gels comprising different GA concentrations: 0%, 1%, 6%, and 12%. The gels were then dried, cryo-sectioned, and the formed microcylinders were thoroughly washed to remove the remaining gel, and the results are presented in FIGS. 7A-D, respectively.

In the absence of GA, hollow tubular particles were obtained, which may indicate that the core solution did not solidify and was therefore washed away in the cleaning process (FIG. 7A). In the case of 1% GA, tubular microparticles were formed, with spheres covering mostly the luminal walls of the tubes (FIG. 7B). This architecture suggests that the emulsification and crosslinking of the core occur first at the core/sheath interface, thus indicating that the process evolves via a slow penetration of the GA through the shell towards the center of the core. At higher concentrations, the obtained microcylinders were filled with nano- and micro-spheres, which indicates a full crosslinking of the polyamine at the core (FIGS. 7C-D).

These results show that the architecture can be further controlled through the concentration of the ingredients of the systems, opening the path for highly porous hollow fiber, which are of potential for catalysis applications.

Based on these results, the following scheme for the formation of the pixie-stick architecture is proposed:
(i) As the fibers are formed, initially the outer PLGA sheath solidifies, accompanied by the formation of an inner sheath of PEG with traces of the polyamine, which is in accordance with a previously described process for PEG/polyester systems [Sitt et al. 2016, supra; Dror et al. 2007, supra]. A liquid polyamine-rich phase remains at the core.
(ii) Once the fiber is immersed in the GA-containing gel, GA slowly penetrates the core either by diffusion or through small cracks in the solid PLGA sheath.
(iii) As GA penetrates the fiber, it first reacts with the PEG-polyamine sheath and further solidifies it, while also leading to its shrinking which induces the formation of a well-defined boundary and a separation from the outer PLGA outer shell.
(iv) As GA continues to penetrate, it induces spontaneous emulsification in the liquid polyamine core, resulting in the formation of the spheres.

Without being bound to any particular theory, in this scheme, the exemplary gel collecting medium, OCT, has several roles: (a) it acts as a large reservoir of the GA; (b) the embedding of the fiber in the gel decreases the evaporation rate of the solvents, thus keeping the core in a liquid phase and the shell prone to diffusion; and (c) it acts as a stress relieving scaffold that eliminates interfacial stresses, which occur in the fiber/collector and fiber/air interfaces, and thus preserves the circular cross-section of the fiber despite its soft inner core.

In an alternative process, introducing the GA and water phase directly on top of dry fibers of similar composition collected on a bare substrate resulted in fibers with a standard core-sheath architecture with a slightly oblate cross-section, and the penetration of the GA and its reaction with the exemplary polyamine, JEFFAMINE® T-403, visually indicated by the appearance of a red color, took several days instead of a few minutes in the case of a collection into the gel (not shown).

### Example 4

### Chemisorption of Metallic Ions and Physisorption of Proteins

The polyamine fibers possess high degree of porosity which renders them as candidates for the adsorption of various chemical species. Their nitrogen-rich core chemistry makes them particularly promising candidates for such applications, e.g., formation of transition metal complexes with imine and/or pyridine groups.

In order to assess the potential of the system to be used for metal adsorption, Ruthenium was tested as an exemplary metal due to its tendency to form complexes with a range of nitrogen-containing species [see, for example, Wamba et al. J. Environ. Chem. Eng. 2018, 6 (2), 3192-3203; Otsuki et al. in: Ruthenium Chemistry, Mishra, A. K. and Mishra, L., Eds., Jenny Stanford Publishing: New York, 2018; 161214].

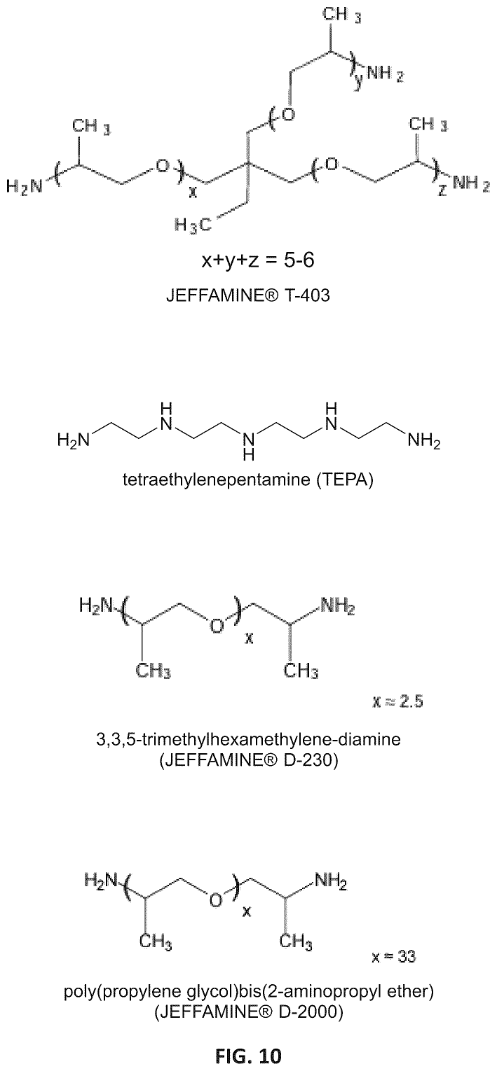

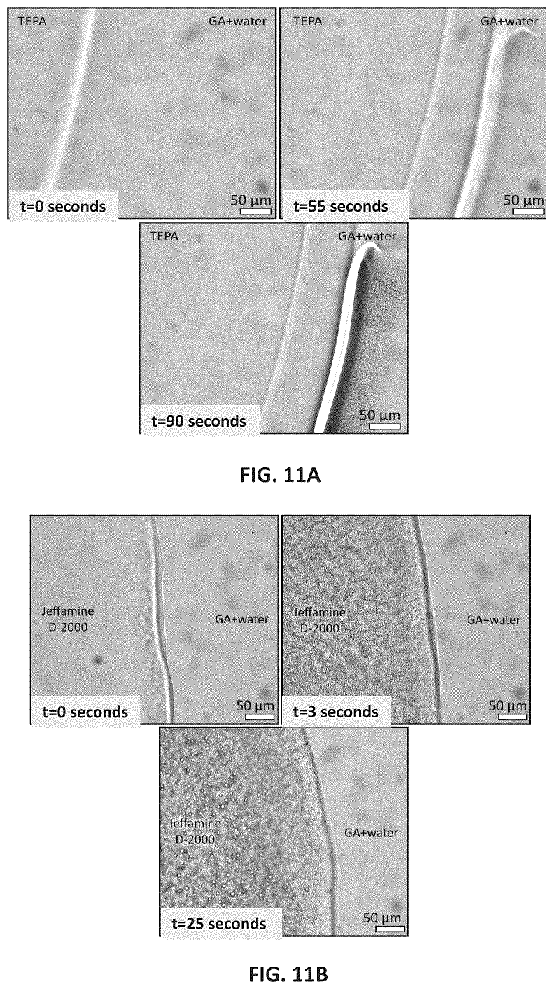

The exemplary sectioned fibers were added to a solution of the metal ions (RuCl₃, 0.1 M) and were incubated overnight. Then, the solution was repeatedly centrifuged and washed with Tween® 20 solution (0.1% v/v in water) to remove the excess ions that were not chemisorbed to the microparticles. Following incubation with the ruthenium, the color of the particles was changed from orange to black, as can be seen in FIGS. 8A-B.

The adsorption of the ruthenium was examined in EDS to identify the position of the adsorbed metal, and as can be seen in FIG. 8C, traces of ruthenium were mainly identified in the core of the microparticle.

The amount of ruthenium adsorbed per mass of particles was analytically determined using inductively coupled plasma-mass spectrometry (ICP-MS), indicating 10% ruthenium by weight (data not shown). Considering a particle's average length of 50 μm and an outer diameter of 16 μm, the amount of ruthenium adsorbed per length is calculated to be 6.8 μg/meter (33 mg/mL). The full analysis is summarized above (see, Calculation of the mass of ruthenium adsorbed per length or volume units).

The nitrogen-rich environment of the core is potentially an effective agent for selective physisorption and non-covalent binding of, e.g., proteins and enzymes.

To explore this, the enzyme catalase, which catalyzes the disproportionation of hydrogen peroxide (H₂O₂) to water and oxygen, was used as an exemplary protein and its binding to the catalase-modified microparticle was examined.

For this purpose, the exemplary microcylinders were incubated with a solution of catalase in phosphate buffer (PB), followed by the removal of the excess unattached enzyme by successive washing and centrifuging cycles until the supernatant showed no enzymatic activity.

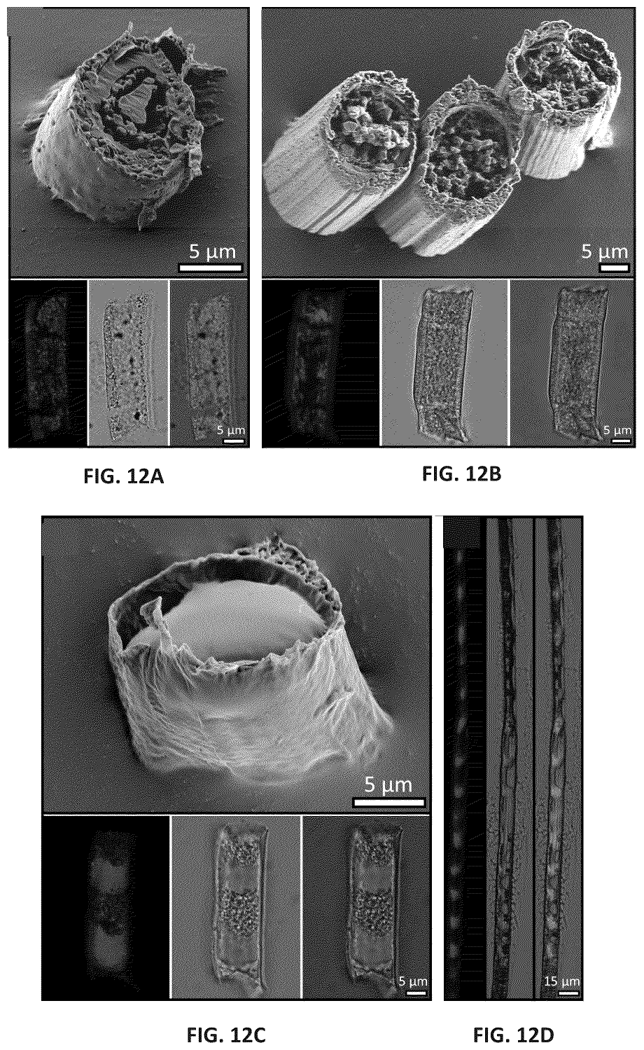

Upon immersing the cleaned microcylinders in a solution of 1.5% hydrogen peroxide in water, a significant ejection of oxygen bubbles from the edges of microcylinders was observed, accompanied by the circular motion of the microcylinders in the water. As can be seen in FIG. 9, Brightfield microscopy examination shows that the formation of the oxygen bubbles is initiated inside the core of the microcylinders, and the bubbles propagate towards the edges, where they are excreted out of the particle.

The regioselectivity of the catalysis indicates the selective adsorption of the enzyme to the spheres which are located at the core of the microcylinder, and further demonstrate reactivity even in the presence of low H₂O₂ concentrations, which shows the high binding efficiency of the enzyme to the core.

Further, the ability of the microcylinders to absorb dyes was also examined. The results (data not shown) indicated a successful absorption of methylene blue by the exemplary microcylinders. To conclude, the nitrogen-rich surface of the polyamine-based core was demonstrated to enable the chemisorption of the heavy metal ruthenium, as well as the physisorption of proteins and enzymes, making it a potent system for absorbing, filtering, separating, catalysis, and sensing applications.

### Example 5

### Effect of the Polyamine on the Microcylinders

The polyamine's effect on forming microcylinders and solid spheres via spontaneous formation of an emulsion at the contact point with GA followed by crosslinking therewith, was examined.

Without being bound to any particular theory, because the tested polyamine, JEFFAMINE® T-403, fully dissolves in water, the emulsification is assumed to be due to the formation of crosslinked JEFFAMINE® T-403 polymeric clusters that continue to grow throughout the process, until leading to a significant reduction in the solubility, which results in phase separation.

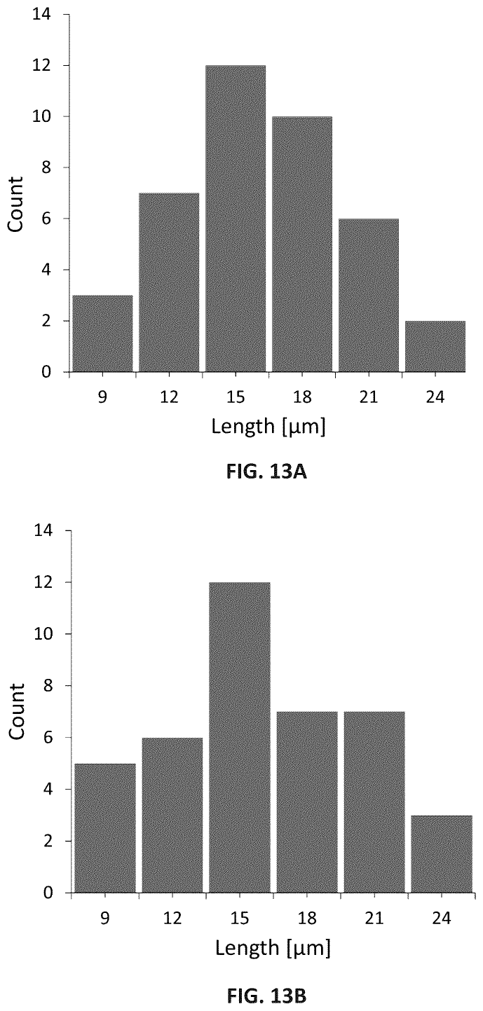

To test this theory, the polyamines tetraethylenepentamine (TEPA), JEFFAMINE® D-230, and JEFFAMINE® D-2000 (poly (propylene glycol)-bis(2-aminopropyl ether), average Mn of about 2,000 Da), as sketched in FIG. 10, were each tested.

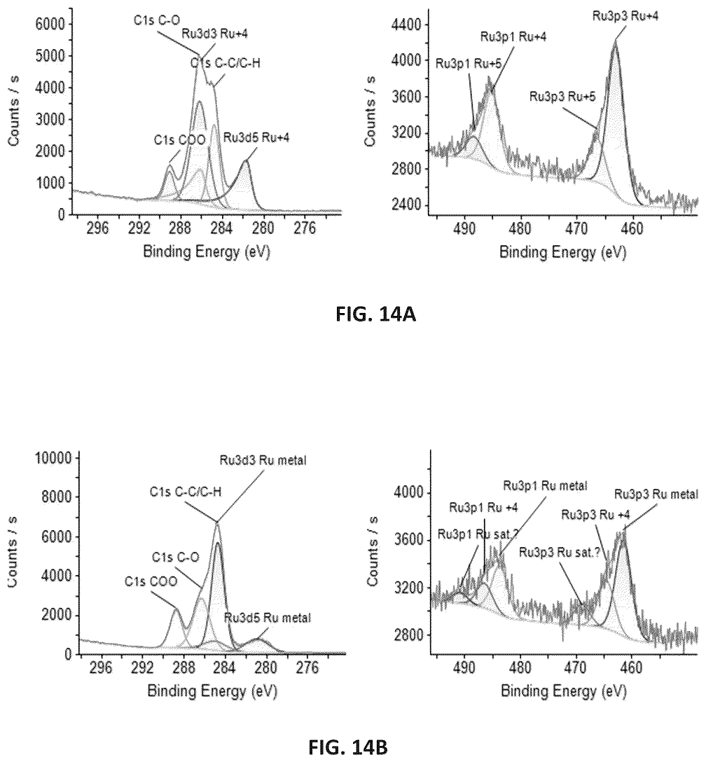

In the case of TEPA, which is smaller than JEFFAMINE® T-403 and has five amine groups, a similar phase separation process was observed for the bulk solutions as for JEFFAMINE® T-403, yet the spontaneous emulsification process was much slower as can be seen in FIG. 11A.

These results may support the assumption that the phase separation is related to the ongoing growth of crosslinked polymer clusters, because TEPA is smaller than JEFFAMINE® T-403 and has more amine groups, which makes it more water-soluble, and consequently, the formed crosslinked TEPA-GA polymer must significantly increase in size to become insoluble, thus causing a delay in the starting time of phase separation process.

In the case of JEFFAMINE® D-2000, the phase separation process is significantly different. Compared to JEFFAMINE® T-430, TEPA and JEFFAMINE® D-230, JEFFAMINE® D-2000 is significantly less soluble in the GA-water phase due to its higher MW and its long poly-propylene glycol backbone. Upon initial contact between the GA-water phase and the polyamine, a clear boundary is observed, as can be seen in FIG. 11B. A vigorous formation of nano- and micro-droplets is observed, which indicates spontaneous formation of an emulsion of GA-water in the polyamine.

As time progresses, the emulsion, which is confined to the JEFFAMINE® D-2000 phase, becomes denser and eventually solidifies, taking the shape of the JEFFAMINE® D-2000 phase. This behavior complies with the observed inner architecture of the JEFFAMINE® D-2000 fibers, and implies that the shape of the solid segments is governed by the solidification and phase separation of the JEFFAMINE® D-2000 inside the fiber and not through emulsification, as is observed for the small polyamine molecules.

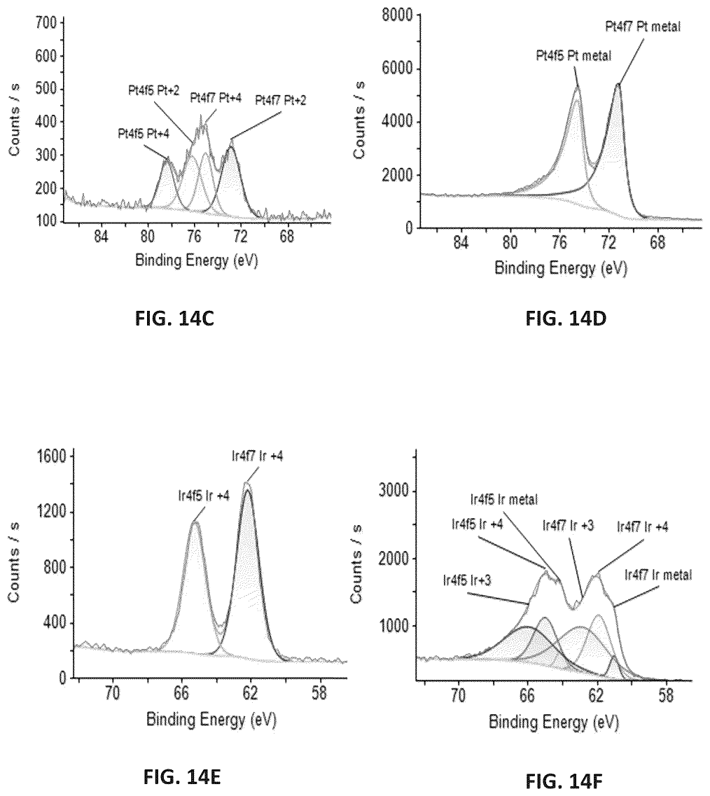

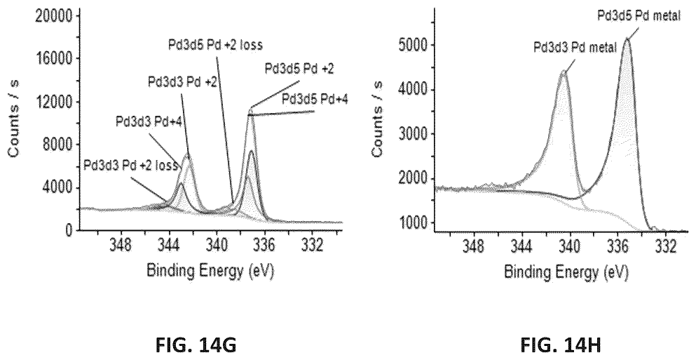

SEM and CLSM analyses of the obtained fibers were performed and the obtained images are presented in FIGS. 12A-D.

The data indicate that the core forms a coral-shaped morphology made of a combination of longitudinal thin pillars and spheres (FIG. 12A). In the case of JEFFAMINE® D-230, which has a high chemical resemblance to JEFFAMINE® T-403 but has only two amine sites, the obtained morphology resembles the one obtained from JEFFAMINE® T-403, but with a less smooth surface of the spheres and lower overall density of spheres in the core, which is possibly due to less efficient crosslinking (FIG. 12B).

In the case of JEFFAMINE® D-2000, which has a much larger molar weight and hence a significantly lower solubility in water, the bulk phase separation process substantially differs from that of the small polyamine molecules (FIG. 11B). In this case, the two phases formed a clear interface, and a reverse emulsion of water in JEFFAMINE® D-2000 was obtained through the rapid formation of water microdroplets at the interface, which penetrated the JEFFAMINE® D-2000 phase. Over time, the microscale water droplets condensed and solidified together to form a solid bulk crosslinked phase within the JEFFAMINE® D-2000 phase.

The clear phase separation of the two phases was also observed in the fibers with JEFFAMINE® D-2000 in the core. However, when combined with the confinement of the phases in the core, this led to a unique segmented morphology that resembles a bamboo stem, where the core separates to distinguished longitudinal solid segments of crosslinked JEFFAMINE® D-2000, separated from each other by voids, as can be seen in a cross-section of the fibers obtained through confocal imaging, as shown in FIGS. 12C-D.

Analysis of the confocal images indicates that the segments and voids are of similar lengths of about 16 μm, as can be seen in FIGS. 13A-B.

Without being bound to any particular theory, this unique segmented morphology resembles the fragmentation of surface-deposited polymeric fibers upon drying, and hence it is believed that the two systems share similarities in the segmentation mechanism [Edelstein-Pardo et al. Chem. Mater. 2022, 34 (14), 6367-6377]. Such segmentation is a result of two opposing stresses that are formed in the fiber throughout the solidification stage.

In the method described herein, the opposing forces occur throughout the phase separation and solidification processes: the crosslinking of the polyamine leads to the shrinking of the core phase and to a reduction of its volume, while the interfacial adhesion of the polyamine solution to the sheath, induced by the confinement, opposes the shrinking process. The combination of these two opposing forces, along with the phase separation process, results in enhanced shrinking in the middle of the core with respect to the core/sheath interface, and the difference in shrinking between the interface and the center of the core leads to a buildup of internal stress in the core.

Although the direct observation of the segmentation process, which could have led to a better understanding of the process, cannot be facilitated because the fibers are immersed in the gel and cannot be visualized throughout the process, support for this mechanism is obtained from SEM images of the sectioned fibers and from confocal images (FIGS. 12C-D), which show that the edges of the solid segment across the fiber are relatively concave.

To summarize, different phase separation schemes and fibers with diverse porous core architectures (e.g., densely packed nanospheres, coral-like, and segmented morphology) can be achieved by selecting different polyamine molecules.

These results demonstrate the engineering of the core of electrospun polymeric fibers through in-situ chemical and physical processes that modify the architecture, and consequently the properties of the fibers. This is enabled by the collection of the fibers into a sacrificial gel matrix, which preserves the fiber's contour and induces the chemical process.

The method demonstrated herein can be extended to other spontaneous emulsification systems and opens a path for more complex hierarchical fibers with new properties and applications (e.g. in filtering and catalysis).

### Example 6

### Metal-Decorated Microstructures

The adsorption of metallic catalytic species to exemplary microstructures as described herein was pursued.

For this purpose, a three-step process was performed:

The fibrous microstructures or the cylindrical microstructures obtained upon cryosectioning of the fibrous structures (MCs) in OCT were immersed in Tween® 20 solution (0.01% v/v in water) to remove the GA/OCT.

The obtained fibrous or cylindrical microstructures were immersed in solutions of ionic metal compounds (ruthenium, platinum, iridium, and palladium) overnight, to thereby effect absorption of the ionic metal species to the microstructures. In dark ionic solutions, a change in the color of the microstructure was observed due to the adsorption of the ions.

The fibrous or cylindrical microstructures were thereafter thoroughly washed to remove unbound ions, and were then immersed in a reducing solution of sodium borohydride to thereby convert the metal ions to elemental metal.

In an exemplary process, it was observed that a few minutes after the addition of sodium borohydride, all the microstructures demonstrated a significant change in color, indicating the reduction of the ions into their metallic form. The solution remained colorless and clear, indicating that the process occurs specifically and selectively within the microstructure (e.g., in the core).

It is noted that the adsorption and reduction processes can be performed both on single long fibers and on fiber bundles, because the aqueous solution can efficiently penetrate the porous core via capillary forces.

In order to analyze the adsorption of the metallic species and their compositions before and after reduction, XPS measurements were performed.

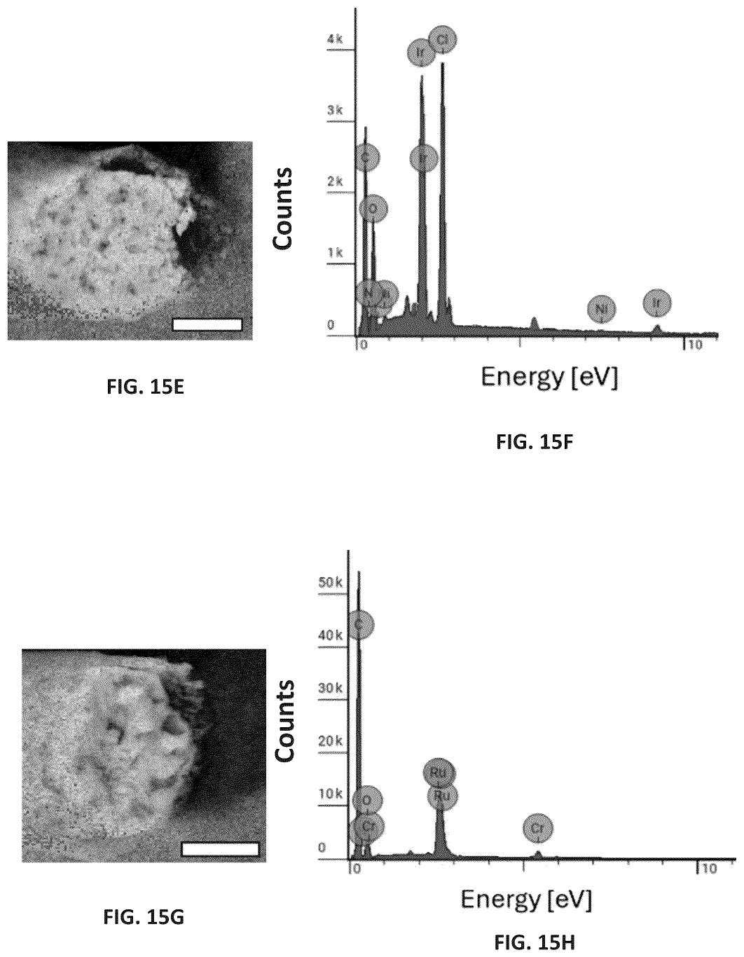

FIGS. 14A-H present the XPS spectra obtained for the different metals before (FIGS. 14A, 14C, 14E, and 14G) and after (FIGS. 14B, 14D, 14F, and 14H) reduction with sodium borohydride. As can be seen, in all the systems, XPS measurements indicate the existence of the added salts and metals at different oxidations states. After the reduction, some of the peaks can still be observed, but a clear peak assigned to the pure metal appears.

These data give a straightforward indication for the adsorption of the metals to the exemplary MCs and to the reduction of the metal species to the corresponding metal particle.

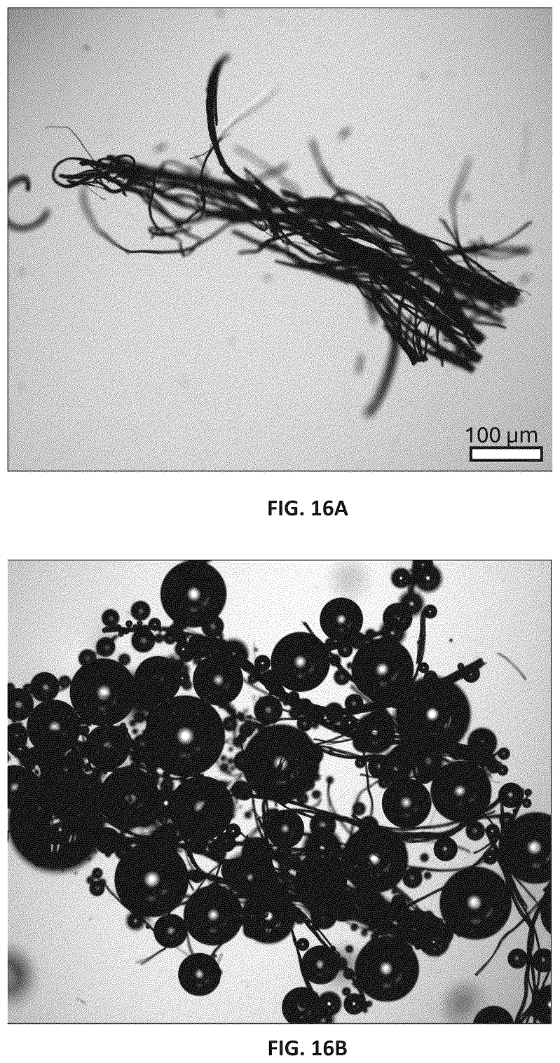

To further examine the position of the metals on the MCs, the systems were imaged using a scanning electron microscope (SEM; FIGS. 15A, 15C, 15E, and 15G) and the position of the metals was examined using Energy-dispersive X-ray spectroscopy (EDX; FIGS. 15B, 15D, 15F, and 15H).

As can be seen, in all systems, EDX measurements identified the highest quantity (traces amounts) of the relevant metal are present in the fibers, and the existence of the respective metal was clearly identified in the EDX spectra.

### Example 7

### Catalytic Activity of Metal-Decorated Microstructures

The catalytic activity of the metal-decorated microstructure was examined using the disproportionation of hydrogen peroxide (H₂O₂) to oxygen gas and water. This reaction, commonly catalyzed by various metallic species, provides a straightforward example of the catalytic properties of exemplary metal-decorated microstructure.

In order to examine the catalytic activity of the metal-decorated microstructure, a microstructure comprising fibers which were not cryo-sectioned and formed bundles of about 1 mm, were used.

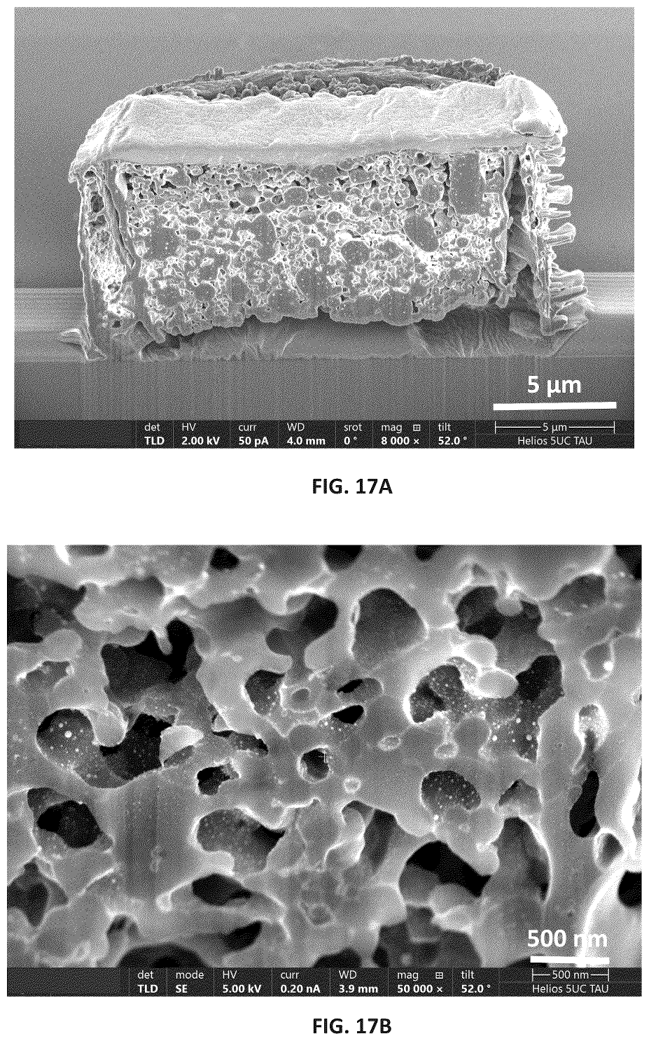

FIGS. 16A-16B present images of a mesh of platinum-decorated microstructures immersed in water before (FIG. 16A) and after (FIG. 16B) the addition 0.1% w/v hydrogen peroxide solution. Once hydrogen peroxide is introduced, a rapid formation of oxygen bubbles can be clearly observed inside and at the edges of the mesh, indicating that indeed a disproportionation reaction occurs, and leading to a buildup of oxygen bubbles on the mesh.

These data demonstrate the ability of metal-decorated microstructures to act as catalysts.

A 10 μm-long platinum-decorated microcylinder as described herein was cross-sectioned using a focused ion beam (FIB) and subjected to SEM analyses.

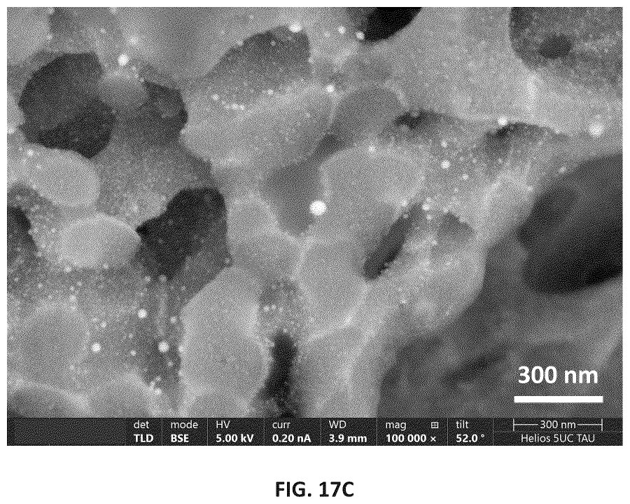

The SEM images are presented in FIGS. 17A-C, and show the platinum as shiny nanospheres that grew on the walls of the crosslinked-polyamine spheres (in FIGS. 17A-C: on the microspheres) following reduction. The estimated diameter of the metal nanoparticles is in the range of from 5 to 50 nm.

### Example 8

### Extraction of Metal Catalysts from the Microcylinders

Substances absorbed to or the microstructures can be extracted and/or separated from the microstructures by degrading the polymeric matrices that form the microstructures.

Degrading the polymeric matrices can be performed by hydrolyzing the imine crosslinking moieties and/or breaking down the polymeric network that forms the outer shell to water-soluble fragments.

Hydrolyses can be performed by immersing the microstructures in an acidic buffer (e.g., 89.10% 0.1 M citric acid: 10.90% 0.2 M Na₂HPO₄ v:v buffer, pH 2.6), using imine reductase enzymes, or any other hydrolyzing method known in the art.

The absorbed substance (e.g., metal particles) can be separated from the obtained hydrolyses reactions using, for example, centrifugation and successive washing to remove, e.g., residual organic materials.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A microstructure comprising an inner core enveloped by an outer shell, wherein said inner core comprises a porous structure made of a chemically-crosslinked polyamine and said outer shell is a polymeric outer shell made of a polymeric material.

2. The microstructure of claim 1, wherein said porous structure comprises a plurality of spheres.

3. The microstructure of claim 2, wherein said plurality of spheres comprises a plurality of microspheres and a plurality of nanospheres.

4. The microstructure of claim 3, wherein:
a weight ratio of said microspheres and said nanospheres ranges from 1:100 to 10:1; and/or
at least 50%, or at least 60%, or at least 80%, or about 90% of said spheres are nanospheres; and/or
said nanospheres feature an average diameter in a range of from 1 to 850, or from 250 to 650, or from 400 to 500, nm; and/or
said microspheres feature an average diameter in a range of from 1 to 3 microns.

5. The microstructure of claim 1, wherein:
the microstructure features an average diameter in a range of from 10 to 50 μm, or from 10 to 30 μm, or from 10 to 20 μm; and/or
an average diameter of said inner core is in a range of from 5 to 30 μm, or from 5 to 20 μm, or from 10 to 15 μm.

6. The microstructure of claim 1, wherein:
said chemically-crosslinked polyamine is formed of a polyamine having an average Mn in a range of from 100 to 5000 grams/mol; and/or
said chemically-crosslinked polyamine is formed of a polyamine having from 2 to 10 amine groups; and/or
said chemically-crosslinked polyamine is formed in the presence of a crosslinker having a molecular weight lower than 1,000 grams/mol; and/or
said chemically-crosslinked polyamine is formed in the presence of a crosslinker which is water-miscible or water-soluble.

7. The microstructure of claim 1, wherein said polymeric material that forms said outer shell and said polyamine that forms said crosslinked polyamine are not dissolvable in one another.

8. The microstructure of claim 1, wherein said polymeric material that forms said outer shell is water-immiscible or water-insoluble.

9. The microstructure of claim 1, being a fibrous microstructure.

10. A method for preparing the microstructure of claim 1, the method comprising subjecting a solution comprising said polymeric material that forms said outer shell and a solution comprising said polyamine to a wet electrospinning process within a hydrogel matrix that comprises a crosslinker, to thereby obtain a fibrous microstructure embedded in said hydrogel matrix;
removing said hydrogel matrix, to thereby obtain said fibrous microstructure; and
optionally, converting said fibrous microstructure into a non-fibrous microstructure,
wherein:
said crosslinker is water-miscible or water-soluble; and/or
wherein said polymeric material that forms said outer shell and said crosslinker are selected such that said crosslinker is capable of penetrating through said outer shell; and/or
wherein said polymeric material that forms said outer shell and said polyamine that forms said crosslinked polyamine are immiscible with one another.

11. The method of claim 10, wherein said hydrogel matrix comprises a sacrificial material that is dissolvable in a solvent that does not dissolve said inner core and said outer shell.

12. The method of claim 10, wherein said hydrogel matrix is characterized by a viscosity in a range of from 1000 to 20000 mPa second (centipoises), or from 2000 to 10000 mPa second.

13. A microstructure prepared by the method of claim 10.

14. A composition comprising a plurality of microstructures, wherein in at least a portion of the microstructures, each microstructure is a microstructure according to claim 1.

15. An article-of-manufacturing comprising the microstructure of claim 1.

16. An article-of-manufacturing comprising the composition of claim 14.

17. A composition-of-matter comprising the microstructure of claim 1 and a substance absorbed to the microstructure.

18. A composition-of-matter comprising a plurality of particles, wherein at least a portion of said particles comprises a chemically crosslinked polyamine.

19. The composition-of-matter of claim 18, wherein said plurality of particles comprises a plurality of spheres, wherein said plurality of spheres optionally comprises a plurality of microspheres and a plurality of nanospheres.

20. The composition-of-matter of claim 19, wherein said plurality of spheres comprises a plurality of microspheres and a plurality of nanospheres.
